(19) United States
(12) Patent Application Publication
(10) Pub. No.: US 2007/0239484 A1
(43) Pub. Date: Oct. 11, 2007

(54) SYSTEM AND METHOD FOR MANAGING PATIENT BED ASSIGNMENTS, BED OCCUPANCY, AND STAFFING IN A HEALTHCARE FACILITY OPERATION

(76) Inventors: Betty Jean Arond, Tucson, AZ (US); Karen Sue Zachar Haas, Tucson, AZ (US); John Marcus Burross JR., Tucson, AZ (US)

Correspondence Address: LEWIS AND ROCA LLP, 40 N. CENTRAL AVENUE, Suite 1900, PHOENIX, AZ, 85004-4429, US

(21) Appl. No.: 11/687,559

(22) Filed: Mar. 16, 2007

Related U.S. Application Data
(60) Provisional application No. 60/743,569, filed on Mar. 20, 2006.

(51) Int. Cl. G06Q 10/00; G05B 19/418

(52) U.S. Cl. 705/2; 705/8

(57) ABSTRACT

An integrated health care delivery network with enabling software and network technology to maximize bed resources, manage varying census levels, and avoid patient diversions through real-time monitoring, automation and communication, is disclosed. Preferably, the present invention is embodied in a Patient Agent Throughput Management System that interfaces with and complements the following existing healthcare facility systems: Admission/Discharge/Transfer (ADT); Scheduling System; Bed tracking (for housekeeping purposes); Security; Clinical Information Management; Human Resources; and Physician Information Management. The “Patient Agent” system is an easy-to-use business intelligence application that is designed to allow administrators, clinicians and managers to easily access, analyze and display real-time patient, staff and bed availability information from clinical and ancillary information systems. It enables users to see trends and relationships in hospital management data directly from their desktop personal computers.

### CROSS NOTING

This application claims priority to U.S. Provisional Application Ser. No. 60/743,569, filed on Mar. 20, 2006, titled “System and Method For Managing Patient Bed Assignments, Bed Occupancy and Staffing In a Healthcare Facility”, which is incorporated herein by reference.

### BACKGROUND TECHNICAL FIELD

The present invention relates generally automated resource management and virtual instrument technology healthcare, and is more particularly related to systems and methods of operating healthcare facilities.

### BACKGROUND

Referring now to FIG. 1, most hospitals employ an Admission/Discharge/Transfer (ADT) system 13 for managing ancillary information, such as admissions, discharge and transfer data about its patients. The information therein is not readily available to the staff who are responsible for transferring and placing patients in the hospital

Most hospitals employ a Clinical Information Management system 14 for managing the clinical care of its patients. Crucial patient clinical information is entered into this source system. Requiring a user to enter this same information into an additional patient placement tool can be problematic to the patient placement process.

Most hospitals employ a Scheduling system 15 to manage the number of staff on a unit which subsequently determines the number of staffed beds on a unit at any given time. Lack of visibility to the current staffed bed count on a unit can increase the time it takes to make an informed patient placement decision.

Many hospitals experience a shortage of clinical staff to fill the positions needed to care for the number of patients on a unit. Attracting clinical staff to fill these shifts in both an economical and employee satisfying manner is a challenge faced by all managers and scheduling committees.

Another problem area is the lack of accurate bed availability information. This generally results in lost admissions, excessive wait times, and increased risk to the hospital.

Direct admissions information is managed and maintained separately from registered inpatients. Data on these potential revenue generating visits can be lost which reduces a hospital's ability to improve their Direct admissions processes.

Maintaining security for Patient Health Information is problematic in that it is many times user name specific and application dependent. Auditing application access based on specific user ids is problematic.

Inefficient and undocumented communication while searching for the appropriate bed for a patient is another problem.

Lack of visibility to ‘observation’ outpatients that occupy inpatient beds is another problem.

Additionally, current ADT systems 13 often lack the ability to access and provide meaningful historical, current and predictive data regarding bed occupancy levels and other activities and events related to the operation of a health care facility.

It would be an advance in the art to provide a system and method for managing patient bed assignments, bed occupancy, and staffing in a healthcare facility to overcome the foregoing problems in the prior art.

### SUMMARY

Implementations satisfy, to a great extent, the foregoing and other needs not currently satisfied by existing systems. The result is achieved, in an exemplary embodiment, by providing an integrated health care delivery network with enabling technology to maximize bed resources, manage varying census levels, and avoid patient diversions through real-time monitoring, automation and communication.

Implementations provide real-time support tools for patient bed assignments, clinical care, staffing, scheduling and other processes in a health care facility and for profiling historical, current and future activities and events.

Preferably, the present invention is embodied in a Patient Agent Throughput Management System that interfaces with and complements existing health care facilities, ADT 13, Clinical Information Management 14, Scheduling 15, Housekeeping/Bed Tracking 16, Physician Information 18, Human Resources 17 and Security systems 22. The Throughput Management System 1 is an easy-to-use intelligent application that is designed to allow administrators, clinicians and managers to easily access, analyze and display real-time patient and bed availability and related information from ancillary and clinical information systems in a centralized and non-duplicative manner. In other words, it enables users to see trends and relationships in hospital management data directly from their desktop personal computers and/or handheld personal digital assistants (PDAs).

Implementations of the present invention improve patient placement efficiency and save time and money by assisting with the clinical and business decision process that occurs when a patient needs to be admitted to a hospital, for instance. Decision makers can easily move from big-picture analyses to transaction-level details while, at the same time, safely sharing this information throughout the enterprise to derive knowledge and make timely, data driven decisions.

Implementations of the present invention enable more efficient patient placement by, for example, reducing/eliminating telephone calls, paper processes and the need to refer to, or duplicate information from, multiple hospital management applications to place a patient. In addition, it is an extremely powerful data warehouse and data mining tool that provides on-demand historical, real-time and predictive reports, alerts and recommendations.

Implementations of the present invention are real-time and mission critical. That is, it handles both scheduled and emergency events. The system also assists with the clinical and business decision processes that occur when a patient or a potential patient in the form of a direct admit needs to be assigned to a specific bed location.

Collectively, the system provides organizations or enterprises with an array of enabling technologies to: schedule/reserve/request patient bed assignments; assign/transfer/discharge patients from an emergency department and/or other clinical areas; reduce/eliminate dependency on telephone calls to communicate patient and bed requirements; and provide administrators, managers and caregivers with accurate and on-demand reports and automatic alerts such as through pagers, electronic mail and system alerts.

Other features of implementations of the present invention include: easy-to-use visual navigation; intuitive interactive interface; easy queries; runs on standard computers; real-time, historical and predictive analyses; user configurable settings; remote access and control; interactive support and alarms; automatic messaging via email, pagers, cell phones etc.; integrated online help and configuration utilities.

Implementations of the present invention provide a Throughput Management System 1 that is designed to protect patient confidentiality and be fully compliant with the evolving Health Insurance Portability and Accountability Act (HIPAA) regulations. The Throughput Management System 1 controls access to the application by validating user access rights against Microsoft Active Directory roles and groups. These roles and groups restrict both processes and the ability to view or change key data. The Throughput Management System 1 stores user access information for auditing purposes. There is a substantial benefit in utilizing Microsoft Active Directory roles to restrict access. The Throughput Management System 1 does not require specific branded source clinical and ancillary systems to be in place prior to its installation. These source systems may have their own built-in security or they may rely on a consolidated security system within the organization. The Throughput Management System 1 strongly supports consolidation wherever possible, thus if the organization has already come to rely on centrally defined role based security for as many systems as possible, Throughput Management System 1 security will be an effortless integration into the organization.

With these and other advantages and features of the invention that shall become hereinafter apparent, the nature of the invention may be more clearly understood by reference to the following descriptions with the several drawings attached herein.

### BRIEF DESCRIPTION OF THE DRAWINGS AND APPENDICES

FIG. 1 is a diagram of an exemplary implementation of a Patient Agent Throughput Management System of the present invention, called Patient Agent;

FIG. 2 is a diagram of an Admissions, Discharge and Transfer (ADT) interface;

FIG. 3 is a flowchart of relationships for Patient Agent Data Store 3, in one exemplary implementation, as represented by Tables 3.1 through 3.18 each of which is shown in Appendix D;

FIGS. 4-11 are diagrams of exemplary implementations of the Patient Agent Throughput Store 5;

FIG. 12 is a screen shot of an exemplary implementation of a Summit View of Patient Throughput;

FIGS. 13-14 represent an exemplary implementation of the user screens used to view, assign and update staff and staffed beds on a given unit as well as communicate staffing information with the organization's Staffing Office. This grouping of capability is contained in the Staffed Beds Module 7;

FIGS. 15-19 are an exemplary implementation of the user screens used to communicate direct admits, patient transfers and discharges between units and the organization's overseeing Throughput Office. This grouping of capability is contained in the Throughput Activity Module 8 as shown in FIG. 1;

FIGS. 20-26 represent an exemplary implementation of the Shift Filler Module 9 screens. From here, a user is able to manage, view and bid on un-staffed shifts in the Facility;

FIGS. 27-29 represent an exemplary implementation of the user screens used to manage the alerts that are defined and triggered by data within the Throughput Management System. This grouping of capability is contained in the Alert Module 10. Alerts specific to an individual module are also accessible within the module itself,

FIG. 30 is an exemplary implementation of the Reporting Module 11. From here, a user with the appropriate security will be able to run trending and detail reports of Throughput Management activity;

FIGS. 31 through 42 are examples of the reports available from the Reporting Module 11;

FIGS. 43 through 46 represent an exemplary implementation of the Patient Agent Administration screens. From here, a user with the appropriate security will be able to configure the system to meet the needs of the facility;

FIGS. 47-48 represent an exemplary implementation of the Throughput Booster 12 screens used to boost throughput in the facility;

FIG. 49 shows various combinations of source systems and modules, each being described above, which can be integrated together into respective implementations of the present invention;

FIGS. 50-51 represent an exemplary implementation of the Summit View 6 in greater detail than that which is shown in FIG. 1. This view provides a summarized global view of current patient information and location as well as pending activity;

Appendices A and B, respectively, illustrate patient data extracted from Health Level 7 (HL7) events and messages received from the ADT system 13 of a health care facility;

Appendix C is an exemplary implementation of a list of SQL Stored Procedure Declarations used to populate the Patient Agent Data Store 3;

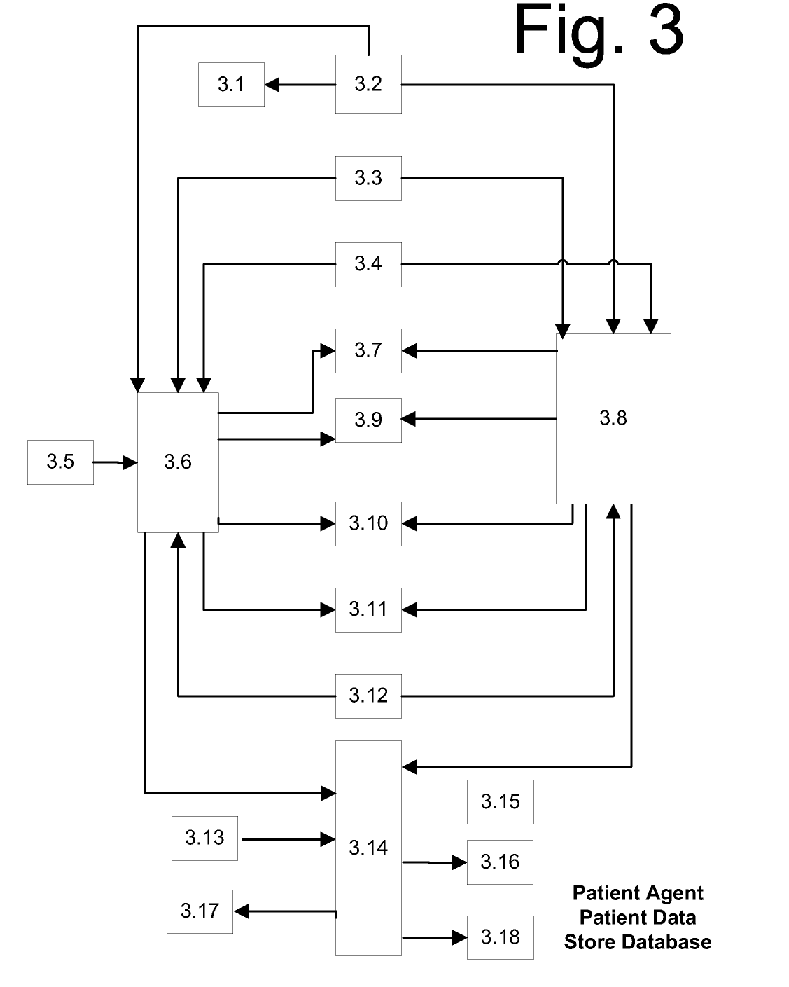

Appendix D shows a series of Tables 3.1-3.18 that illustrates exemplary implementations of data tables and fields thereof as stored in the Patient Agent Data Store 3 of FIG. 3;

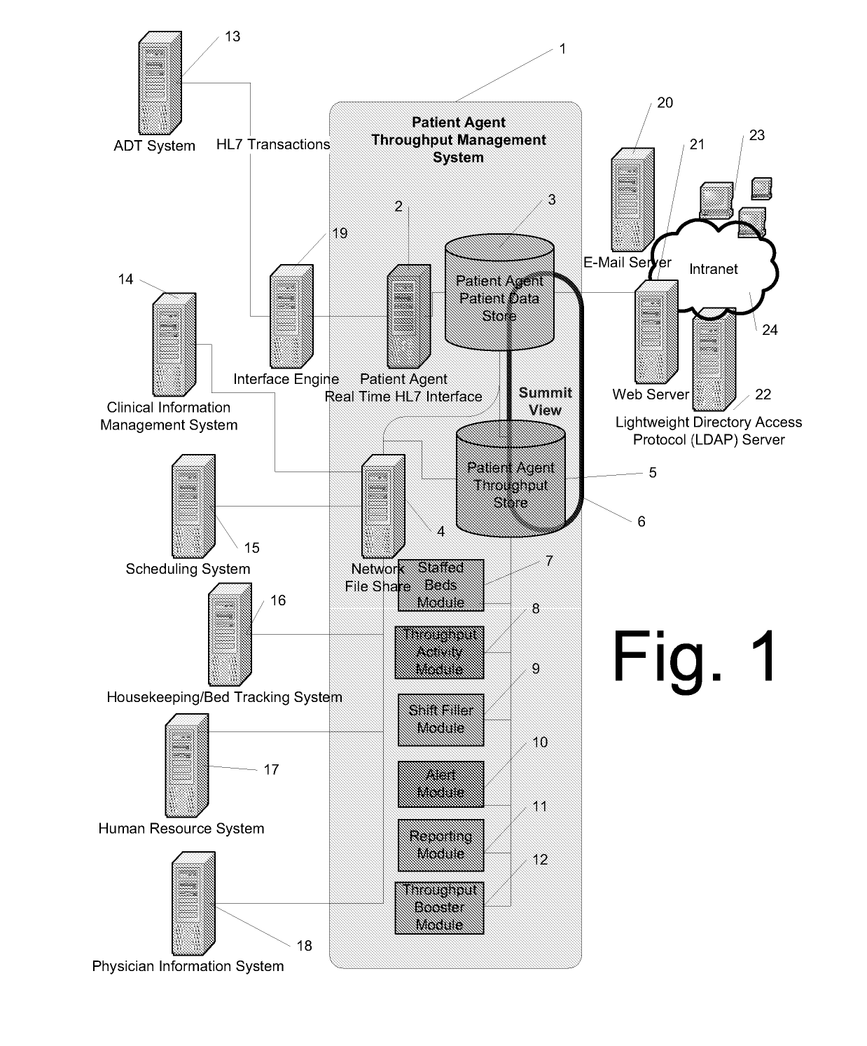

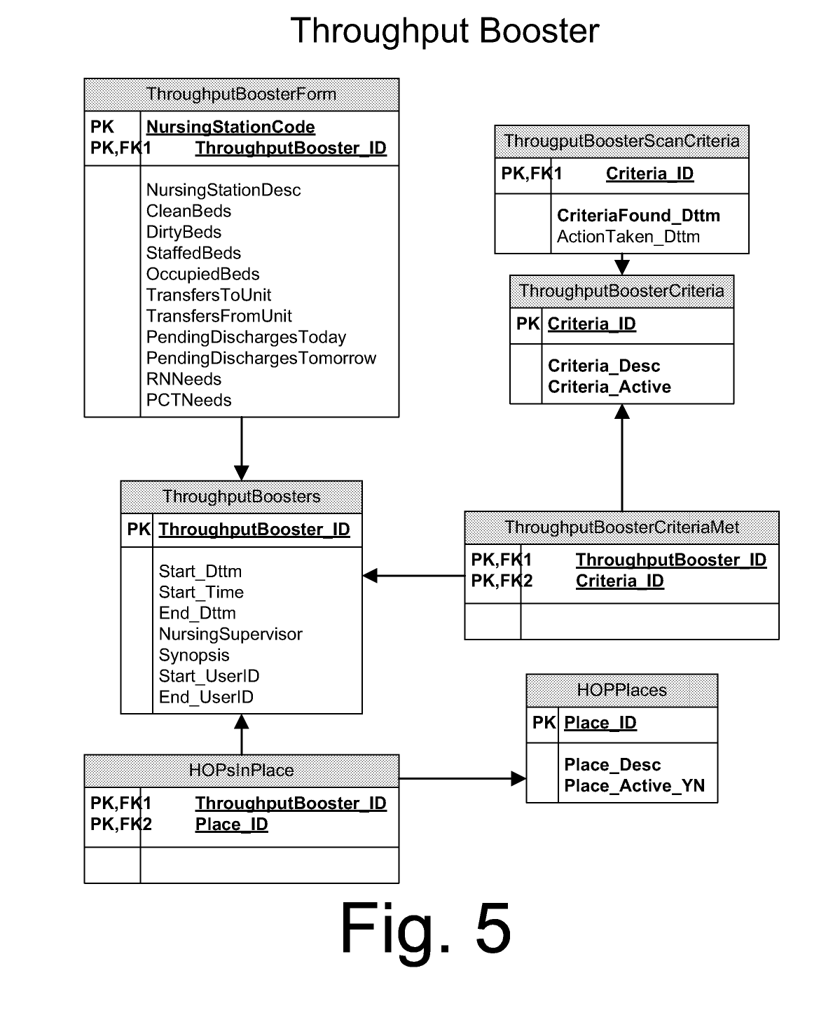

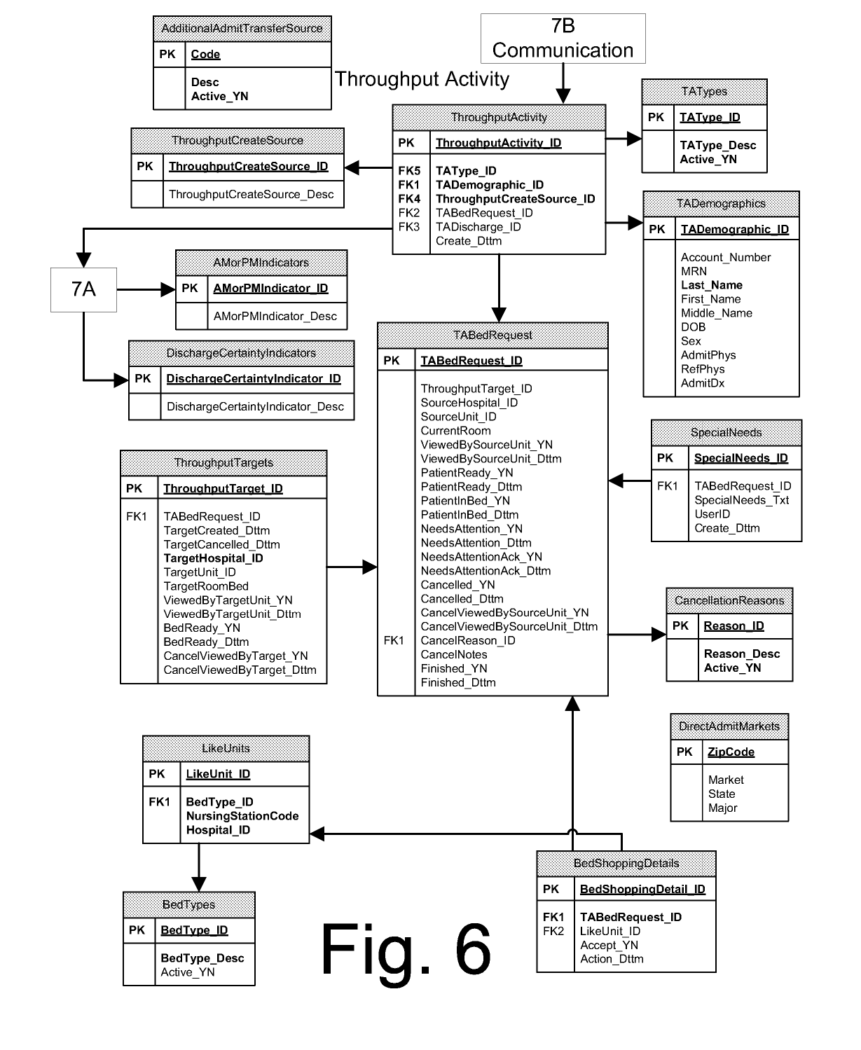

Appendix E shows Tables 4.1-4.70 representing exemplary implementations of fields in these tables that are stored in the Patient Agent Throughput Store 5 of FIGS. 1 and 4-6;

Appendix F illustrates exemplary implementations of the data feeds from source systems which are extracted, stored and used to support the Throughput Management modules; and

Appendix G illustrates how access to a portion of the application that is defined and secured to a specific group of users. Group memberships are populated by users or roles in a Light Weight Directory Access Protocol (LDAP) server 22.

### DESCRIPTION

Referring now to the drawings, FIG. 1 illustrates an exemplary implementation of an inventive Patient Agent Throughput Management System of the present invention generally referred to by reference numeral 1 and shown by components in a shaded region of FIG. 1. The Patient Agent Throughput Management System 1 is interfaced to an admission/discharge/transfer (ADT) system 13, a clinical information management system 14, a scheduling system 15, a housekeeping/bed tracking system 16, a human resource system 17 and a physician information management system 18 of a health care facility (not shown) via an interface engine 19 connected to the Patient Agent Real Time HL7 Interface 2. The Patient Agent Real Time HL7 Interface 2 connects to the Patient Agent Data Store 3.

The Patient Agent Real Time HL7 Interface 2 is a standard Windows server 2. A Network File Share 4 is located in a hospital as a network file share that is common to both the hospital legacy systems and to the patient agent throughput management system. HL7 as used herein is intended to the “Hospital Language 7” standard that defines the communication and delivery of hospital information as is commonly used and supported by Medicare and a variety of insurance companies. The Network File Share 4 and the Patient Agent Real Time HL7 Interface 2 do not have to be geographically located next to each other, as long as the Patient Agent Real Time HL7 Interface 2 can write data to the Patient Agent Patient Database 3.

The clinical information management system 14, scheduling system 15, housekeeping/bed tracking system 16, human resource system 17 and physician information system 18 connect to a network file share 4 common to both the Patient Agent Throughput Management System 1 and the existing hospital source systems. Source systems 13, 14, 15, 16, 17, and 18, seen in FIG. 1, can write data to the Network File Share 4 and can receive data in turn. The ADT system 13 is not depicted as being directly connected to the Network File Share 4, although it could be. If for some reason a healthcare facility did not want to use a real time feed nor use HL7 messages, then the Patient Agent Real Time HL7 Interface 2 could be removed and all information could come through the Network File Share 4, wherein the ADT System 13 would connect directly to the Network File Share 4.

The Patient Agent Data Store 3 and the Patient Agent Throughput Store 5 are two databases that are connected to an email server 20 and a web server 21. The web server 21 is connected to a Microsoft Active Directory Services server 22. The web server 21 connects to client computers 23 via the Intranet 24. The Summit View 6 connects to the Patient Agent Data Store 3 and the Patient Agent Throughput Store 5 via the Web server 21. The Summit View 6 is an aggregate view of data stored in the Patient Agent Data Store 3 and Patient Agent Throughput Store 5. The Patient Agent Throughput Store 5 is a database that stores information, not stored elsewhere, that is needed by the Patient Agent Throughput Management System 1 in order to complete all of the functions of Modules 7 through 12. The non-patient information specific to Modules 7-12 is stored in the Patient Agent Throughput Store 5. Source systems 14-18, seen in FIG. 1, may have information stored in the Patient Agent Throughput Store 5 so as to provide ready access for importation to Modules 7-12. Implementations of the present invention provide that modules 7-12 can be used with numerous units in a hospital and/or with a multi-facilities healthcare system (e.g., a system of hospitals).

The phrase “Patient Agent” is intended to be understood as a virtual runner that accomplishes tasks that make it possible for a patient to receive proper health care in a desired sequence of events, where the patient agent acts as a virtual agent for the patient. The Patient Agent is not geographically limited but can manage a patient's throughput through multiple geographic locations where hospital care is provided. As such, the Patient Agent is made up of a system of people, software, computers, and databases. The right hand side of FIG. 1 shows servers 20, 21 and 22 in communication with terminals 23.

As will be discussed in detail below, a preferred embodiment of the Patient Agent Throughput Management System 1 includes the following application modules identified in FIG. 1 as Staffed Beds Module 7, Throughput Activity Module 8, Shift Filler Module 9, Alert Module 10, Reporting Module 11 and Throughput Booster Module 12.

Although an embodiment of the Patient Agent Throughput Management System 1 is described herein as having an ADT interface for coupling to an ADT system of a health care facility, it should be understood that the present invention is not limited in this regard and the system interface can be configured to couple the system of the invention to other types of admission systems or networks for health care facilities or a broader scope of the invention the system can be configured to interface with other types of systems or facilities.

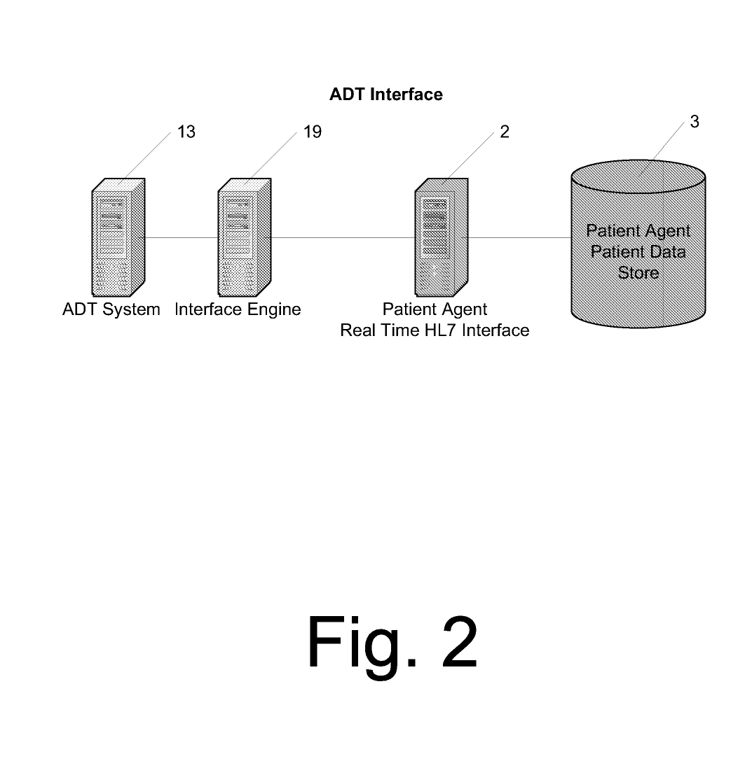

Referring to the system 1, FIG. 2 illustrates one embodiment of the ADT interface system 13 wherein the Patient Agent Patient Data Store 3 is coupled to a health care facility's ADT system 13 via the ADT interface engine 19 that is coupled to the Patient Agent Real Time HL7 Interface 2 and receives patient information there from. The ADT interface engine 19 and the Patient Agent Data Interface 2 communicate HL7 events from the health care facility's ADT system 13 in real time.

Tables 3-5 seen in Appendices A-C, respectively, identify the Real Time HL7 events processed by the Patient Agent Data Interface 2, the data elements stored by the Patient Agent Real Time HL7 Interface 2, and the sample SQL stored procedure declarations for use by the system 1.

The Patient Agent Patient Database 3 stores patient specific information fed to it from the ADT system 13, including information on patient demographics, diagnosis, locations, hospitals, etc. Modules 7 through 12 rely on data in the Patient Agent Patient Database 3, with the possible exception of Shift Filler Module 9 since it can be configured to deal only with nursing staff.

The Lightweight Directory Access Protocol (LDAP) Server 22 is further illustrated in Appendix G to show an example of ‘ADS’ defined access.

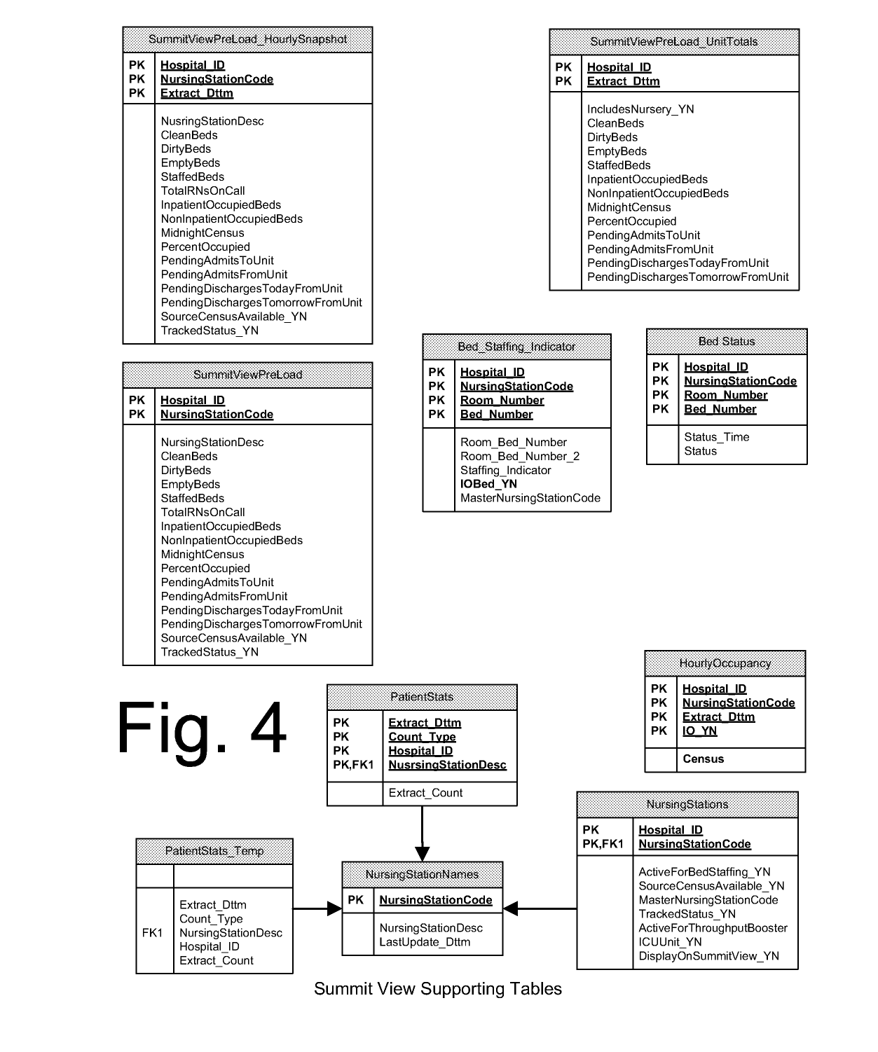

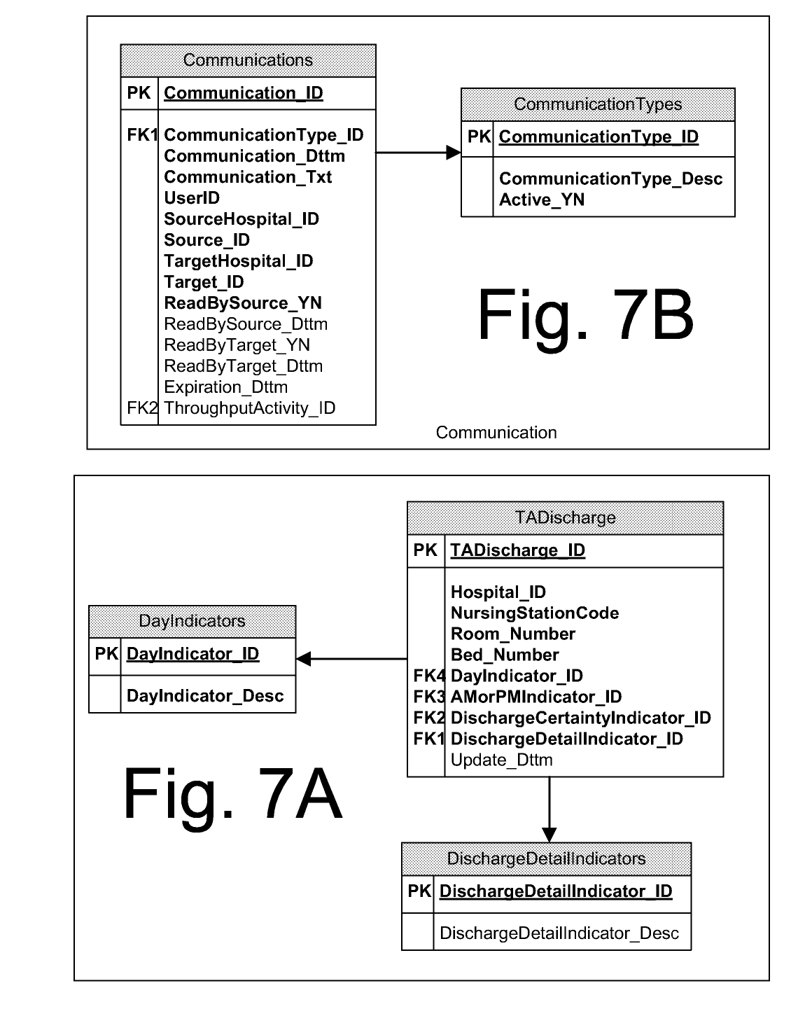

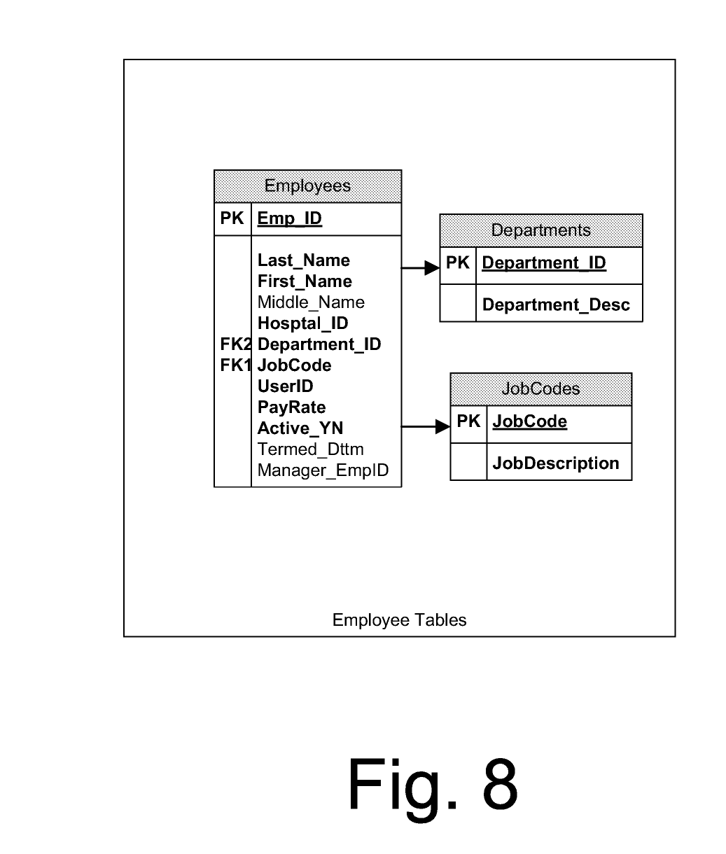

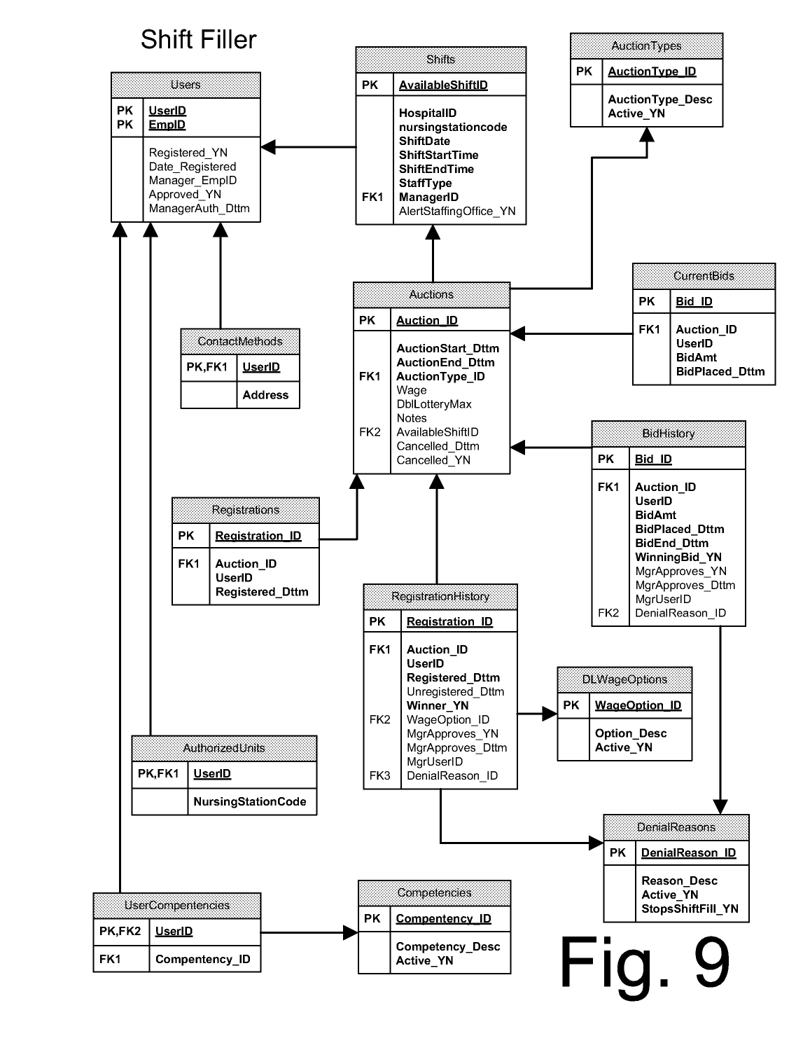

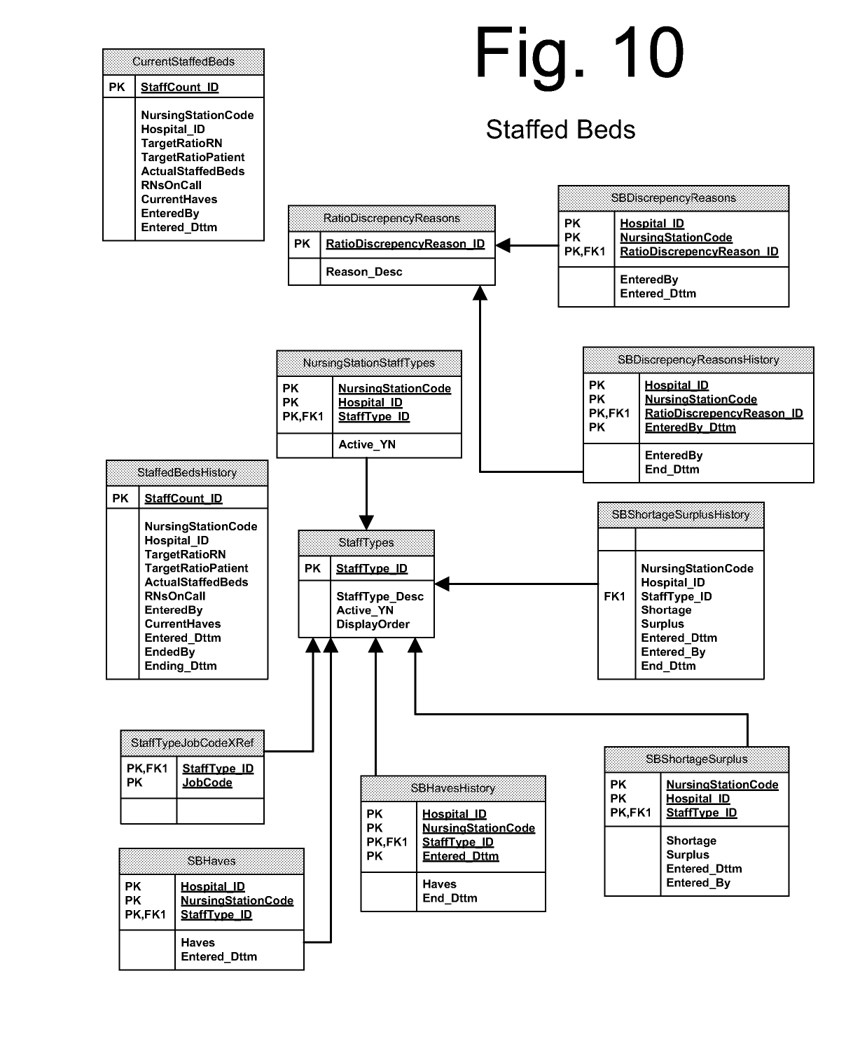

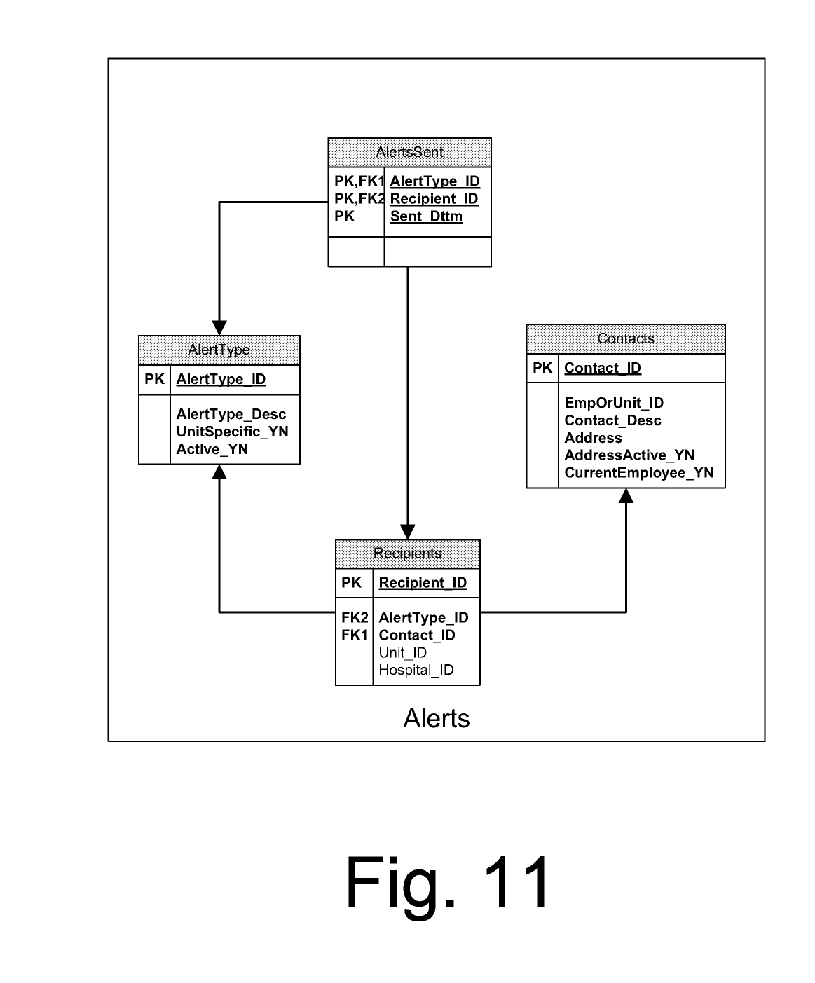

The Patient Agent Throughput Store 5 is further illustrated in FIGS. 4-11 as the Patient Throughput Database (see also the field in Tables 4.1 through 4.70).

Appendix F shows fields for data feeds to populate and support data in the patient agent databases.

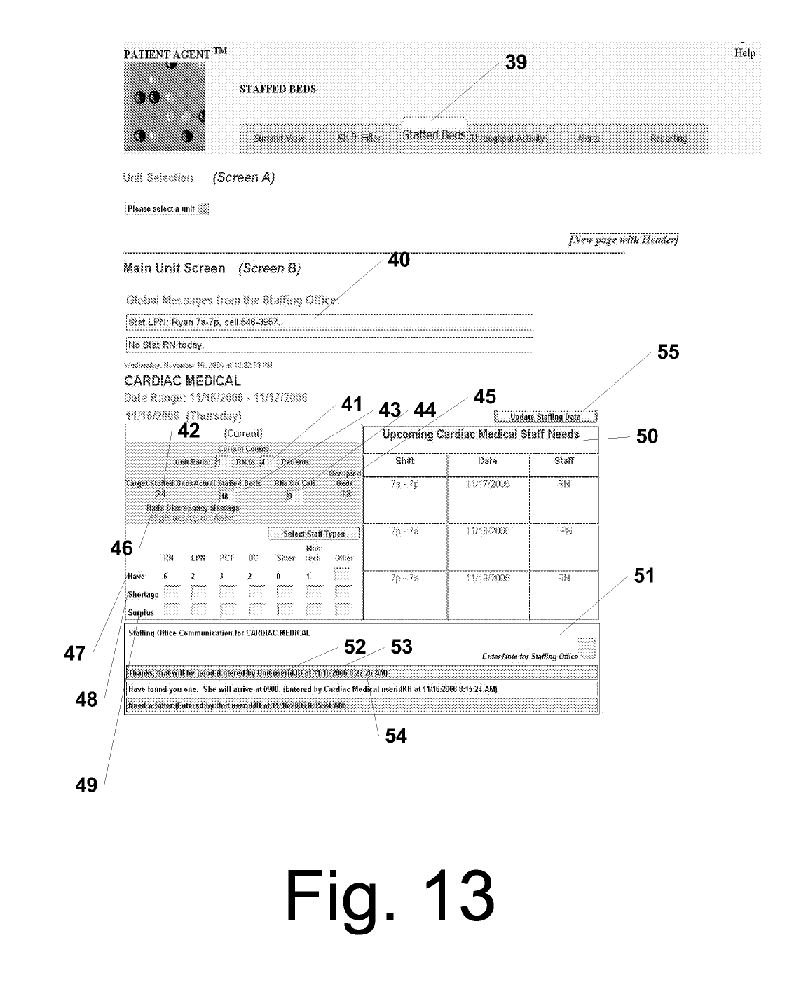

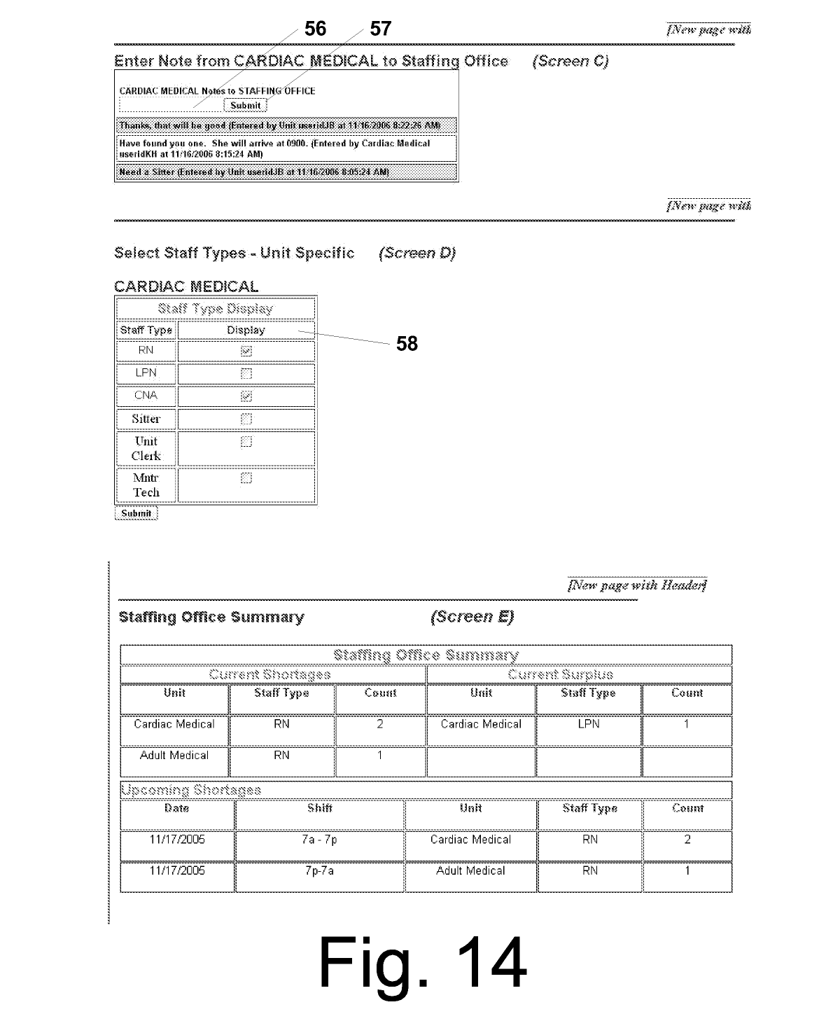

The Staffed Beds Module 7 uses data from the organization's scheduling system 15 translating job codes to job types and translating hours/shifts to current HAVE's; where the future needs are visible via the organization's scheduling system and Shift Filler Module 9. As supporting documents, see the description of the Staffed Bed Module 7 and the screen shots showing the Staffed Bed Staffing page in FIGS. 13-14.

The Staffed Beds Module 7 is used by the management of a hospital unit to enter a number of staffed beds. This entry is used to figure whether or not a patient can be placed in a bed on that unit. The Staffed Beds Module 7 also includes a data feed from the Scheduling System 15 that shows how many healthcare workers (RN's, LPN's, PCT's) are available, thereby providing an awareness of a desired patient to clinical staff ratio. As such, an on-going assessment can be automatically taken as to whether the unit is meeting the desired ratio, exceeding it, or is beneath it. Alerts can be created from this calculation. The unit is thereby kept informed as to how many staffed beds there are in a unit before placing a patient there. Key information is thus managed right at unit, and alerts are generated as the ratios are calculated on an on going basis.

The Staffed Beds Module 7 holds the shortages and surpluses of each type of clinical worker. If the unit has a special need, the Staffed Beds Module 7 enables the staffing office to manage all staff in all units of a hospital to fill needs. Staffed Beds Module 7 also provides electronic communication between the unit and a staffing office, and also stores all of these communications with date and time stamps, user IDs, etc. The highly documented log of communications can thus be followed for the staff on a unit.

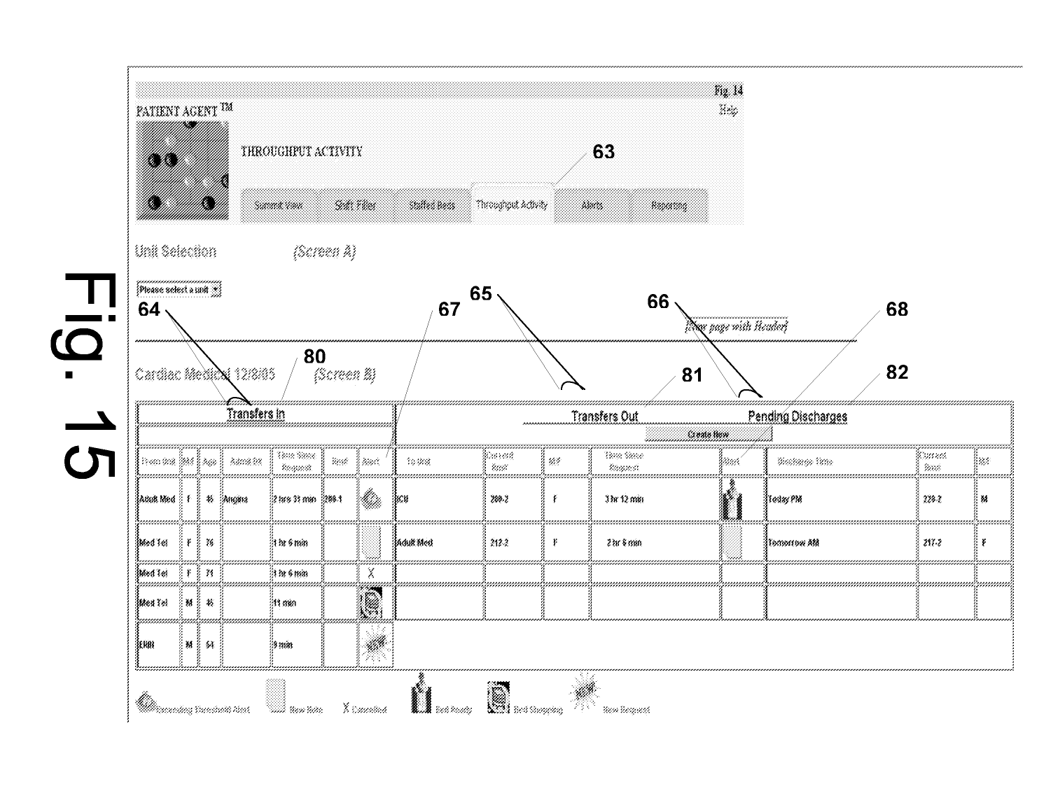

The Throughput Activity Module 8, in the shaded region in FIG. 1, includes all patient movement communication including discharge communication. As supporting documentation, see the Throughput Activity Module 8 and the screen shots seen in FIGS. 15-19 described herein. The Throughput Activity Module 8 can be used by any unit in a facility or any unit in a multi-facilities healthcare system to communicate regarding a patient admit or transfer, with respect to both sending and receiving units. All communication again is documented and stored, such as with user ID, date/time stamps, etc. All requests for beds and requests for transfers are managed within the Throughput Activity Module 8. The Throughput Activity Module 8 stores all information related to where patients are in the hospital and where patients need to go in the hospital or hospitals, and where they are going.

The Throughput Activity Module 8 receives an importation of clinical information data stored in the Clinical Information Management System 14. Pertinent general and clinical information for the patient will appear on a throughput activity record for the patient.

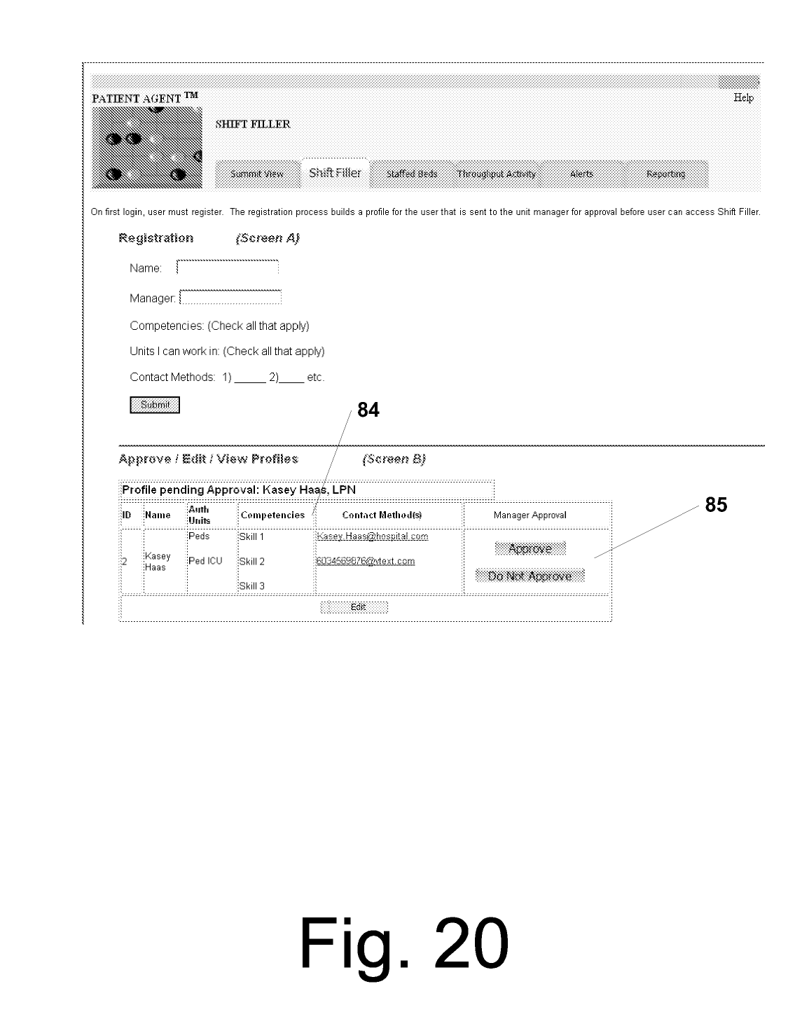

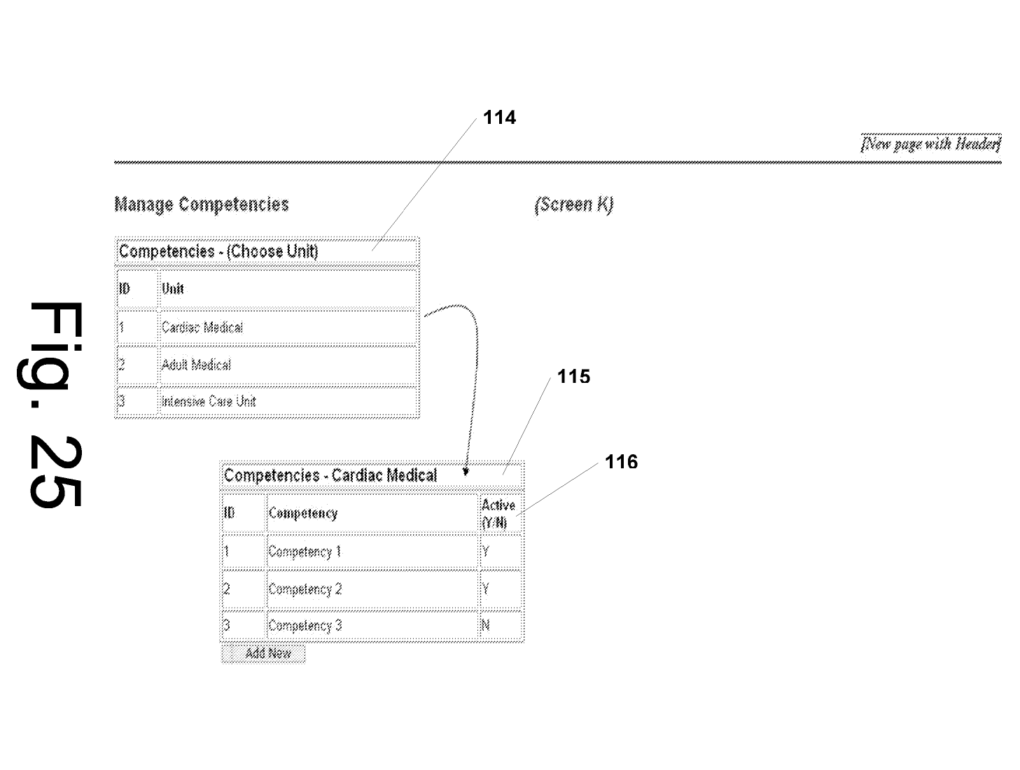

The Shift Filler Module 9 pulls empty shifts from the organization's scheduling system and acts as a bidding and lottery shift filler. For supporting documentation, see the Shift Filler Module 9 and the screen shots of the Shift Filler as seen in FIGS. 20-26.Shift Filler. The Shift Filler Module 9 is an improvement over prior art systems that staff hospital beds with healthcare workers. The improvement integrates information on a hospital that would affect placing a patient in a bed, thus giving awareness as to the available healthcare workers in each unit according to a schedule prior to placing a patient in a unit.

In a ‘lottery bid’, one bid is randomly from among all the bidders for a particular empty shift position. In a “double lottery” bid, the selected bid may also get a bonus for being the ‘winner’, thus further making the ‘lottery’ bid more attractive to bid on for an otherwise unattractive shift to work. As such, the “double lottery” bit places both the pay amount and the bonus ‘in the hat’ for random selection.

The Shift Filler Module 9 provides a solution to a prior art problem. Many hospitals experience a shortage of RN's and hospitals need to try to come up with a way to attract RN's to fill certain undesirable shifts. The shift filler module 9 leverages the Scheduling System 15 such that the shift filler module 9 will reveal any holes or vacancies in upcoming shifts. Then, it's up to a manager to choose whether or not to even use this module. Although the holes in a schedule continue to show up to reveal when a shift is not filled, if a manager needs to fill a shift with holes, the manager has three options with the shift filler module 9 that give administrators the ability to customize how placement of healthcare workers on a unit for a schedule is accomplished, including how much money to pay. In a first choice, the hospital indicates how much they are willing to pay to fill a hole in a shift. The healthcare workers can enter their names and one worker will be chosen. In this first option all healthcare workers will knows what is being paid. The shift filler module 9 provides a lottery to attract bids from RNs to fill up shifts.

Three (3) options for bidding are available. One option is a set rate of pay. Another option is to accept bids for a base pay rate plus a set percentage. A third option is ‘time and a half’ or another amount defined by a manager. The available options are displayed to the bidders. If an RN sees an empty shift that will pay a higher amount than a standard rate, perhaps even an unexpectedly higher amount due to a ‘lottery’ provision, then the attractiveness to submit a bid is increased.

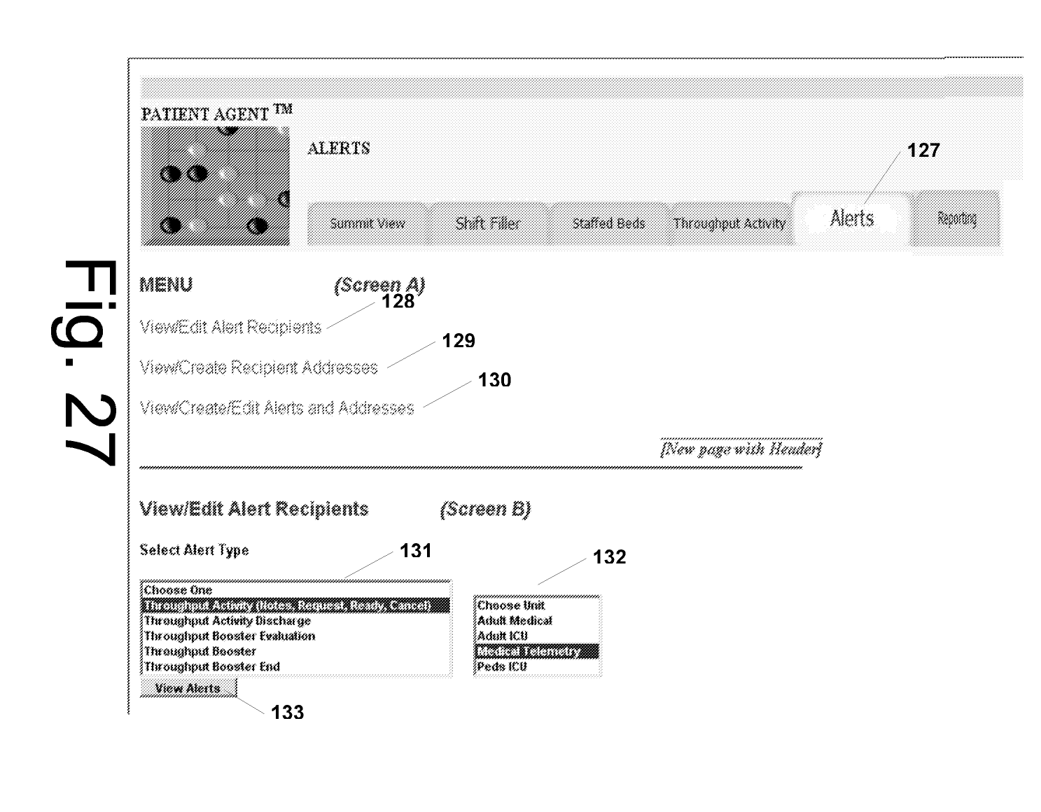

In Alert module 10, for supporting documentation, see the screen shots of the Alert Module 10 seen in FIGS. 27-29. The Alert Module 10 handles all alerts, including electronic messages that are delivered in any number of thick and thin clients. Each alert is manageable by a unit and/or by the staff of the unit, including how alerts are received (e.g.; e-mail, text message, cell phone), which alerts will be received, and whether alerts are enabled to appear on a display screen, etc.

The Reporting Module 11 allows users to access reporting functions, including requests for demand reports, periodic reports, and all kinds of reports.

The Patient Agent Patient Data Store 3 and the Patient Agent Throughput Data Store 5 are updated by the operation of the system in response to requests by system administrators, authorized users, or in response to messages from the Patient Agent Real Time HL7 Interface 2, other system feeds through the Network File Share 4, or other client requests.

The Patient Agent Throughput Management System 1 can be configured to connect to any system necessary (not shown) provided the source system can create an ASCII text file containing the exported data. This allows the system 1 to be customized to meet the needs of any existing facility.

The Throughput Management System 1 is connected to the facility's already existing back up and disaster recovery systems (not shown). This allows the facility to decide how best to ensure system availability and recoverability should outages or disasters occur.

Alternatively, the patient data received from the health care facility admissions department can be retrieved, formatted and stored for use by the Patient Agent Throughput Management System 1 using various other methods and configurations, thus the FIGS. 2-11 should be understood as only exemplary representations of the system and methods of the present invention.

FIG. 3 is a flowchart of relationships for Patient Agent Data Store 3, in one exemplary implementation, as represented by Tables 3.1 through 3.18 each of which is shown in Appendix D. Errors during the processing of messages are written to a file by the interface 2 (not shown). Tables 3.1-3.18, seen in Appendix D, have fields where information related to the patient is stored.

FIGS. 4 through 11 illustrate the relationship between Tables 4.1 through 4.70 for a Patient Throughput Database. The fields respectively in Tables 4.1 through 4.70 are shown in Appendix E and are filled with data from the Patient Throughput Database Store 5 shown in FIG. 1. Errors during the processing of messages are written to a file by the interface 2 (not shown). Table 4.0, below, shows where information is stored with respect to the Patient Agent Throughput Management System 1, and Modules 7-10 and 12.

TABLE 4.0

| Tables | Module |
|---|---|
| 4.1 through 4.18 | Throughput Activity Module 8 |
| 4.19 through 4.22 | Alert Module 10 |
| 4.23 through 4.36 | Shift Filler Module 9 |
| 4.37 through 4.46 | Summit View 6 (displayed information) |
| 4.47 through 4.48 | Patient Agent Throughput Management System 1 |
| 4.49 through 4.60 | Staffed Beds Module 7 |
| 4.61 through 4.63 | Healthcare Organization's Employee Information |
| 4.64 through 4.70 | Throughput Booster Module 12 |

Generally, the data stored in the Patient Agent Data Store 3 is referred to herein as being “patient data” meaning the data pertains to a patient. Generally, the data stored in the Patient Agent Throughput Store 5 is referred to herein as being “throughput activity” data meaning the data pertains to patient transfers; “staffed beds” data meaning the data pertains to staffing needs and communication thereof, “shift filler” data meaning the data pertains to filling of future empty shifts; “alerts” data meaning the data pertains to system generated notifications; and throughput booster data meaning the data pertaining to throughput booster activity. The stored data is formatted such that the Patient Agent Throughput Management System 1 is capable of accessing and updating many different data fields related to the patient, the beds in the facility, the bed occupancy levels, the performance of the staff, etc. as well as current, historical, and future information associated with the operation of the hospital.

The Patient Agent Throughput Store 5 stores most relevant information for the management of the patient bed assignments and the bed occupancy of the health care facility for normal operation as well as in emergency situations such as when a large number of beds are needed on short notice.

In the preferred embodiment of the Patient Agent Throughput Management System 1, the web server 21 is coupled to the health care facility's network such that the health care facility's Active Directory Services server 22 can be used to authenticate a user's request to access the Patient Agent Throughput Management System 1. An Active Directory Services server 22 is utilized by the health care facility for user authentication and the Patient Agent Throughput Management System 1 is coupled thereto, such that a user can access the Patient Agent Throughput Management System 1 using the same login identification name and password as he/she uses for access to the network of the health care facility. A typical login screen can be displayed on a client computer 23 of the Patient Agent Throughput Management System 1, wherein a user is prompted to enter a user ID and password (not shown).

Additionally, Microsoft Active Directory 22 shown in FIG. 1 is coupled to the web server computer 21 for controlling user access to the Patient Agent Throughput Management System 1. All user activity is tracked within the Patient Agent Throughput Management System 1. Microsoft Active Directory 22 is configured to provide various levels of security for using the system 1, including task level security, and attribute level security wherein actions performed in using the system are referred to as tasks and each task has various attributes associated therewith. Microsoft Active Directory 22 is configured to associate each user with a specific role, thus the levels of security in the system are based on the role of the user rather than the identification of the individual users, however, a user can be associated with multiple roles.

In using the Patient Agent Throughput Management System 1, each task or attribute thereof is to be executed only by users in certain roles. Thus, prior to executing a user requested task, Active Directory 22 verifies the role of the user and confirms that a user in that role can perform the requested task. Examples of task identifiers used with Active Directory are:
Module—does the user have the authorization to enter this module of the system, e.g. Shift Filler module 9, Alert module 10, etc.
Screen—can the user view a screen, e.g. health care facility summary screen; task-view alert notification information;
Process—register for a Shift Filler auction; and
Indicator—view an indicator, e.g. hospital occupancy level indicator.

Microsoft Active Directory 22 controls the use of the Patient Agent Throughput Management System 1 on a task by task basis, wherein authorization for each requested task is verified based on the group membership of the user's role before the task is executed. Use of Microsoft Active Directory 22 can ensure that the system 1 satisfies HIPAA requirements including those related to patient privacy.

Appendix F defines the feeds scheduled to run from the organization's ADT 13, Clinical Information 14, Scheduling 15, Housekeeping/Bed Tracking 16, Human Resource 17, and Physician Information 18 systems. The data in each feed is written to a .txt file and all data elements are delimited by a pipe (\). There is one entry per row. The data is stored in a location that is accessible to jobs that populate either of the Patient Agent Databases: Patient Data Store 3 or the Throughput Store 5.

Appendix G illustrates a group configuration in Microsoft Active Directory 22. Administrators of the Patient Agent Throughput Management System 1 can assign roles within each group and define authorized tasks for each group. Administrators of Microsoft Active Directory 22 can be used to create the defined group and add the defined roles. Roles may be assigned to one or more groups.

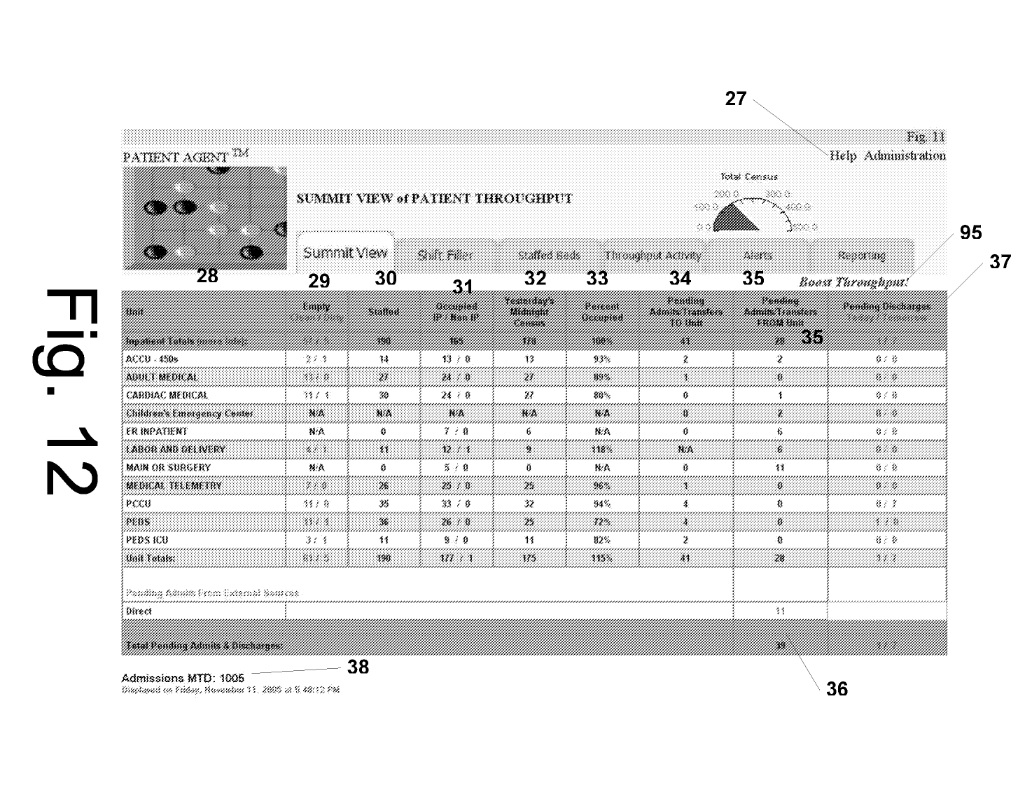

A typical and common log in user interface display screen can be provided for a user authentication screen and used to access the Patient Agent Throughput Management System 1 with predefined security settings. Upon being granted access, the user can be presented with the display screen of FIG. 12.

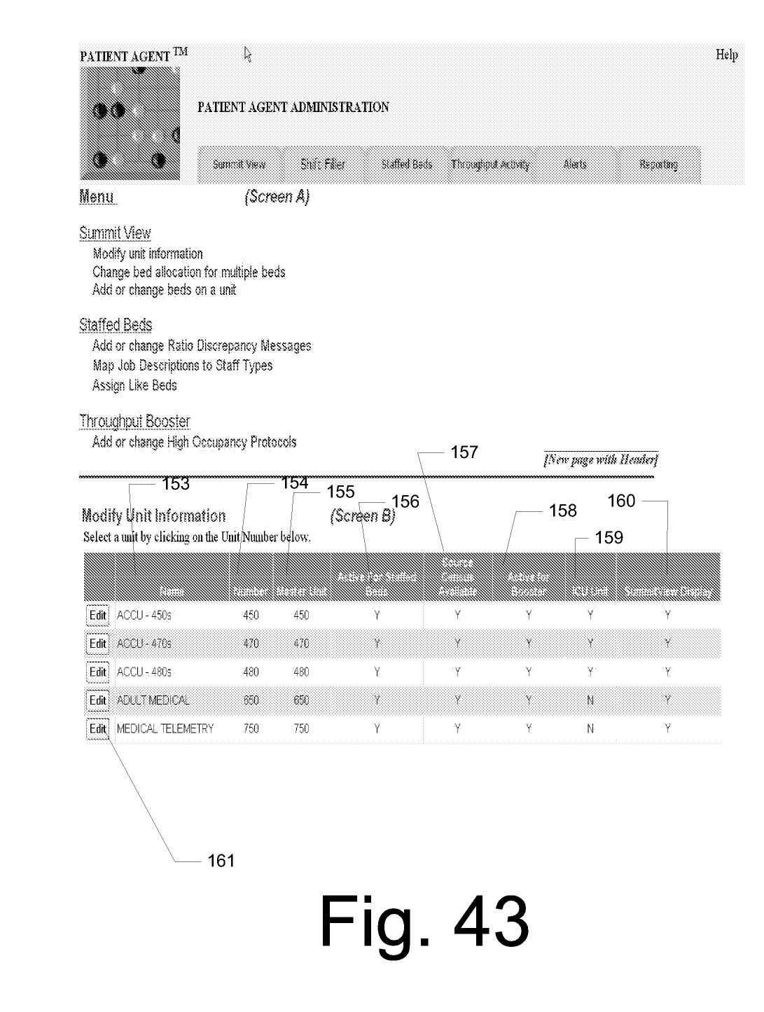

Referring to FIG. 12, the Patient Agent Administration link 27 found on the Summit View 6 of the Patient Agent Throughput Management System 1 is provided for use by the administrators of the system 1. The Patient Agent Administration screen as seen in FIGS. 43-46, and will be detailed later, allows administrators to edit the configuration of the system 1. This includes the ability to edit unit definitions, combine units, re-allocate unit beds, create new beds, change ratio discrepancy messages, edit high occupancy protocols, and manage staff types.

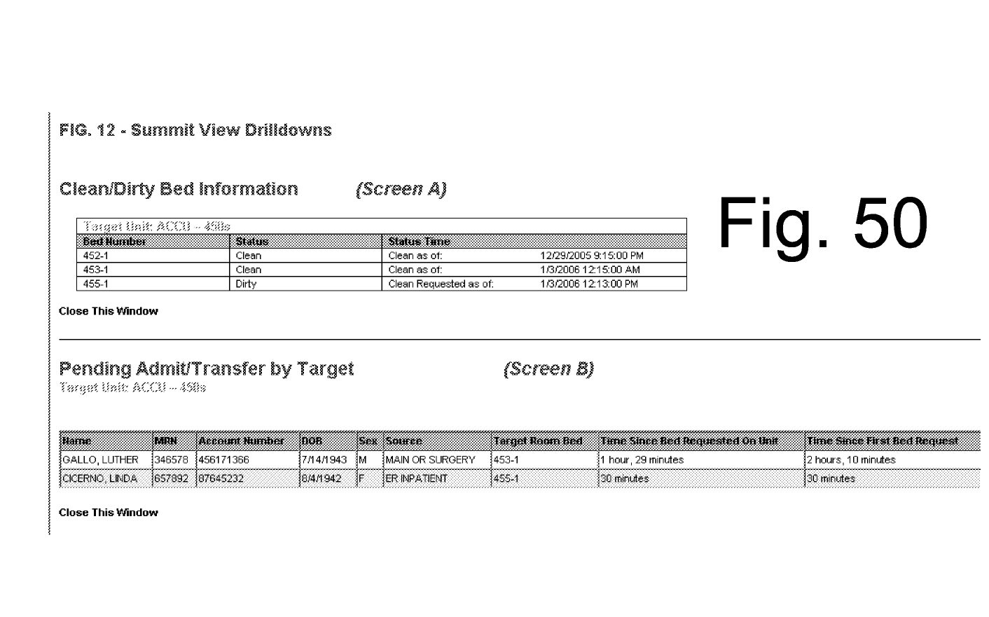

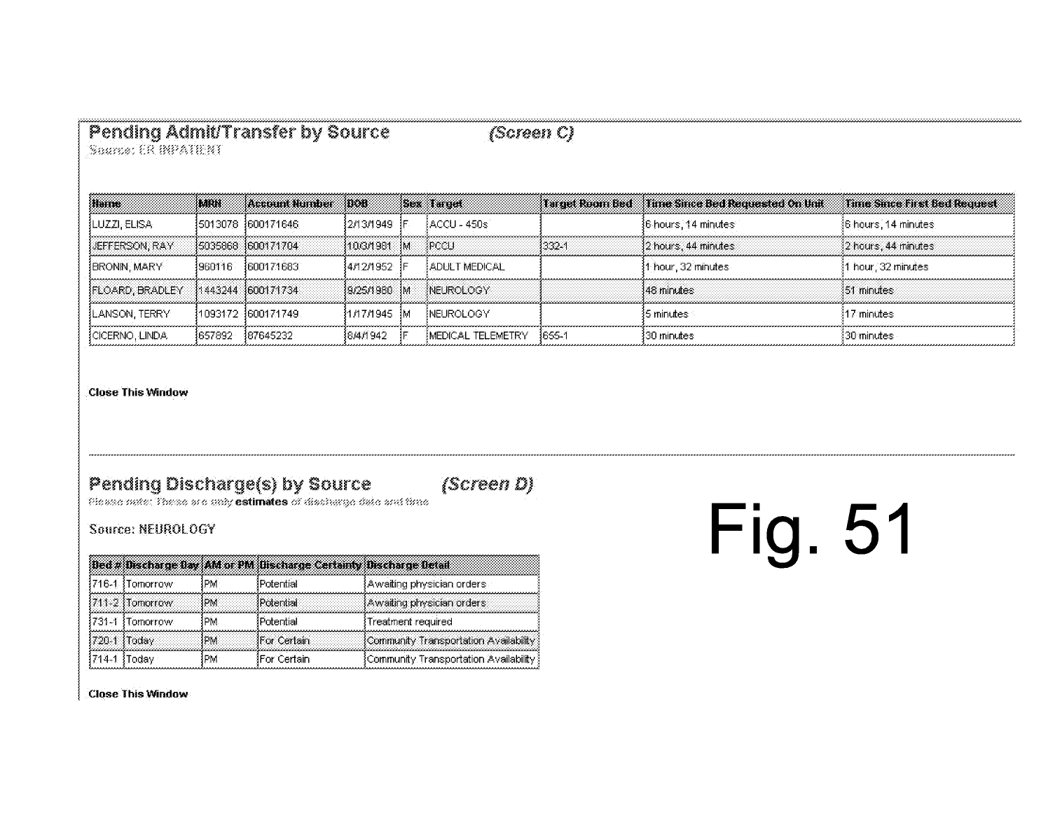

FIGS. 50-51, on screens A through D, show the navigation and use of the Summit View 6 as depicted in FIG. 1. Following authenticated sign-on to the Patient Agent Throughput management System 1, the user would click on the Summit View tab 176 to access the Summit View. Referring to FIGS. 12 and 50-51, the information appearing in the columns of FIGS. 12 Summit View 6 is explained beginning from the left. The facility and units of the organization are indicated at 28. This data comes from the organization's ADT system 13. The next column 29 displays the number of both clean and dirty (meaning any value that does not equal the organization's definition of “clean”) beds assigned to the unit. This is a dynamic link to the data extracted from the organization's housekeeping or bed tracking system 16 and is displayed on Summit View drill down FIG. 50 at Screen A. The next column 30 displays the number of staffed beds that the unit currently has on their unit. This information is manually entered from the unit via the Staffed Beds Module 7. The next column 31 displays the number of occupied beds, showing both the numbers of registered inpatients and observation patients. The next column 32 displays the most recent midnight census on each unit. The next column 33 calculates the percent occupancy based on division of the occupied amount by the staffed amount. The next column 34 displays the number of pending admits and transfers to the unit. This is a dynamic link to the admit/transfer detail from the Throughput Activity Module 8 and is displayed in FIG. 50 at Screen B. Transfers coming from external sources are displayed following the list of units at 36. The next column 35 displays the number of pending transfers from the unit. This is a dynamic link to the transfer detail from the Throughput Activity Module 8 and is displayed in FIG. 51 at Screen C. The last column 37 displays the number of pending discharges anticipated today and tomorrow. This is a dynamic link to the discharge detail from the Throughput Activity Module 8 and is displayed in FIG. 51 at Screen D. The total admissions to date for the month are displayed at 38. This data comes from the organization's ADT system. The Boost Throughput link 95 is a link to the Throughput Booster module 12. The Throughput Booster Module 12 activates a variety of functions to make beds in a healthcare facility available to patients, such as where there is a bottleneck causing patients to be waiting in an Emergency Room due to the unavailability of beds. This module generates alerts that go out throughout a hospital. These alerts are generated automatically without human intervention without anyone needed at a specific unit (e.g.; ER, Surgery, recovery, etc.) The Throughput Booster Module 12, after sending alerts, constantly monitors measured patient counts and directs alerts to the responsible administrators as well as to general administers who can see a display of the “Summit View” to assess the bottleneck situation from a plenary view of the healthcare facility. The Throughput Booster Module 12 is also helpful in getting patients who have been designated for admittance to be admitted prior midnight when a census is taken for accounting purposes.

The Throughput Booster Module 12 creates historical records of the status of a healthcare facility when a boost was needed. These recorded summit view snapshots of a hospital allow a historical view of needs on a unit-by-unit basis. The Throughput Booster Module 12 is further detailed later in reference to FIGS. 43-48.

Navigation and use of the Staffed Beds Module 7 is shown in FIGS. 13-14. Following authenticated sign-on to the Patient Agent Throughput Management System 1, the user would click on the Staffed Beds tab 39 to access the Staffed Beds Module 7. The first screen A prompts the user to select a unit. Once a unit is selected, the main Staffed Beds screen B is displayed. This provides a summarized view of the current staffing on the unit.

Referring to FIG. 13 screen B, the summarized view of current staffing situation on a unit is enabled by displaying desirable information at a glance to help evaluate staffing needs and help management ensure the unit is staffed as efficiently as possible.

Referring to screen B of FIG. 13, the system 1 displays any current Global message from the Staffing Office 40, the unit's nurse to patient ratio 41, Target Staffed Beds 42, Actual Staffed Beds 43, RNs On Call 44, the Occupied Beds 45, the Ratio Discrepancy Message 46, the Have staff numbers 47, the Shortage numbers for each staff type 48, and the Surplus numbers for each staff type 49. The future staffing needs for the unit are summarized at 50. Communications between the unit and the staffing office are displayed at 51.

Referring to screen B of FIG. 13, the Target Staffed Beds 42 is calculated based on the RN to Patients unit ratio 41 and the current RN Have 47 amount. For example, if the unit has a 1:4 RN to patient ratio and the current RN Have is 6 then the Target Staffed Beds number would be 6*(4/1)=24/1=24.

Referring to screen B of FIG. 13, the Occupied Beds 45 data is derived from the patient information as stored in Patient Agent Data Store 3.

Referring to screen B of FIG. 13, the RN Have numbers 47 are derived from the data received by the system 1 as transmitted from the facility's scheduling system 15.

Referring to FIG. 13 screen B, the communications 51 between the unit and the staffing office are displayed in reverse chronological order such that the most recent communication is displayed at the top of the list. Each communication is followed by the source of the note (unit or staffing office) 52, user ID of the person who created the note 53, and the date and time the note was created 54. In some implementations, only the most recent 12 hour's worth of notes are displayed. All communication, however, is stored in Patient Agent Throughput Store 5.

A user is able to update the Unit RN to Patient ratio 41, Actual Staffed Beds 43, RNs on Call 44, the Shortages for each staff type 48 and Surpluses for each staff type 49. This is done by clicking on the Update Staffing Data 55 link and entering the data into the appropriate field and clicking the Submit button. The update screen is not shown.

Referring to screen C of FIG. 14 a user is able to create a new communication by entering the text of the communication 56 and clicking the Submit button 57. A user request is then transmitted to the web server 21 and the system 1 writes the communication, source of the communication, the user ID of the user who created the communication and the system date and time to Patient Agent Throughput Store 5.

Screen D of FIG. 14 represents an administrative screen available from the Staffed Beds Module 7. User accesses this screen by clicking on the Select Staff Types button 263 from FIG. 13 Screen B. This screen allows a user, having proper authorization, the ability to customize the Staffed Beds module 7 to the unit's needs.

Referring to FIG. 14 screen D a user, having proper authorization, is able to control what staff types are displayed for the unit. Since not all staff types are used in every unit of the facility, the user is able to choose which staff types to display on the unit by placing a check in Display checkbox 58 of the desired staff type. To ensure a staff type is not displayed for the unit, the user removes the check from the Display checkbox 58 of the staff type. When finished the user clicks the Submit button 59. A user request is then transmitted to the web server 21 and the system 1 writes the information to the Patient Agent Throughput Store 5. The system 1, allows each unit the ability to define what staff types are displayed in the Staffed Beds Module 7.

Screen E of FIG. 14 is one embodiment of the user interface screen used by the facility's staffing office. This screen displays the current staff shortages and surpluses, as defined by the units using the Staffed Beds Module 7, FIG. 13 screen B. The staff shortages and surpluses displayed on screen E are separated by Unit and Staff Type. Screen E allows the facility's staffing office the ability to quickly assess the facility's staffing situation so that staff can be reallocated as efficiently as possible resulting in increased throughput.

Navigation and use of the Throughput Activity Module 8 is shown in FIGS. 15-19. Following authenticated sign-on to the Patient Agent Throughput Management System 1, the user would click on the Throughput Activity tab 63 to access the Throughput Activity Module. The first screen A seen in FIG. 15 prompts the user to select a unit if they have secured access to multiple units. Once a unit is selected, the main Throughput Activity screen B seen in FIG. 15 is displayed.

Referring to FIG. 15 screen B, the summarized view of current throughput activity on a unit is enabled by displaying desirable information at a glance to help evaluate and maximize patient placement efficiency. Transfers into a unit are summarized at 64. Transfers out of the unit are summarized at 65 and pending discharges are summarized at 66. Use of icons to signify current alerts are shown at 67 and 68. These alerts are visible on the screen as well as received on the unit's other defined devices such as cell phones, e-mail addresses or pagers. The pending transfers can be seen in more detail by clicking on the summary headers 80, 81 and 82.

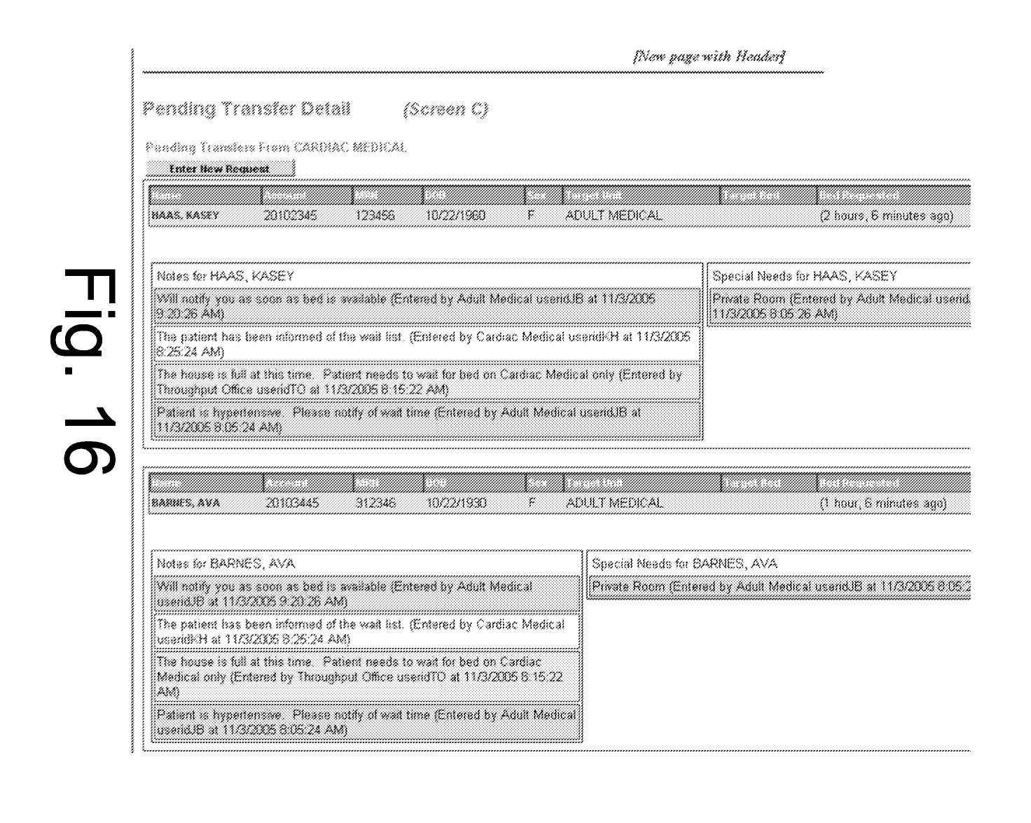

Referring to FIG. 16 screen C, the pending transfer detail is displayed. This detail is accessed by clicking on the summary headers 80, 81 or 82 of FIG. 15 screen B.

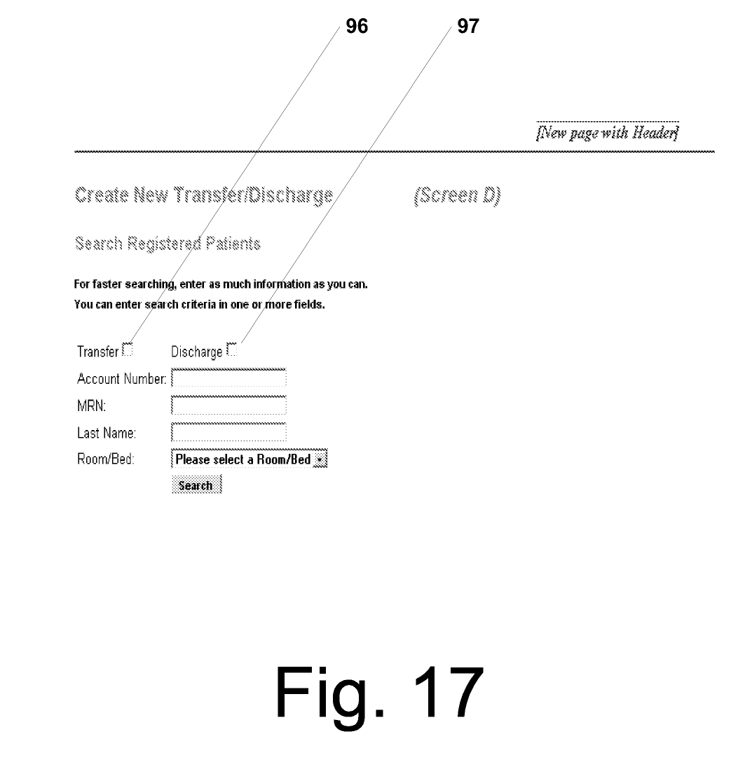

Referring to FIG. 15 Screen B, users can generate a new throughput activity record by clicking on Create New 264. User is taken to FIG. 17 Screen D, designates a transfer 96 or discharge 97 and searches registered patients from the organization's ADT system 13 by account or medical record number, last name or room/bed number.

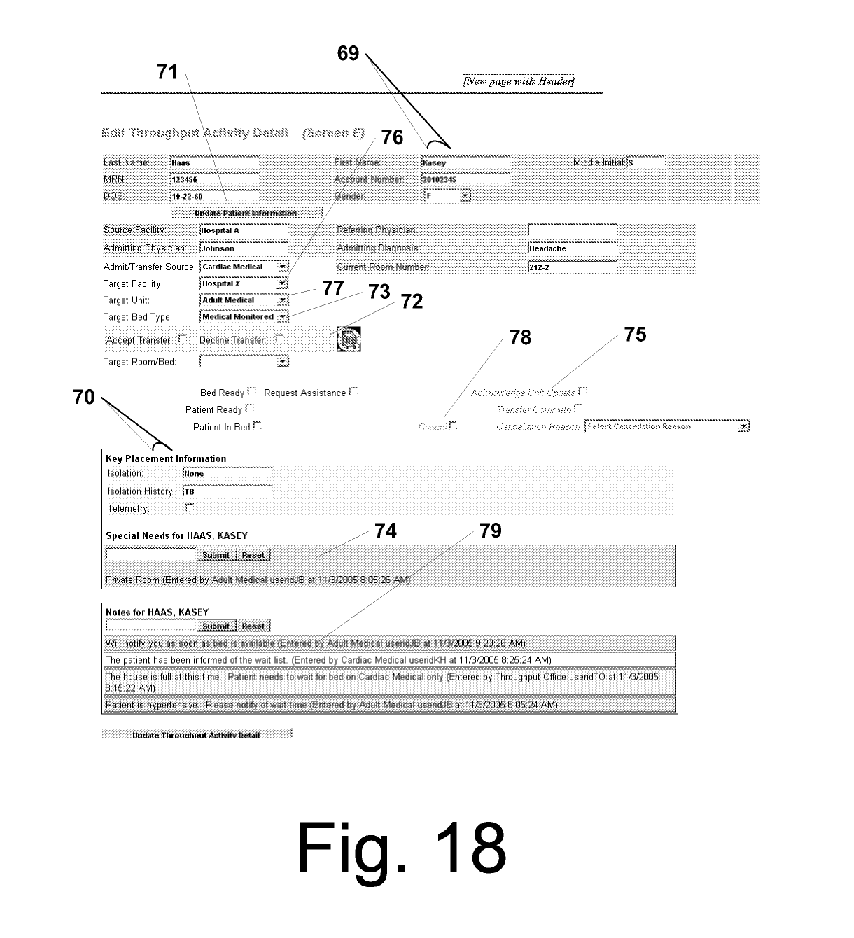

Referring to FIG. 18 screen E, users can edit a throughput activity record either at creation or by clicking on any part of a record from screen B seen in FIG. 15. All throughput records of current registered patients display the following information from the organization's source ADT system 13: Last name, First Name, Middle Initial, MRN, Account Number, Date of Birth, Gender, Source Facility, Admitting Physician, Referring Physician, Admitting Diagnosis and Current Room Number 69.

Referring to FIG. 18 screen E, all throughput records of current registered patients display the following information from the organization's source Clinical Information Management System 14: Isolation, Isolation History and Telemetry 70. The clinical information displayed here is only one example of the data that can be displayed. Any data that can be extracted from the facility's source system can be displayed on this screen.

Referring to FIG. 18 screen E, records for patients without existing ADT records such as Direct Admit patients, can be created and then linked to their official ADT record once it is created by using the “Update Patient Information” function 71. This ensures that all throughput activity demographic information is based on and stored from a single source system.

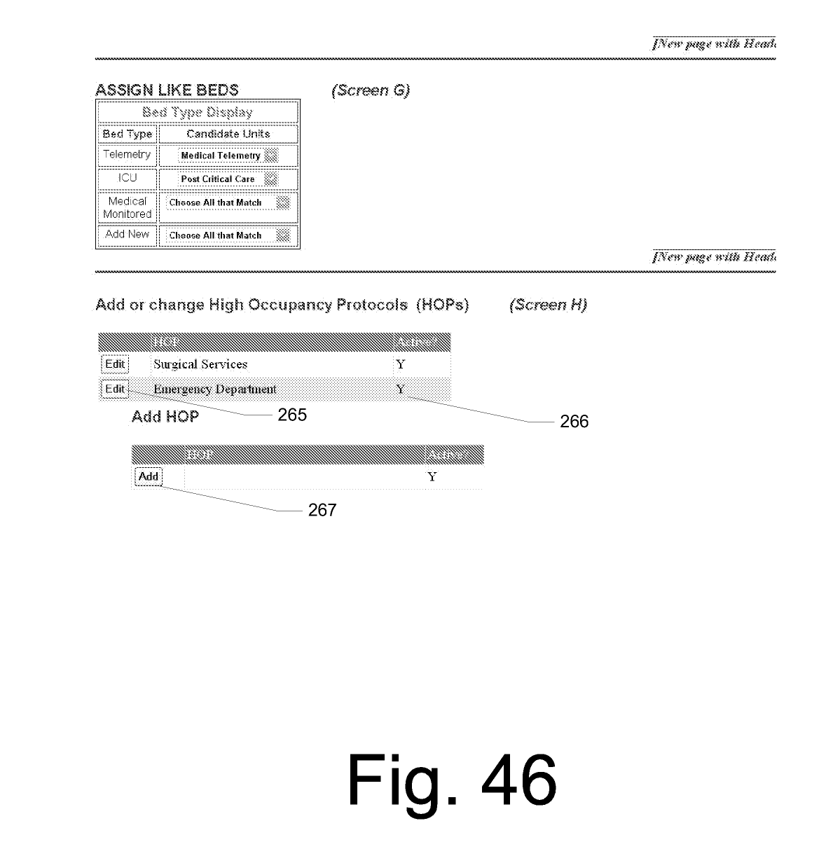

Referring to FIG. 18 screen E, transfers or bed requests that can be accommodated in a number of units containing similar bed types, such as Telemetry or Medical Monitored, is entered as a “Bed Shopping” type bed request and is sent to all units that can accommodate the request. The units that are defined to contain similar bed types are assigned at an administrative level seen in FIG. 46 Screen G. Each unit can either accept or decline the transfer at screen E 72 seen in FIG. 18. As soon as the request is declined or another unit accepts the transfer, the request is no longer displayed on the Throughput Activity screen for all other similar units.

Referring to FIG. 18 screen E, the target 73, Key Placement 70 and Special Needs 74 information is entered by the unit initiating the throughput activity information or request. The staff in the Throughput Office might be the only ones with authority to acknowledge a unit update 75, change a target facility 76 and unit 77 or cancel 78 a Throughput Activity record.

Referring to FIG. 18 screen E, the communication notes 79 are visible to the sending unit, receiving unit and Throughput Office.

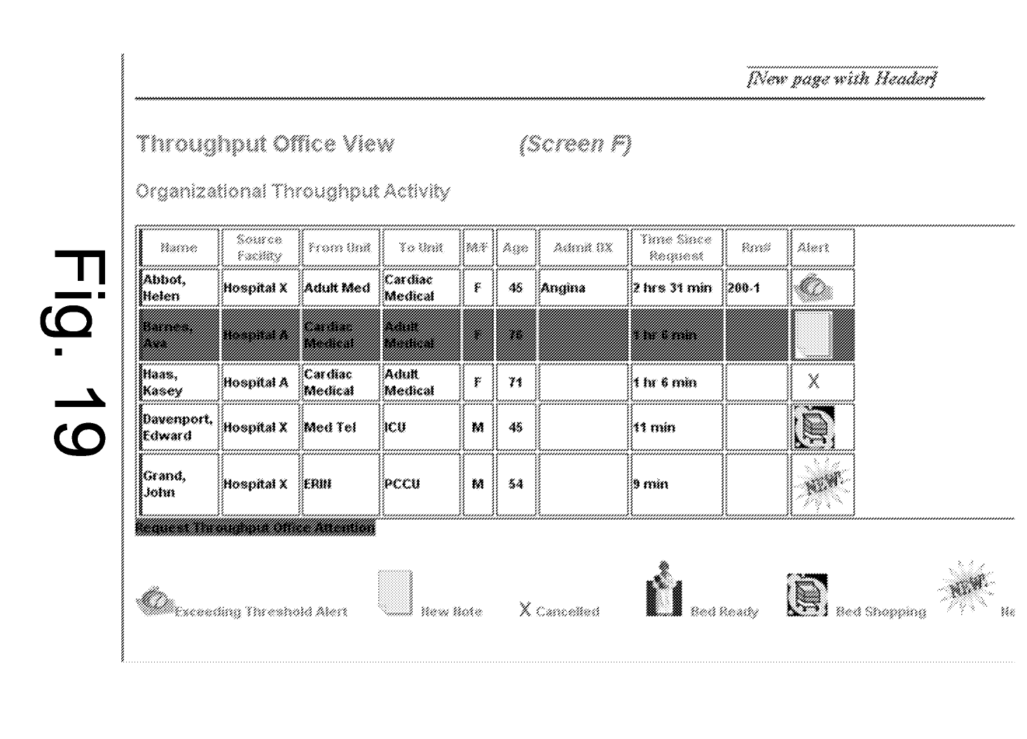

Referring to FIG. 19 screen F, the organization's Throughput Office is able to view all throughput activity for the entire organization. The list of records is sortable by any column. The records that need immediate attention appear in Red, the records that have not been viewed by the Throughput Office appear in yellow. The system 1 enables the Throughput Office to have a bird's eye view of the organization's throughput activity. This supplies the tools and means to provide facilitation action for all areas of the organization if needed.

An additional module of the Throughput Management System 1 is the Shift Filler Module 9. The primary purpose of this module is to enable management to identify and fill staffing needs proactively, in an automated manner and in a way that provides more than financial incentive for employee participation. Shift Filler may require that management and scheduling committee personnel primarily utilize the organization's Scheduling system 15 for all scheduling needs. An hourly data feed of empty shifts from the Scheduling system populates the unit's “Shift Filler” task list. If a manager or scheduler cannot fill a shift with known staff resources, he/she may choose to send the shift out to auction (lowest bidder wins), lottery (pay is posted and staff throw their names into a hat for it), double lottery (staff throw their names into a hat for the shift and all participants take their chances on getting paid their salary plus 10%, their salary plus $10 or a static desirable dollar amount). A notice is sent to each staff member who matches the certification criteria and has entered a means of communication. The recipients may go to the Shift Filler area to “bid” on a shift or register for the lottery.

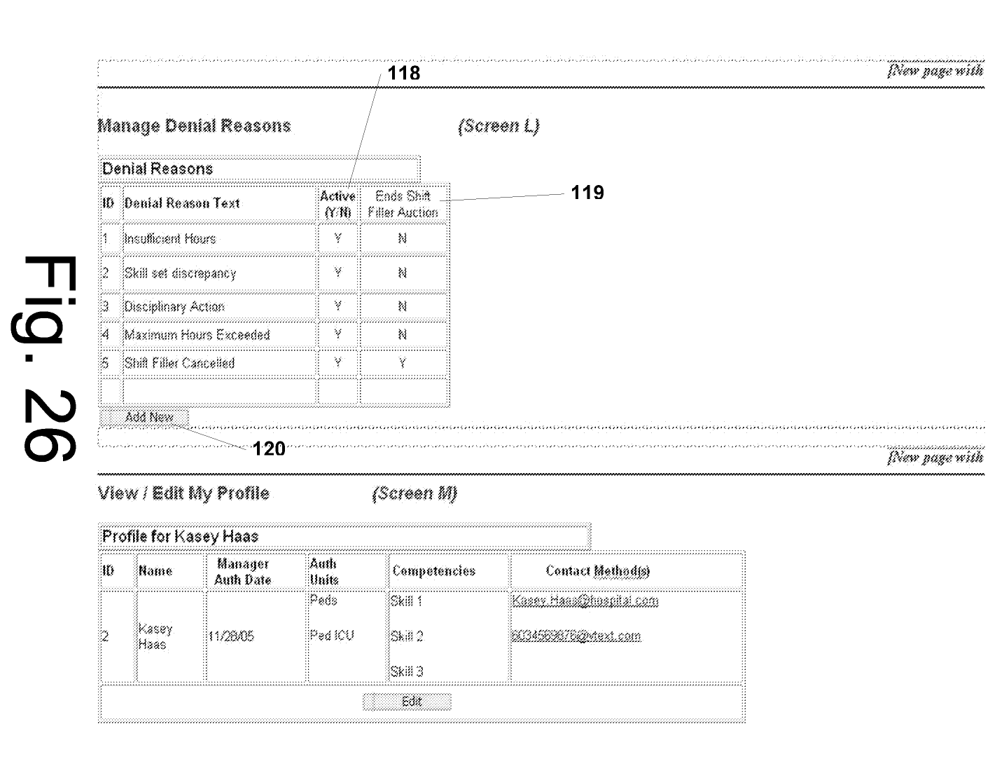

Navigation and use of the Shift Filler Module 9 is shown in FIGS. 20-26. Following authenticated sign-on to the Patient Agent Throughput Management System 1, the user would click on the Shift Filler tab 83 to access the Shift Filler Module 9. On the first login, a non-manager is prompted to register at FIG. 20 screen A. The registration process builds a user profile that can be modified by the user at any time at FIG. 26 screen M. The profile is sent to the unit manager for approval before the user can view or participate in Shift Filler 9.

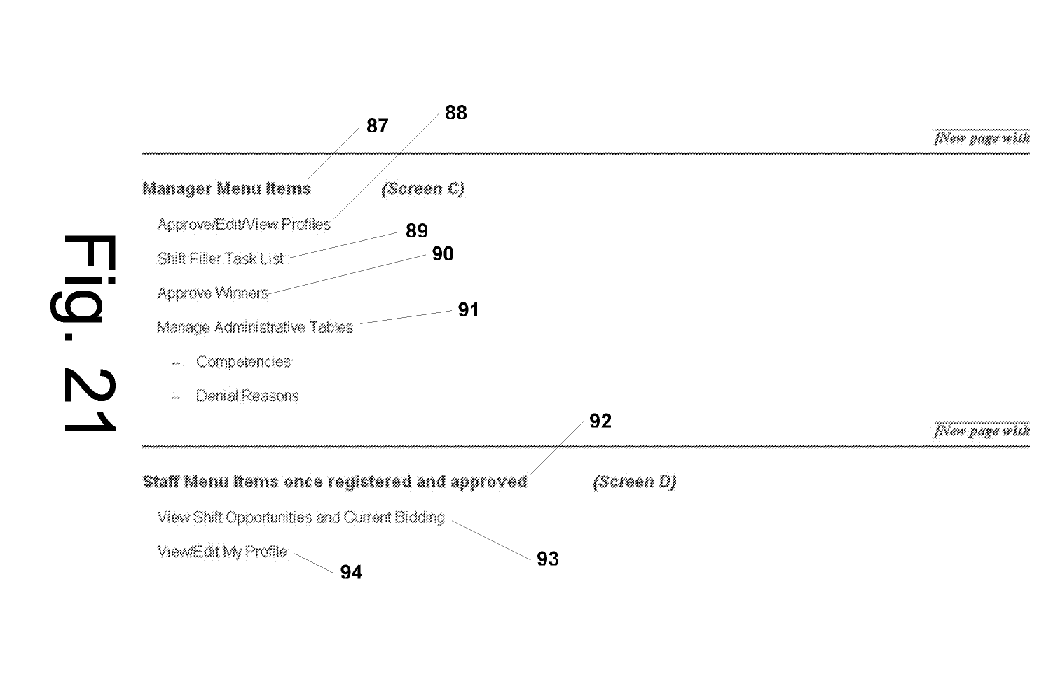

Once a profile has been submitted for approval, the manager is sent an automatic alert. The manager clicks manager menu item 88 from FIG. 21 Screen C entitled Approve/Edit/View Profiles.

Referring to FIG. 20 screen B, the manager determines if the user competencies 84 are valid, may edit the record 86 and chooses to either approve or not approve 85 the user to participate in Shift Filler 9.

Referring to FIG. 21 screen C, the menu items present based on user role in the organization. The menu 87 on screen C is for managers. It enables managers to approve, edit and view user profiles 88, view and assign shifts for auction or lottery 89, approve shift filler staff 90 and administer supporting tables 91.

Referring to FIG. 21 screen D, the menu 92 for registered clinical staff enables users to view shift opportunities, bid on auctions, register for lotteries, view current status of lotteries and auctions 93 and view or edit their own profile 94.

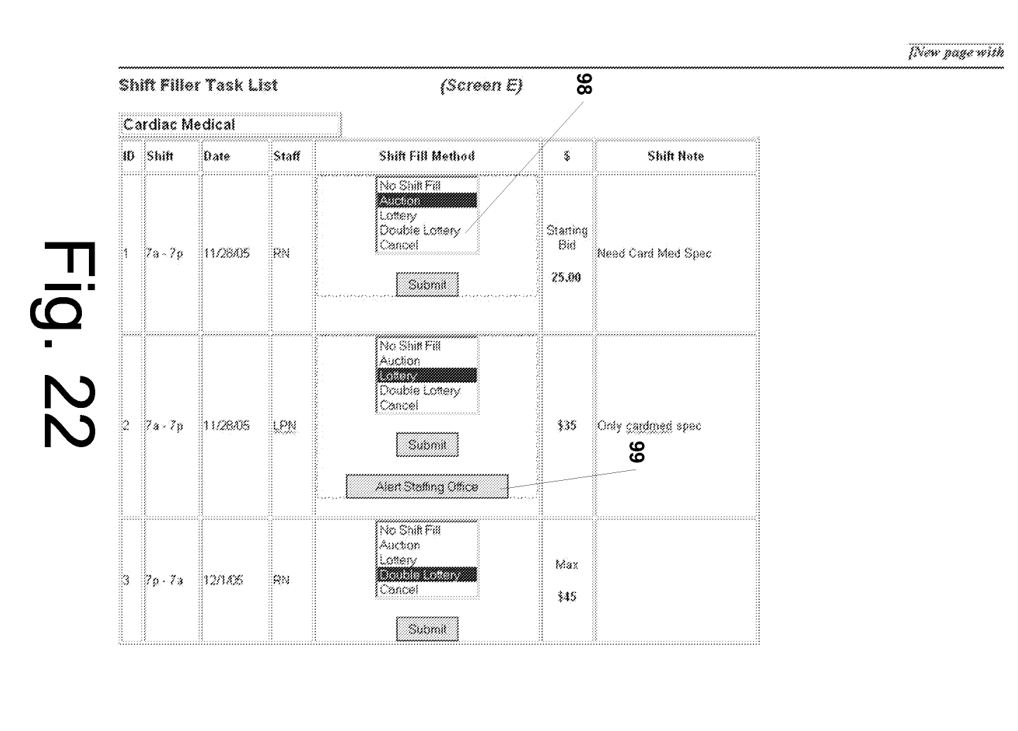

Referring to FIG. 22 screen E, the empty shifts are displayed on the manager's Shift Filler Task List. These shifts come from a feed of unfilled shifts from the organization's Scheduling System 15. From this list, the manager determines if the shift should be included in an auction, lottery, double lottery 98 or sent to the Staffing Office 99.

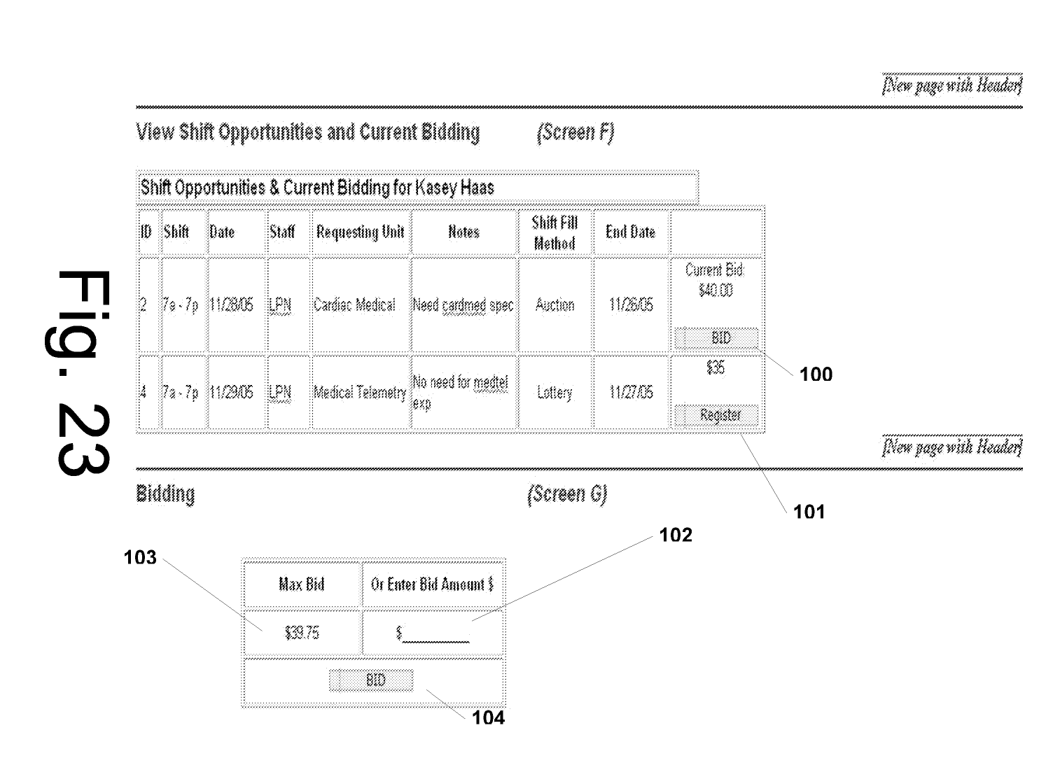

Referring to FIG. 23 screen F, registered users will see a list of shifts that have been sent to lottery or auction that they are authorized to work. If the employee is interested in working the shift they can click the Bid 100 or Register 101 button next to the desired shift.

Referring to FIG. 23 screen G, the Bidding screen is displayed by clicking on the Bid 100 button or Register 101 button of FIG. 22 Screen E. The user is able to enter a Bid Amount 102 that is equal to or less than the Max Bid 103. When finished the user clicks on the Bid 104 button to save the bid to the system 1.

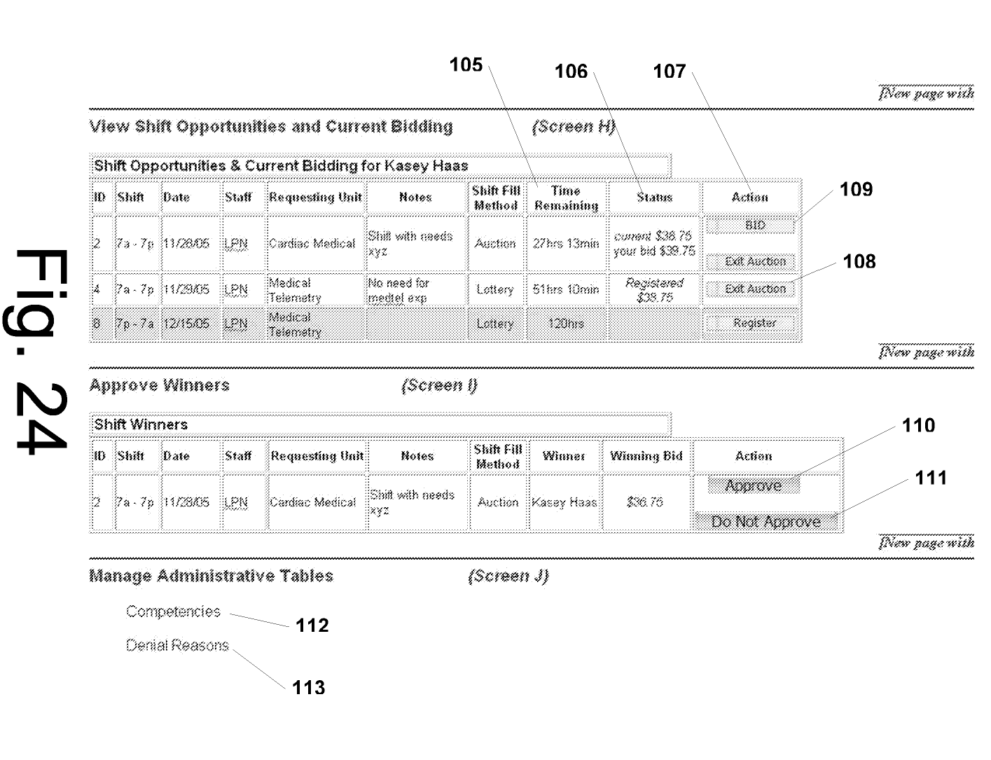

Referring to FIG. 24 screen H, a registered user is able to keep track of the current bidding situation for all shifts the employee is authorized to work including Time Remaining 105, Status 106 and Action 107. If the user decides that they are no longer interested in working the shift and the lottery or auction has not ended the user my click the Exit Auction 108 button next to the desired shift. If the user wishes to place a new bid, the user clicks on the Bid 109 button and the same bid screen illustrated in FIG. 23 screen F is displayed.

Referring to FIG. 24 screen I, the manager is able to approve the winner of the auction or lottery by clicking the Approve 110 button or the Do Not Approve 111 button. If approved the employee receives an alert. If not approved, the manager selects a denial reason (not shown). Once selected, the denial is saved to the database and the runner up is given the opportunity to be approved or denied (not shown).

Referring to FIG. 24 screen J a manager can administer Competencies 112 and Denial Reasons 113 from the Manage Administrative Tables 91 menu option.

Clicking on the Competencies 112 menu option of FIG. 24 screen J displays the Manage Competencies screen as illustrated in FIG. 15 screen K. First the user is presented with a list of units 114. Clicking on the desired units displays the competencies associated with that unit 115. To remove a competency, the user clicks on the desired competency and enters a N in the Active(Y/N) 116 column. A new competency can be added by clicking the Add New 117 button at the bottom of the screen.

Clicking the Denial Reasons 113 menu option of FIG. 24 screen J displays the Manage Denial Reasons screen as illustrated in FIG. 26 Screen L. Referring to FIG. 26 screen L, the user is able to deactivate a Denial Reason by clicking on the desired Denial reason and entering an N in the Active(Y/N) 118 column. The user is also able to enter a Y or N in the Ends Shift Filler Auction 119 column. This action will end the auction without a winner and notify participants. To add a new Denial Reason, the user clicks the Add New 120 button at the bottom of the screen.

The Alerts Module 10 is used to manage all alert recipients used by system 1. When an alert is triggered, the system 1 will search the Patient Agent Throughput Store 5 for all recipients that are registered to receive the alert. An alert message will then be generated by the system 1 through Patient Agent Throughput Store 5 and sent to the recipient's pre-defined address using the facility's e-mail server 20.

Recipients are divided into two categories; employees and locations. Employees include the current employees of the facility. Locations are user definable recipients for alerts. One example of a location may be a particular pager that resides on a nursing unit for everyone's use.

Navigation and use of the Alerts Module 10 is illustrated in FIG. 27-29. Following authenticated sign-on to the Patient Agent Throughput Management System 1, the user would click on the Alerts tab 127 to access the Alert Module 10. At that point the user is presented with screen A of FIG. 27. This screen displays a menu list of functions that can be performed from this module. This menu includes the ability to View/Edit Alert Recipients 128, View/Create Addresses 129, and View/Add/Edit Alerts and Addresses for Employees and Locations 130.

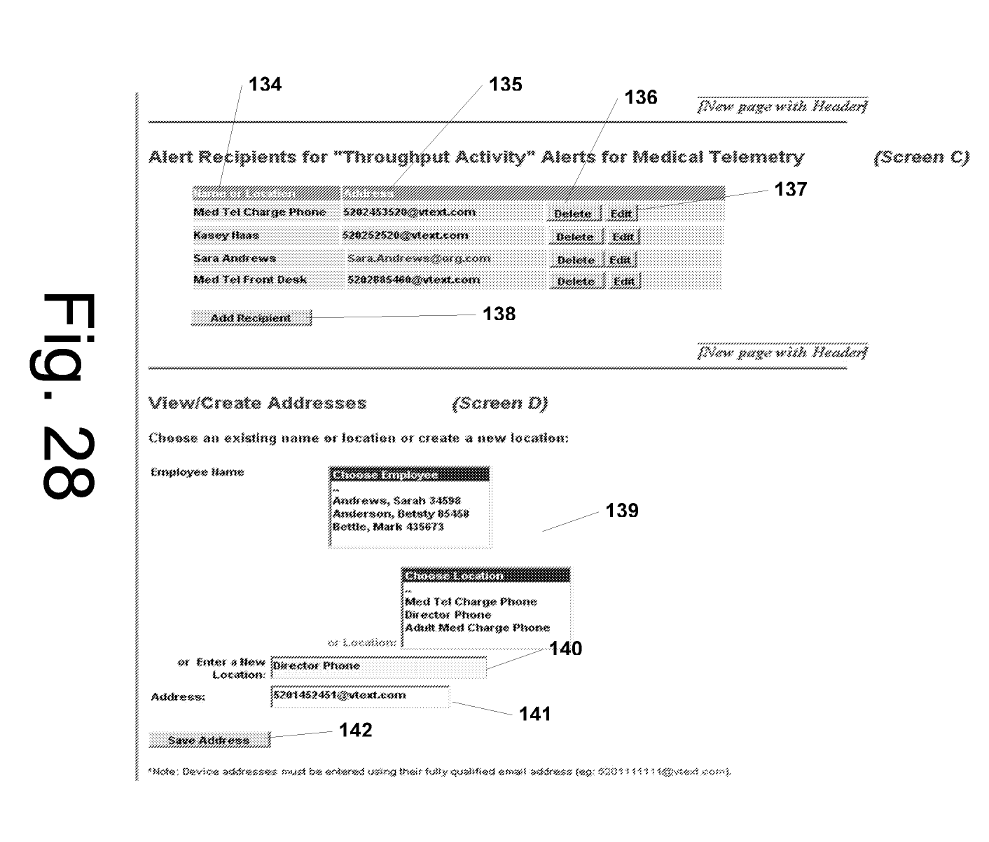

When the user clicks on the View/Edit Alert Recipients 128 option of screen A, Screen B of FIG. 27 is displayed. From this screen a user first selects the type of alert from the Alert Type drop down box 131. The user then selects the desired unit from the Units drop down box 132. When finished, the user clicks the View Alerts 133 button. Screen C of FIG. 28 is then displayed with all the existing alerts that have been defined in the system

Referring to screen C of FIG. 28 the user is presented with a list of all defined system alerts matching the criteria chosen from screen B seen in FIG. 27. The user is able to see the Name or Location of the recipient 134, the Address 135 used by the system 1 to send the alert, a Delete button 136 and an Edit button 137. From here the user is able to edit or remove any existing recipient from the list. To edit a recipient, the user clicks the Edit button 137 next to the desired recipient. To delete the recipient the user clicks the Delete button 136 next to the desired recipient. Additionally, the user is able to create a new recipient by clicking the Add Recipient button 138 at the bottom of the screen and entering the recipient details (screen not shown).

When the user clicks on the View/Create Recipient Addresses 129 option of screen A seen in FIG. 27, Screen D of FIG. 28 is displayed. First the user can either choose the existing recipient name or location from the Employee Name and Location 139 dropdown list. If a new location recipient is being created, then the user enters the new location in the Enter a New Location 140 text box. Once the employee or location has been selected or entered, the user enters or edits the address of the recipient in the Address 141 text box. When finished, the user clicks on the Save Address button 142 to save this recipient.

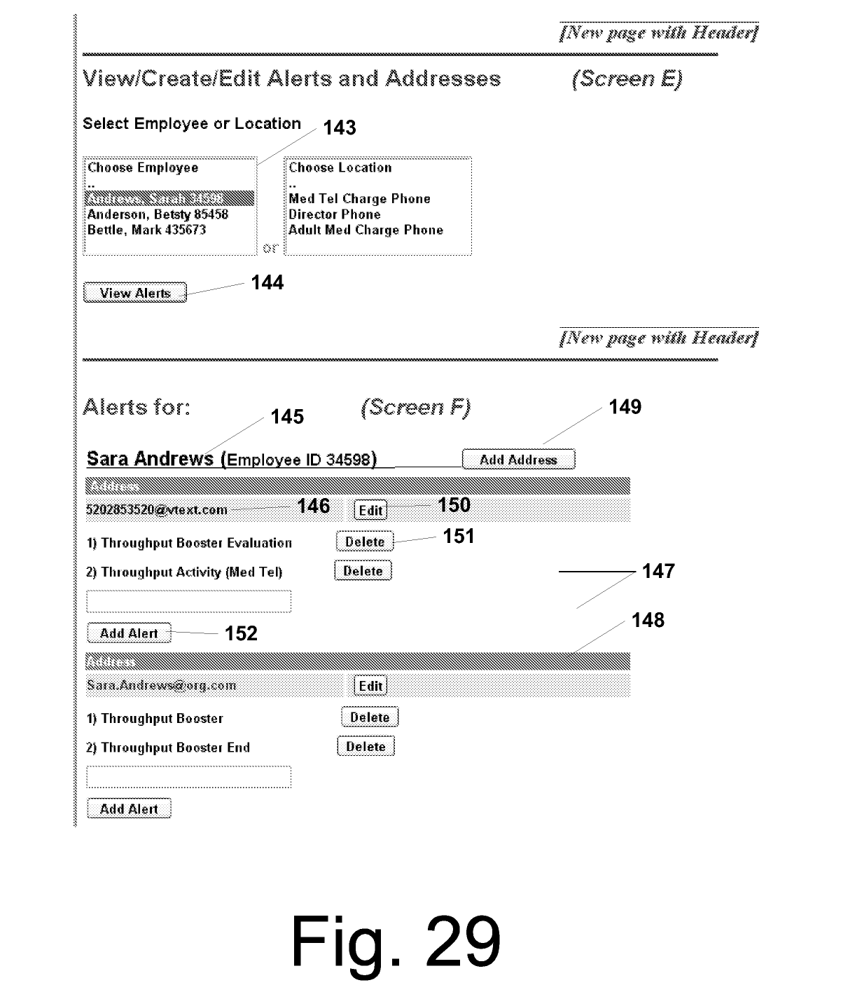

When a user clicks on the View/Create/Edit Alerts and Addresses 130 option of screen A seen in FIG. 27, screen E of FIG. 29 is displayed. From this screen a user first selects the Employee or Location from the drop down box 143. When finished, the user clicks the View Alerts 144 button. Screen F of FIG. 29 is then displayed showing all the addresses and alerts defined for the selected recipient.

Referring to screen F of FIG. 29 the user can see the recipient name 145, recipient address 146 and a list of all alerts for that address 147. If a recipient has more than one address stored, the alerts for each subsequent address are displayed below 148 the prior one.

From screen F of FIG. 29, the user is able to add an address by clicking on the Add Address 149 button. Once clicked the user is prompted for the new address (not shown).

Referring to screen F of FIG. 29 the user is able to edit an existing address. To do so, the user clicks on the Edit 150 button for the desired address. The user is then prompted to edit the address (not shown).

Referring to screen F of FIG. 29 the user is able to delete an existing alert. To do this the user clicks on the Delete 151 button of the desired alert. The user is then asked to confirm the deletion. If confirmed, the alert is deleted. If not confirmed the alert is kept and no changes are made (not shown).

Referring to screen F of FIG. 29 the user is able to add an alert to an existing address by clicking the Add Alert 152 button. Once clicked the user is able to select the new alert from a list of available alerts (not shown).

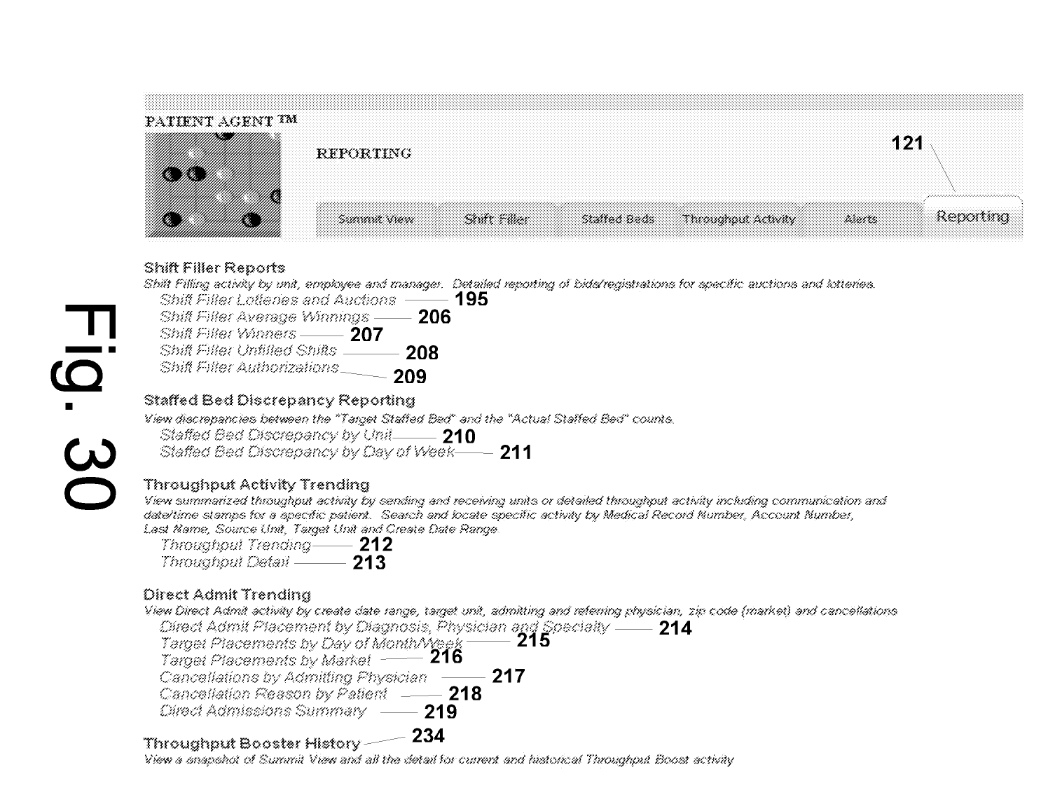

Navigation and use of the Reporting Module 11 is shown in FIG. 30. Following authenticated sign-on to the Patient Agent Throughput Management System 1, the user would click on the Reporting tab 121 to access the Reporting Module 11. The Reporting Module 11 allows a user the opportunity to generate reports from the system 1. These reports are designed to assist the staff in maximizing patient throughput, as well as, provide summaries and analysis of the records for the entire facility or a portion thereof.

Referring to the Reporting Menu on FIG. 30, the listed reports are as follows: Shift Filler Lotteries and Auctions 195, Shift Filler Average Winnings 206, Shift Filler Winners 207, Shift Filler Unfilled Shifts 208, Shift Filler Authorizations 209, Staffed Bed Discrepancy by Unit 210, Staffed Bed Discrepancy by Day of Week 211, Throughput Trending 212, Throughput Detail 213, Direct Admit Placement by Diagnosis, Physician and Specialty 214, Target Placements by Day of Month/Week 215, Target Placements by Market 216, Cancellations by Admitting Physician 217, Cancellation Reason by Patient 218, Direct Admissions Summary 219, and Throughput Booster History 234.

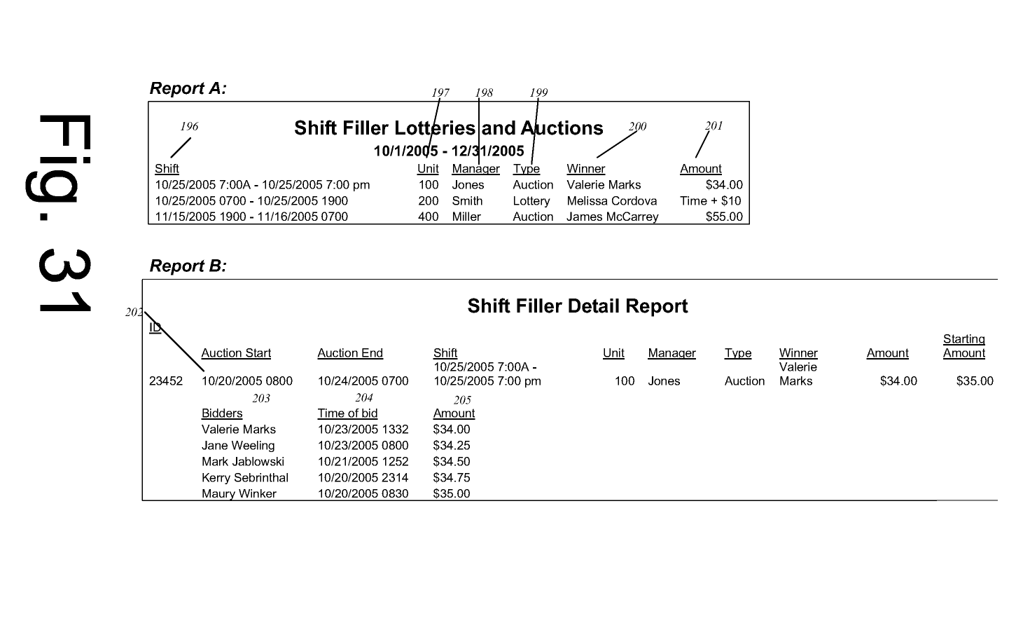

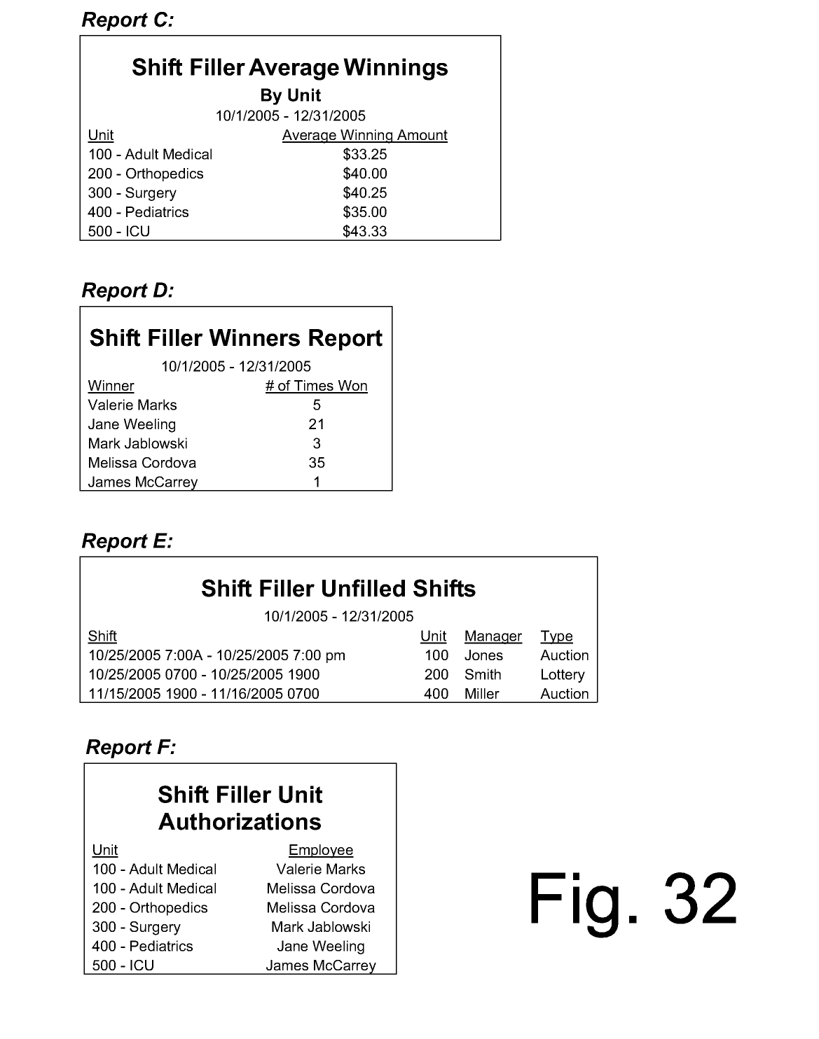

FIGS. 31-32 show examples of the Shift Filler Reports generated by clicking on a Shift Filler report title (195, 206, 207, 208 or 209) from the reporting menu FIG. 30. The generation of these reports is a two step process. First the user enters the desired date range for the report. Secondly, the user clicks the Generate Report button (not shown). A user request is then transmitted to the web server 21 and the system 1 searches the Patient Agent Throughput Store 5 for the report data.

Referring to FIGS. 31-32, Report A is an example of the Shift Filler Lotteries and Auctions report as generated by clicking the Shift Filler Lotteries and Auctions link 195 from the report menu FIG. 30. This report displays a list of all Shift Filler Lotteries and Auctions for the time period selected. The data displayed to the user includes the Shift 196, Unit 197, Manager 198, Type 199, Winner 200 and Amount 201. The user is able to sort by each column of the report by clicking on the column header.

Referring to FIG. 31, Report B is an example of the Shift Filler Detail report as generated by clicking on an auction or lottery record generated by FIG. 31, Report A. This report displays the detail of the lottery or auction 202. Below this detail 202, the following bidding information is displayed: Bidders 203, Time of Bid 204, and Amount 205.

Referring to FIG. 32, Report C is an example of the Shift Filler Average Winnings report as generated by clicking the Shift Filler Average Winnings link 206 from the report menu FIG. 30. This report stratifies by unit the average winning amount of all lotteries and auctions. The user is able to sort by each column of the report by clicking on the column header.

Referring to FIG. 32, Report C, by clicking on any of the entries in the report, the user is able to see a report similar to FIG. 31 Report A to view detail of the auction and lottery information for the selected unit and time period (not shown).

Referring to FIG. 32, Report D is an example of the Shift Filler Winners report as generated by clicking on the Shift Filler Winners link 207 from the report menu FIG. 30. This report stratifies the number of times won by user.

Referring to FIG. 32, Report D, by clicking on any of the entries in the report, the user is able to see a report similar to FIG. 31 Report A to view detail of the lottery or auction won by the selected winner and time period (not shown).

Referring to FIG. 32, Report E is an example of the Shift Filler Unfilled Shifts report as generated by clicking the Shift Filler Unfilled Shifts report link 208 from the report menu FIG. 30. This report displays all shifts that were sent to auction or lottery and were not bid on or registered for by staff.

Referring to FIG. 32, Report F is an example of the Shift Filler Unit Authorizations report as generated by clicking on the Shift Filler Authorizations link 209 from the report menu FIG. 30. This report displays the units and employees authorized to bid on shifts for the selected unit. The user is able to sort by each column of the report by clicking on the column header.

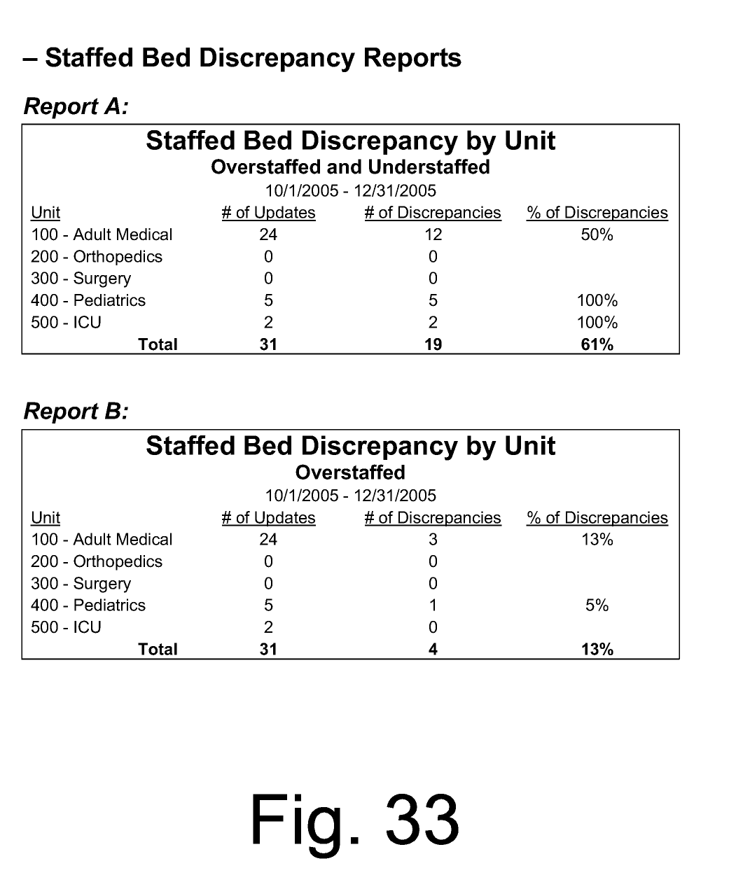

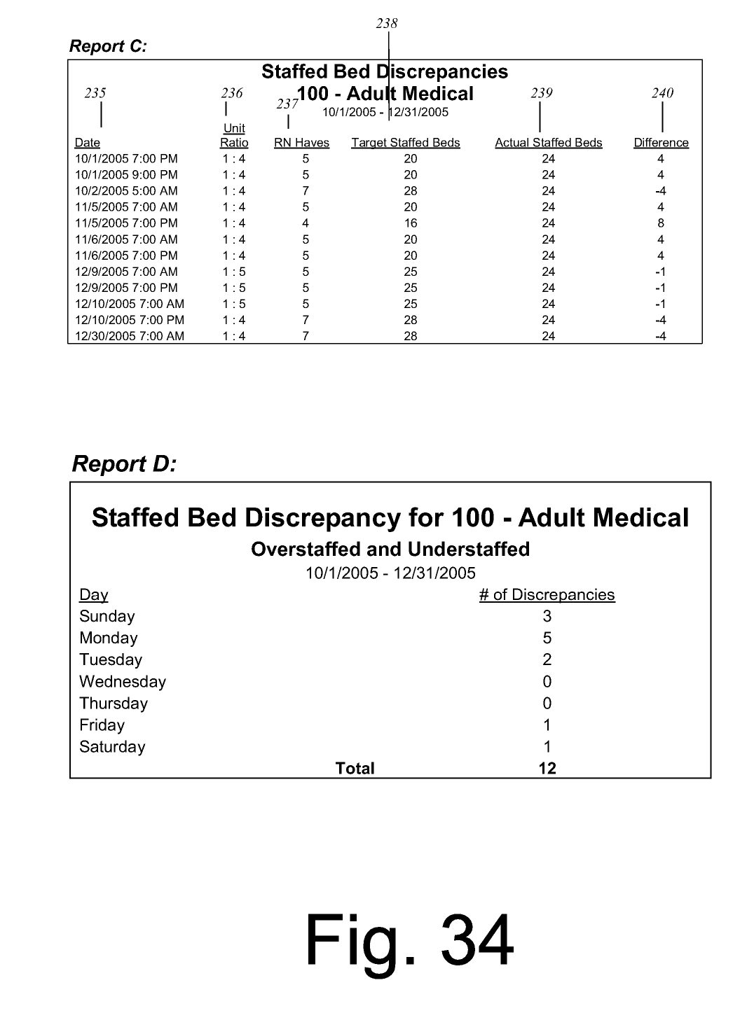

FIGS. 33-34 shows examples of the Staffed Beds Discrepancy Reports generated by clicking on a Staffed Bed Discrepancy report title from the reporting menu FIG. 30. The generation of these reports is a four step process (not shown). The user first enters the date range for the report. The user then selects how the report is stratified (by date, day of week, time, or Unit). The user then selects the type of discrepancy to display (Overstaffed, Understaffed, or Both). Finally, the user clicks the generate report button. A user request is then transmitted to the web server 21 and the system 1 searches the Patient Agent Throughput Store 5 for all staffed bed data (RN Haves 47, Actual Staffed Beds 43 and Unit Ratio 41). The data is then returned and displayed to the user through the web server 21.

Referring to FIG. 33, Report A is an example of the Staffed Bed Discrepancy by Unit report for both overstaffed and understaffed incidents and all units. This report stratifies, by unit, the number of times the Actual Staffed Beds 43 differed from the Target Staffed Beds 42 within the selected date range.

Referring to FIG. 33, Report B is an example of the Staffed Bed Discrepancy by Unit report for overstaffed events only and all units. This report stratifies, by unit, the number of times the Actual Staffed Beds 43 amount was greater than the Target Staffed Beds amount 42 within the selected date range.

Referring to FIG. 33, Reports A and B embody two examples of the Staffed Bed Discrepancy by Unit report. This report could also contain data for understaffed events only (not shown).

Referring to FIG. 34, Report C displays the drill down detail available by clicking on any part of a record appearing in FIG. 33 Report A or FIG. 33 Report B. For each discrepancy summarized in FIG. 33 Reports A or B, this report displays the detail of each unit update. The detail for each update is as follows: Date 235, Unit Ratio 236, RN Haves 237, Target Staffed Beds 238, Actual Staffed Beds 239 and Difference 240.

Referring to FIG. 34, Report D is an example of Staffed Bed Discrepancy by Day of Week report as generated by clicking the Staffed Bed Discrepancy by Day of Week link 211 from the report menu FIG. 30. This report stratifies the number of times the Actual Staffed Beds 43 do not match the Target Staffed Beds 42 by day of week for the selected unit(s).

Report D of FIG. 34 embodies one example of this report. This report could contain data for multiple units as well as understaffed or overstaffed events only (not shown).

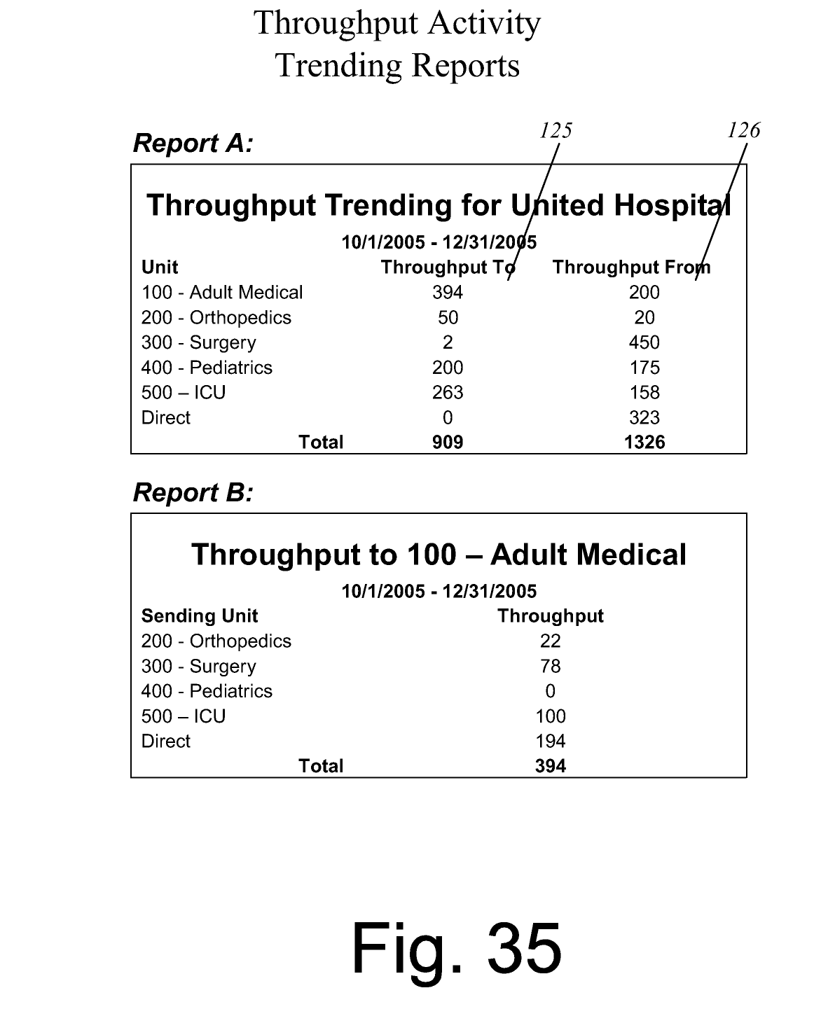

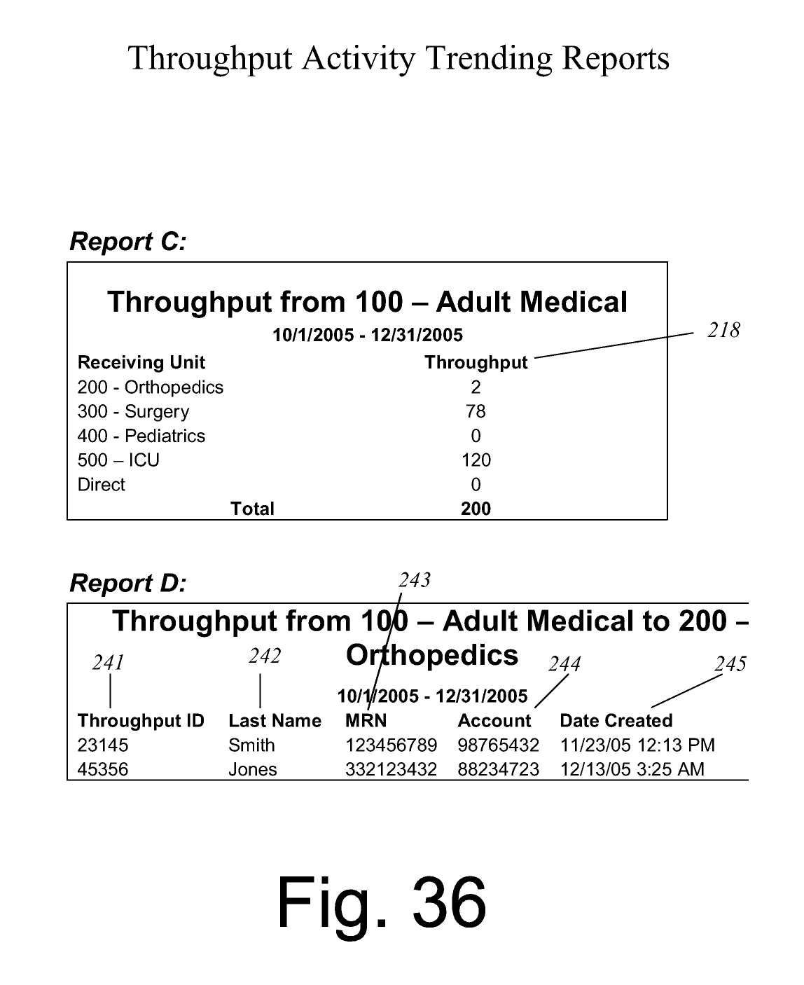

FIGS. 35-36 shows examples of the Throughput Activity Trending generated by clicking on the Throughput Trending link 212 from the reporting menu FIG. 30. The generation of these reports is a two step process. The user enters the date range for the report, and then clicks the Generate Report button (not shown). A user request is then transmitted to the web server 21 and the system 1 searches the Patient Agent Throughput Store 5 for the report data. The data is then returned and displayed to the user through the web server 21.

Referring to FIG. 35, Report A is an example of the Throughput Trending report for the entire facility. This report stratifies patient movement by unit. The Throughput To column 125 displays a count of all patient transfers to the designated unit during the selected time period. The Throughput From column 126 displays a count of all transfers from the designated unit during the selected time period.

Referring to FIG. 35, Report B displays an example of the drill down detail available by clicking on the Throughput To column 125 of a record appearing in FIG. 35 Report A. This report summarizes by sending unit the number of transfers to the selected unit.

Referring to FIG. 36, Report C displays an example of the drill down detail available by clicking on the Throughput From column 126 of a record appearing in FIG. 35 Report A. This report summarizes by receiving unit the number of transfers from the selected unit.

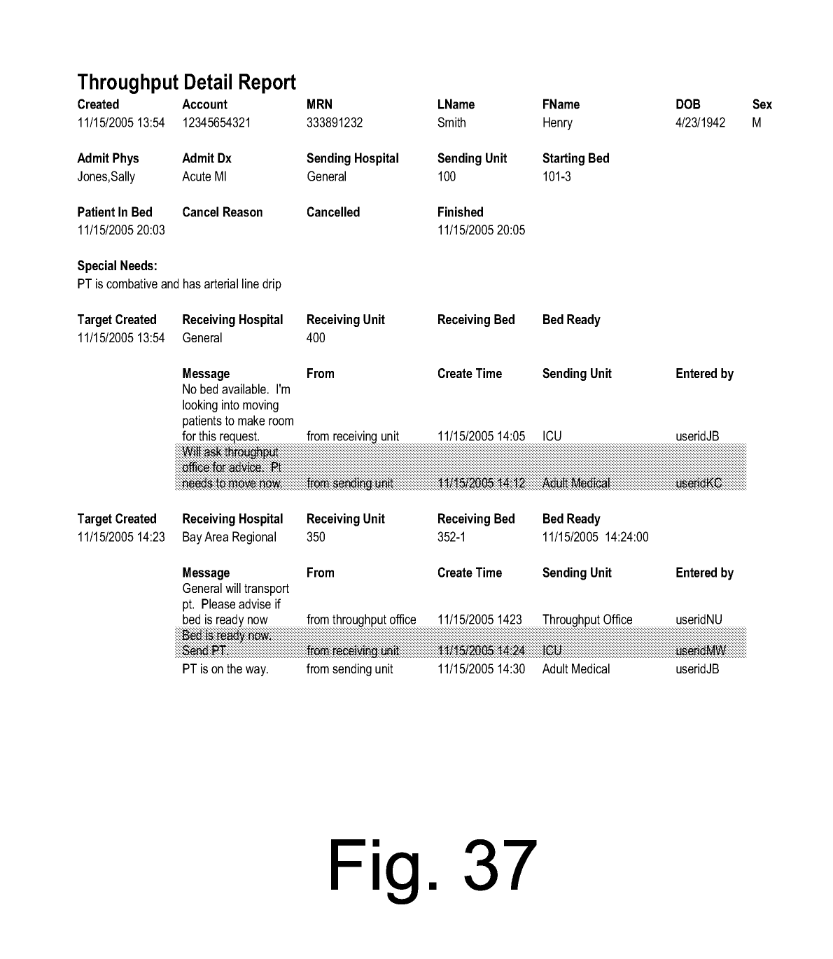

Referring to FIG. 36, Report D displays an example of the drill down detail available by clicking on the Throughput column 218 of a record appearing in FIG. 36 Report C. This report displays the following detail for a transfer between selected units: Throughput ID 241, Last Name 242, MRN 243, Account 244 and Date Created 245. The user is able to click on a specific transfer record in this report to view the Throughput Activity Detail report FIG. 37.

FIG. 37 is an example of the Throughput Detail report generated by clicking on the Throughput Detail link 213 from the reporting menu FIG. 30. This report displays detailed information for a single transfer searchable by patient's last name, account number, medical record number, sending unit or a user defined date range. The generation of this report is a 3 step process (not shown). First the user enters the search criteria in the Last Name, Account Number, MRN, and/or Sending Units fields. Partial entries will result in the search returning all matches. If a field is left blank, the field will not be used to limit the search. Secondly, the user enters the range of dates by which to limit the search. This date range applies to the date the throughput event was created. Thirdly, the user clicks on the Generate Report button. A user request is then transmitted to the web server 21 and the system 1 searches the Patient Agent Throughput Store 5 for the report data. The data is then returned and displayed to the user through the web server 21.

Referring to FIG. 37, The Throughput Detail Report can also be generated by clicking on a record in the Throughput Trending report FIG. 36 Report D.

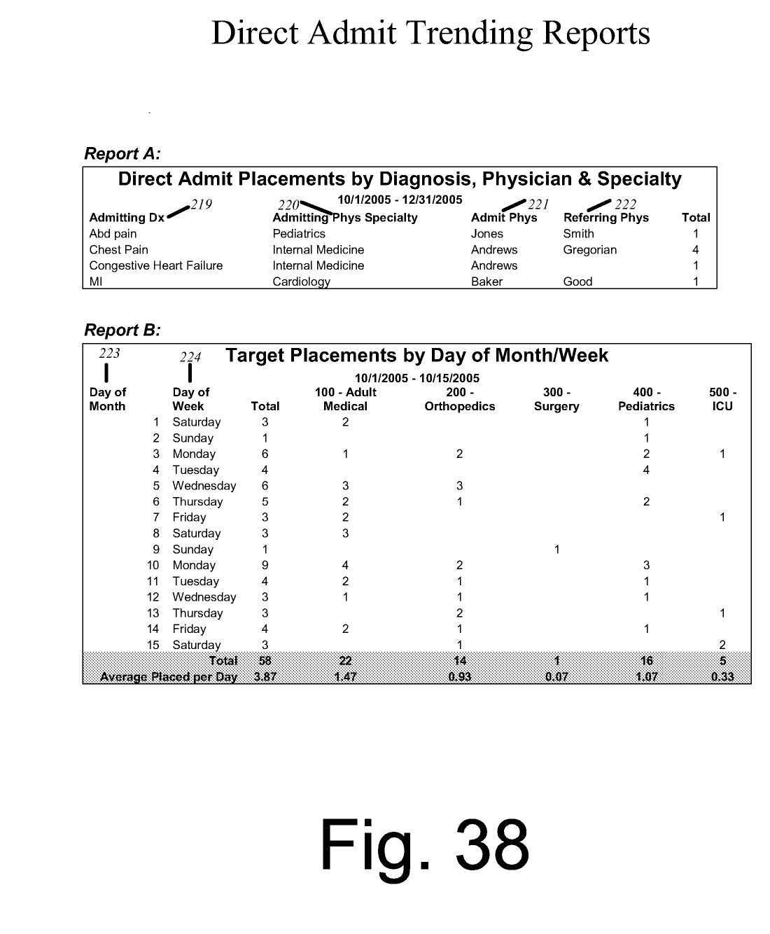

FIGS. 38-41 show examples of the Direct Admit Trending Reports generated by clicking on a Direct Admit Trending report title from the reporting menu FIG. 30. The generation of a selected report is a three step process (not shown). The user first enters the date range for the report. Next, the user selects the report specific criteria. The user then clicks the Generate Report button. A user request is then transmitted to the web server 21 and the system 1 searches the Patient Agent Throughput Store 5 for the report data. The data is then returned and displayed to the user through the web server 21.

Referring to FIG. 38, Report A is an example of the Direct Admit Placements by Diagnosis, Physician & Specialty report as generated by clicking the Direct Admit Placement by Diagnosis, Physician and Specialty link 212 on FIG. 30. This report stratifies direct admits that were placed in the hospital during the selected time period by admitting diagnosis 219, admitting physician specialty 220, admitting physician 221, and referring physician 222.

Referring to FIG. 38, Report B is an example of the Target Placements by Day of Month/Week report as generated by clicking the Target Placements by Day of Month/Week link 213 on FIG. 30. This report displays the number of direct admits placed to each unit by the day of the month 223 and day of the week 224.

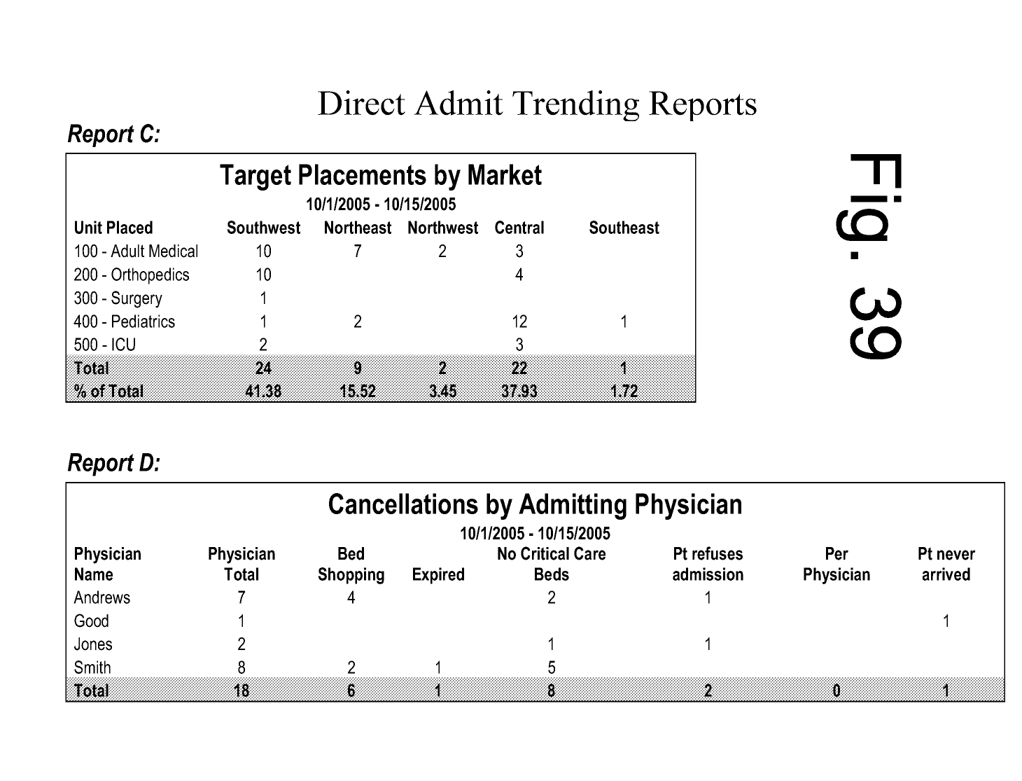

Referring to FIG. 39, Report C is an example of the Target Placements by Market report as generated by clicking the Target Placements by Market link 214 on FIG. 30. This report stratifies the number of direct admits to a unit by the market the patient lives in for the selected time period.

Referring to FIG. 39, Report D is an example of the Cancellations by Admitting Physician report as generated by clicking the Cancellations by Admitting Physician link 215 on FIG. 30. This report stratifies the number of potential direct admits that had to be cancelled by physician and cancellation reason.

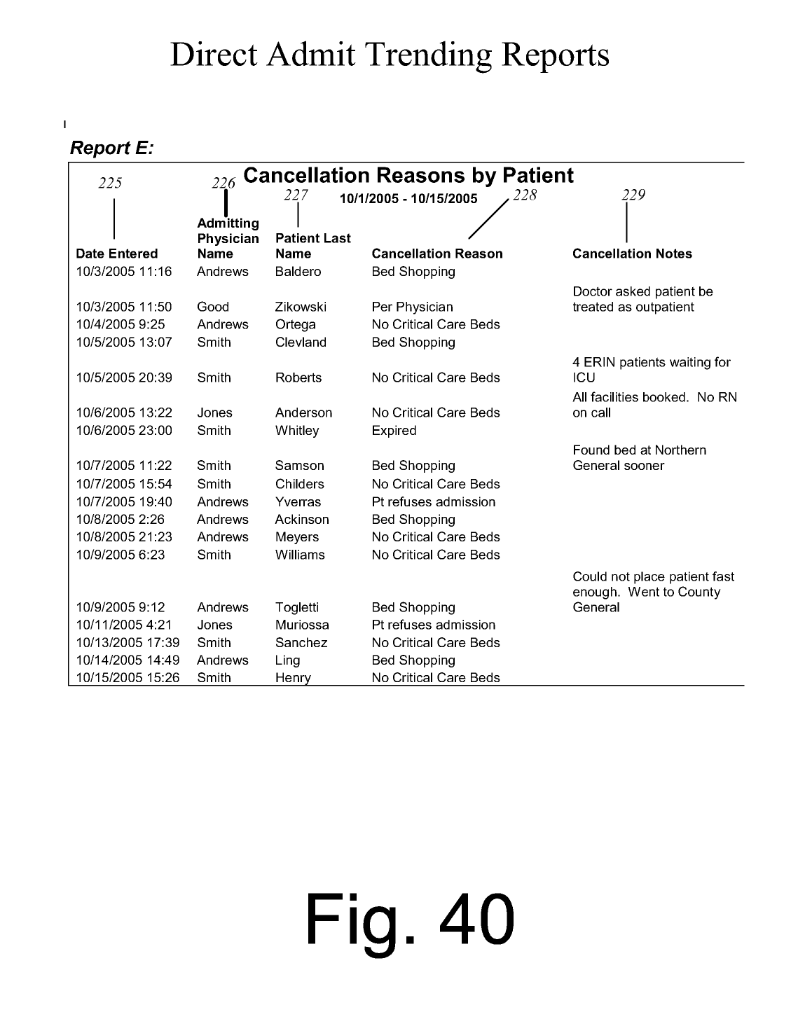

Referring to FIG. 40, Report E is an example of the Cancellation Reasons by Patient report as generated by clicking the Cancellation Reason by Patient link 216 on FIG. 30. This report lists the following detail for each cancelled direct admit within the requested date range: Date Entered 225, Admitting Physician Name 226, Patient Last Name 227, Cancellation Reason 228 and Cancellation Notes 229.

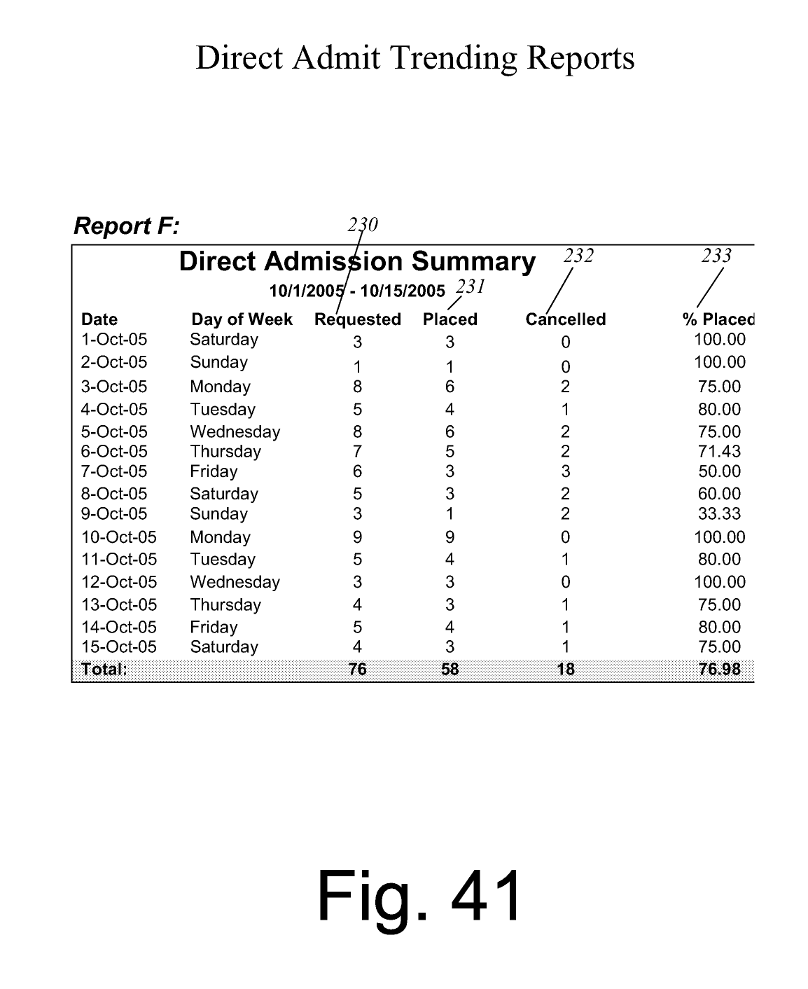

Referring to FIG. 41, Report F is an example of the Direct Admissions Summary report as generated by clicking the Direct Admissions Summary link 217 on FIG. 30. This report stratifies the number of direct admits requesting rooms 230, the number of direct admits placed 231, the number of direct admits cancelled (not placed) 232 and the percentage placed 233 by date and day of week.

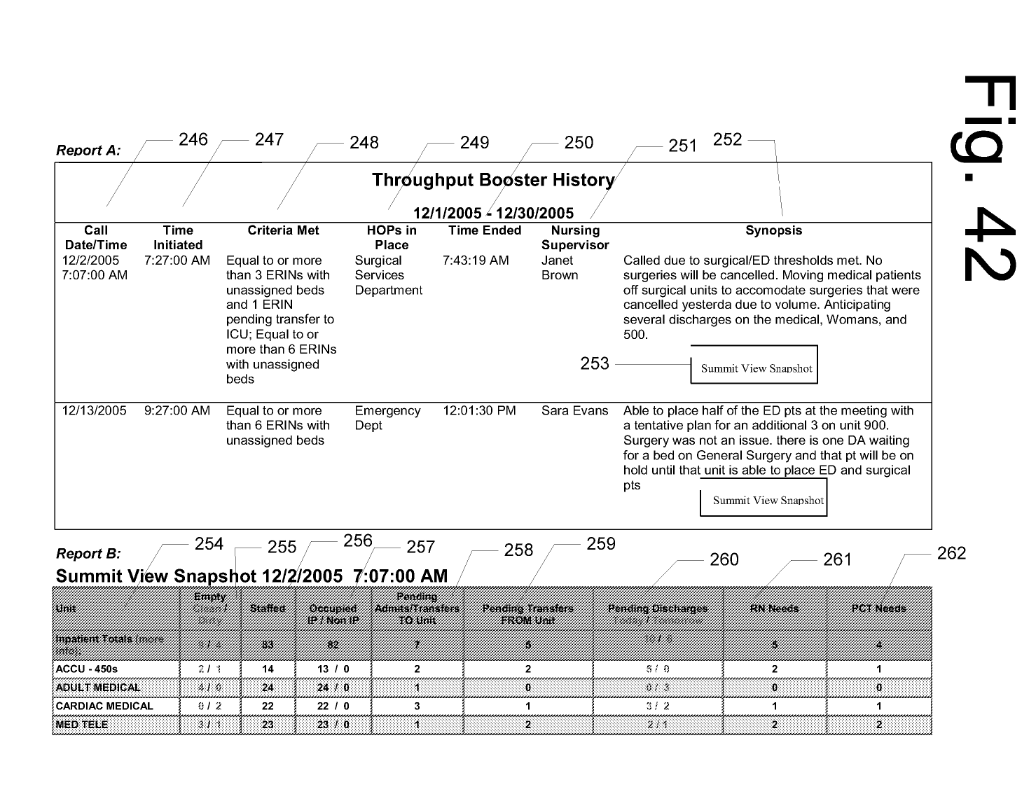

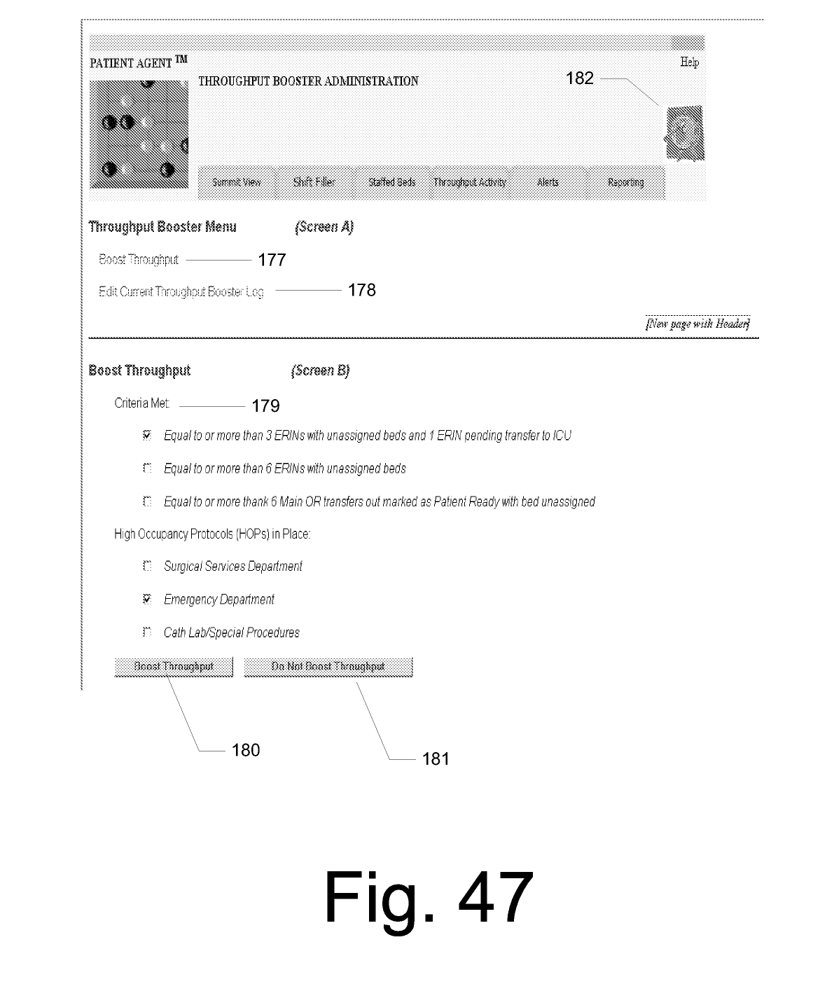

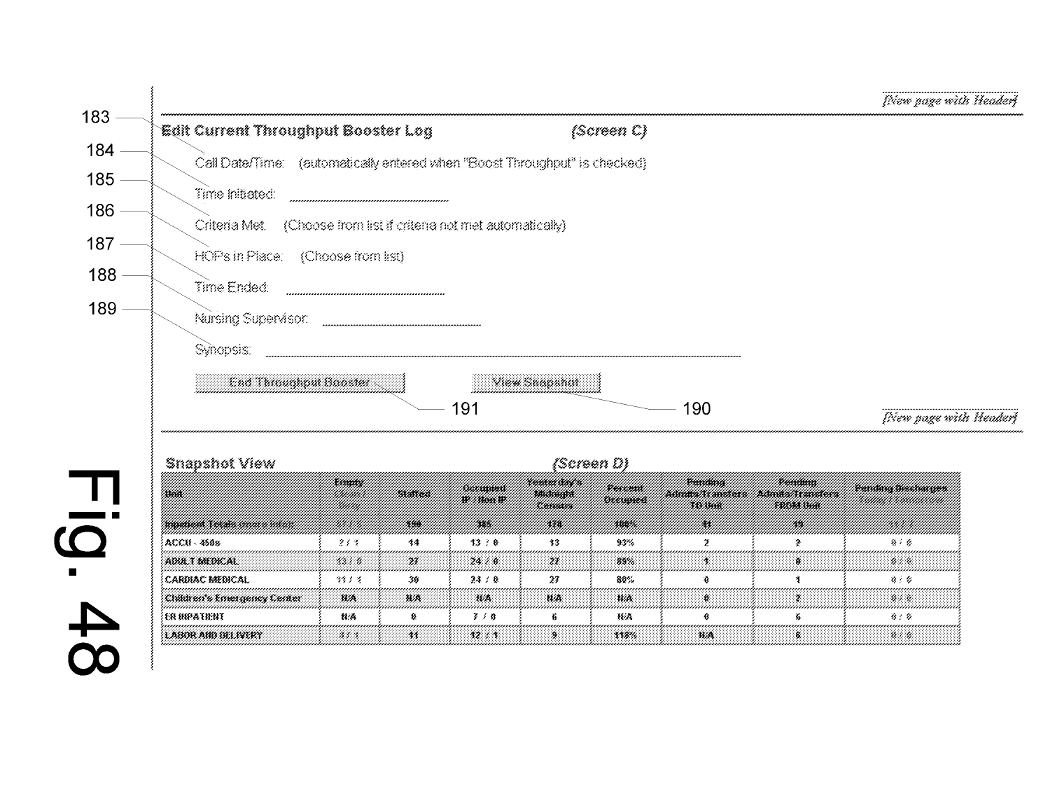

FIG. 42 is an example of the Throughput Booster History report generated by clicking on the Throughput History link 234 from the reporting menu FIG. 30. FIG. 42 shows Reports A and B for a Throughput Booster History, on which Report B is a snapshot of selected elements that are displayed in the Summit View of Patient Throughput display screen in FIG. 12. Throughput Booster reports are generated from data generated and stored during the use of the Throughput Booster Module. This module is explained later in reference to FIGS. 47-48.

Referring to FIG. 42, Report A is an example of the detail displayed to the user for current and historical Throughput Booster events. A Throughput Booster event is an episode of intense cross-facility attention and teamwork to maximize patient movement through the facility. For each event, the following fields are stored and displayed: Throughput Call Date/time 246, Time Initiated 247, Criteria Met 248, High Occupancy Protocols (HOPs) in place 249, Time Ended 250, Nursing Supervisor 251 and Synopsis 252. For each event, the user may view the state of the facility at the time that the Throughput Booster event was called by clicking the Summit View Snapshot link 253.

Referring to FIG. 42, Report B is an example of the detail displayed when user clicks the Summit View Snapshot link 253 of FIG. 42 Report A. The Summit View Snapshot is a snapshot of the following data at the time a Throughput Booster event was called: Unit 254, Empty Beds 255, Staffed Beds 256, Occupied Inpatient and Non Inpatient beds 257, Pending Transfers to the unit 258, Pending Transfers from the unit 259, Pending Discharges for today and tomorrow 260, the Unit's RN needs 261 and the unit's PCT needs 262. Visibility to this snapshot allows management to ascertain the situation during a Throughput Booster event and review or analyze the situation following the conclusion of a Throughput Booster event.

Navigation and use of the Patient Agent Administration is shown in FIGS. 43-46. Following authenticated sign-on to the Patient Agent Throughput Management System 1, the user would click on the Administration link 27 found at the top of the Summit View tab 25 to access the administration tools. These administration tools allow a properly authenticated user to configure units and beds for use in the system 1. This administration allows each facility to customize the Patient Agent Throughput System 1 to their facility's needs. Screen A of FIG. 43 is the Patient Agent Administration menu of actions. Screen B seen in FIG. 43 is an example of the main unit configuration page. Each of the facility's units is displayed along with their configuration data. The Name column 153 is the name of the unit. The Number column 154 is the unit ID of the nursing station. This ID is the same ID as found in the facility's ADT system 13. The Master Unit column 155 is used to combine two distinct units. The Active for Staffed Beds column 156 signifies whether or not that unit uses the Staffed Beds module 7. The Source Census Available column 157 is used to signify whether or not that unit's current census information should be displayed on the Summit View 6. The Active for Booster column 158 is used to determine whether or not the unit participates in Throughput Booster Module 12. The ICU Unit column 159 is used to signify if the unit is designated as an ICU unit for use in the Throughput Booster Module 12. The Summit View Display column 160 is used to signify whether or not the unit should be displayed on the Summit View 6.

All information displayed on screen B of FIG. 43 can be edited with the exception of the Number 154 data. To edit the data, the user clicks on the Edit button 161 for the desired unit. The user then edits the data for the unit as desired. After making changes to the values, the user clicks the Update button displayed for that unit's row and the system 1 writes the data to the Patient Agent Throughput Store 5 (not shown).

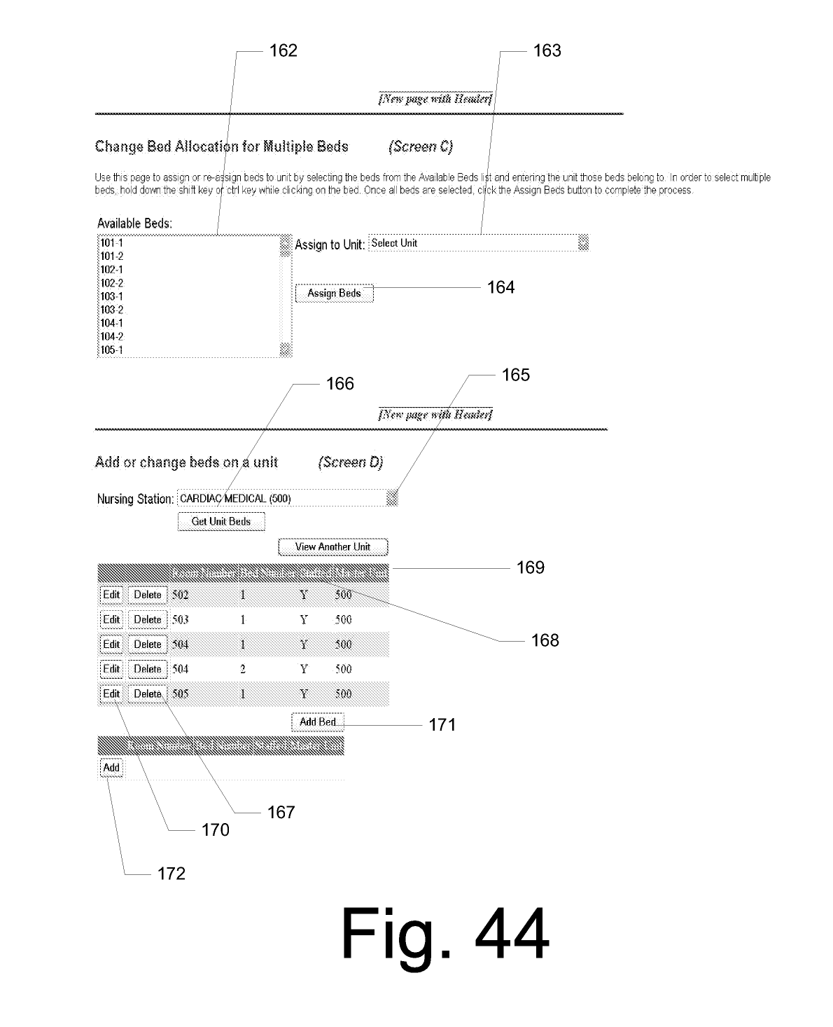

Screen C of FIG. 44 is an example of the Bed Allocation screen. This screen is used to change the unit that a bed is part of. First, the user selects the desired beds in the Available Beds 162 column. The user then selects the unit those beds should be part of in the Assign to Unit drop down box 163. When finished the user clicks the Assign Beds button 164.

Screen D of FIG. 44 is an example of the “Add or Change Beds on a Unit” screen. Once the user selects the desired unit from the Nursing Station drop down box 165 and clicks Get Unit Beds 166. A list of all beds associated to that unit is displayed. To delete a bed, the user clicks on the Delete button 167 next to the desired entry. When clicked the system 1 removes all information for that bed from the Patient Agent Throughput Store 5 and the bed will no longer be included for use in the Throughput Activity Module 8 or the Summit View 6. The user is also able to change the Staffed column 168 and the Master Unit column 169. The Staffed Column 168 signifies whether or not a bed is staffed. The Master Unit column 169 signifies if the bed belongs to a combined unit. To make these edits, the user clicks on the Edit button 170 next to the desired bed. After making the changes, the user clicks on the Update button (not shown). To add a bed to this unit, the user clicks on the Add Bed button 171 at the bottom of the screen. The user is then able to enter the Room Number, Bed Number, Staffed and Master Unit values for the new bed. When finished the user clicks the Add button 172 to save the new bed information to the Patient Agent Throughput Store 5.

Screen E of FIG. 44 is an example of the Add or Change Ratio Discrepancy Messages screen. From here, the user is able to edit, disable or add discrepancy messages for use in the Staffed Beds Module 11. To edit or deactivate a message, the user clicks on the Edit button 173 of the desired message. Once clicked, the message and the Active value become editable (not shown). The user can then edit the message as desired. If the message is to be deactivated the user can change the active value from Y to N 174. When finished making edits, the user clicks on the Update button (not shown) appearing next to that row. At this point a user request is transmitted to the web server 21 and the system 1 writes the information to the Patient Agent Throughput Store 5. If the user wishes to cancel the update without saving any information, the user can click on the Cancel button for that row (not shown). If Cancel is selected, no changes are made to the data.

If the user wishes to add a new Discrepancy Message to the list of available messages, the user clicks on the Add button 175. Once clicked the user enters the message and clicks the Save button (not shown). The new message is then added to the database and then displayed in the list of available messages.

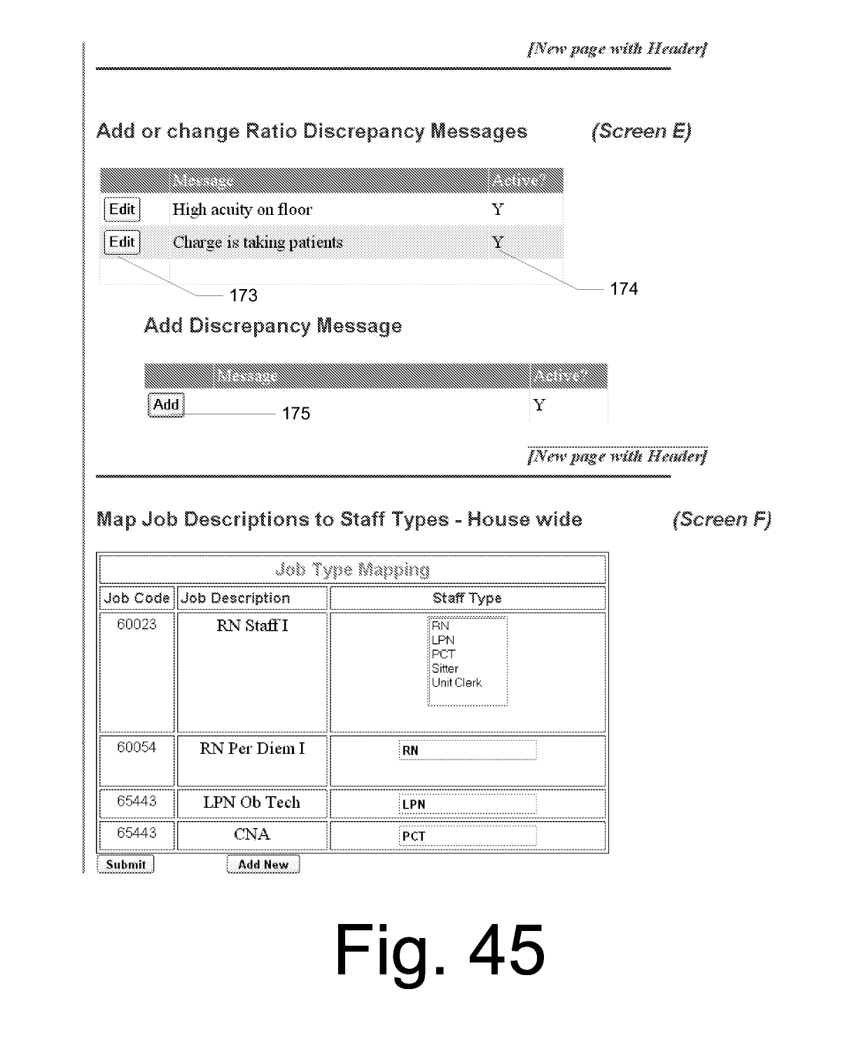

Referring to FIG. 45 screen F a user, having proper authorization, is able to define the relationship between the facility's pre-defined job descriptions, as found in their human resources system 17, and the staff types as defined in the Patient Agent Throughput Management System 1. This allows the facility to customize how the system's 1 staff types are defined. For example, the facility may have many different classifications of RN. These classifications may be important to the facility's human resources system 17 in order to determine pay, benefits and other HR related compensation. To the Patient Agent Throughput Management System 1, however, these classifications are not important and can be combined into the general category RN. To complete these mappings, the user should select the appropriate staff type in the Staff Type 60 drop down list for the Job Description. When finished selecting the staff types, the user clicks the Submit button 61. A user request is then transmitted to the web server 21 and the system 1 writes the information to the Patient Agent Throughput Store 5. These mapping definitions apply to all units in the facility. Adding new staff types can be done by clicking the Add New button 62.

Screen G of FIG. 46 is an example of the Assign Like Beds screen. From here, the user is able to group units together by bed type. To group beds together, the user selects all Candidate Units 192 for the desired Bed Type 193. The user clicks the Add New 194 button to add a new Bed Type and selects all Candidate Units 192 for that Bed Type 193.

Screen H of FIG. 46 is an example of the Add or Change High Occupancy Protocols (HOPs) screen. From here, the user is able to edit, disable or add HOPs for use in the Throughput Booster module 12. To edit or deactivate a HOP, the user clicks on the Edit button 265 of the desired HOP. Once clicked, the HOP and the Active value become editable (not shown). The user can then edit the HOP. If the HOP is to be deactivated the user can change the active value from Y to N 266. When finished making edits, the user clicks on the Update button (not shown) appearing next to that row. At this point a user request is transmitted to the web server 21 and the system 1 writes the information to the Patient Agent Throughput Store 5. If the user wishes to cancel the update without saving any information, the user can click on the Cancel button for that row (not shown). If Cancel is selected, no changes are made to the data.

If the user wishes to add a new HOP to the list of available messages, the user clicks on the Add button 267. Once clicked the user enters the message and clicks the Save button (not shown). The new HOP is then added to the database and then displayed in the list of available HOPs.

The Throughput Booster Module 12 is used to identify opportunities to increase patient throughput in the facility. The system 1 monitors the facility's current conditions for potential throughput problems. When the system 1 identifies a potential problem with patient throughput, the system 1 generates an alert to all system users defined as recipients of Throughput Booster Evaluation alerts in the Alerts Module 10. It is then the responsibility of the users of the system 1 to evaluate the current scenario and determine whether or not to activate Throughput Booster.

Navigation and use of the Throughput Booster Module 12 is illustrated in FIGS. 47-48. Following authenticated sign-on to the Patient Agent Throughput Management System 1, the user would click on the Summit View tab 176. The user then clicks on the Boost Throughput link 95 found at the top of the Summit View screen.

Screen A of FIG. 47 represents the Throughput Booster Menu displayed to the user. From here, the user is able to Boost Throughput 177 and Edit Current Throughput Booster Log 178.

Clicking on the Boost Throughput 177 link found on Screen A of FIG. 47 presents the user with a screen summarizing the current throughput status as exemplified in screen B of FIG. 47. If the system 1 has found any potential throughput problems they will be listed as Criteria Met 179. After evaluating the information as displayed on screen B of FIG. 47, the user is able to decide whether or not to boost throughput by clicking the Boost Throughput 180 button or the Do Not Boost Throughput 181 button.

By clicking the Do Not Boost Throughput button 181 on screen B of FIG. 47, the system returns to normal and no special function is performed. By clicking the Boost Throughput 180 button found on screen B of FIG. 47, the system 1 enters Boost Throughput mode. During this mode, the system displays the Boost Throughput icon 182 at the top of all Patient Agent screens. This icon alerts all Patient Agent users to the fact that the facility is currently in a Boost Throughput situation. The system 1 also records a snapshot of the current facility throughput data.

Screen D of FIG. 48 is an example of this snapshot of data. This is a subset of the Summit View 6 data. Screen D of FIG. 48 includes all unit data designated as Active for Booster in the Patient Agent Administration section detailed in FIGS. 43-46. The data found in screen D of FIG. 48 is stored by the system 1 in Patient Agent Throughput Store 5. Finally the system generates an alert to all system 1 users defined as recipients of the Throughput Booster alert.

Once the facility has entered Boost Throughput mode, a properly authenticated user is able to click the Edit Current Throughput Booster Log 178 link found on screen A of FIG. 47. Once clicked screen C of FIG. 48 is displayed. This screen acts as the main information gathering screen of the Boost Throughput event. Call Date/Time 183 is the system generated date and time that the Boost Throughput 180 button was clicked. Time Initiated 184 is a user editable time marking the official beginning of the Boost Throughput event by the facility's staff. The Criteria Met 185 is a list of all possible potential throughput problems. If the system identified any of these criteria during its routine scan, the criteria will already be checked as having been met. The user is able to check or uncheck any criteria as necessary. HOPs in Place 186 is a list of High Occupancy Protocols that have been enacted as a result of the Boost Throughput event. The user is able to select any HOPs that have been initiated by the facility staff. The Time Ended 187 field is a user editable field containing the time the Boost Throughput event ended. The Nursing Supervisor 188 field contains the name of the nursing supervisor as entered by the user. The synopsis field 189 is a place for the user to enter a descriptive summary of what lead to the need for a Boost Throughput event, what was done during the Boost Throughput event, and how throughput was increased during the Boost Throughput event. By clicking on the View Snapshot 190 button at the bottom of screen C as seen in FIG. 48, the user is able to see the snapshot of data (detailed at screen D of FIG. 48) as recorded by the system 1 when the Boost Throughput 180 button was clicked.

When the Boost Throughput event has ended, the user clicks on End Throughput Booster 191 found in Screen C of FIG. 48. When clicked, the system 1 generates an alert to all system 1 users defined as being recipients of the Throughput Booster End alert. The system 1 also removes the Boost Throughput icon 182 from the top of all Patient Agent screens. The system 1 resumes scanning the system for potential throughput problems.

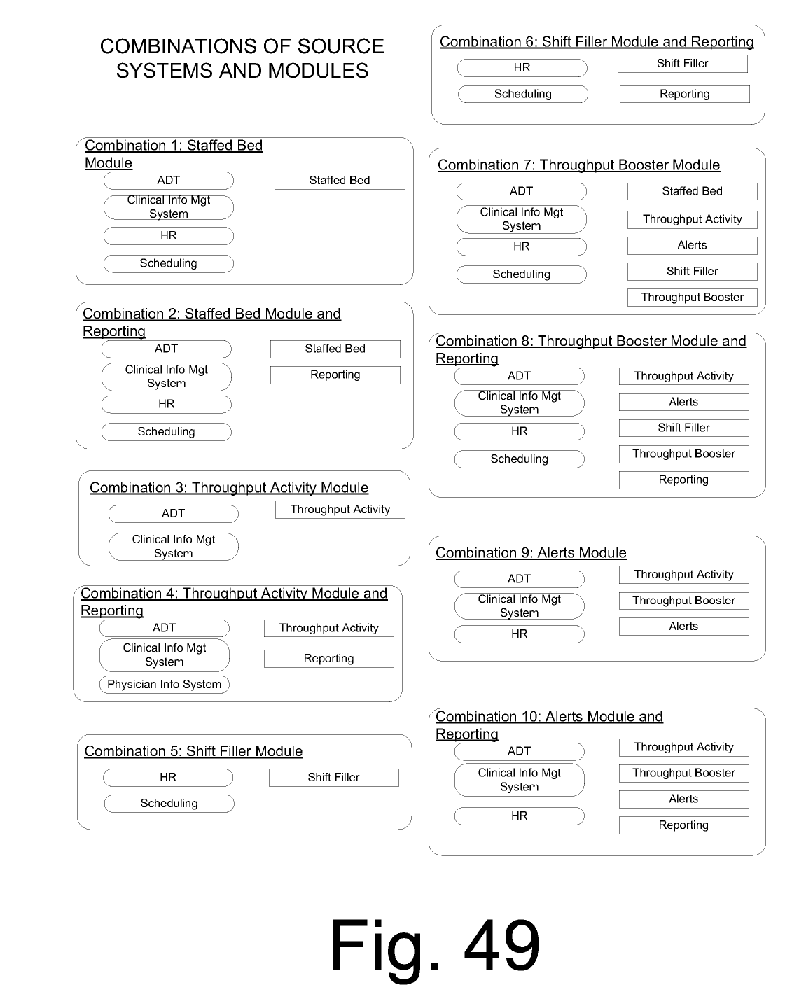

FIG. 49 shows various combinations of source systems and modules, each being described above, which can be integrated together into respective implementations.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

### APPENDIX A

HL7 Events Processed:

A01—Admit a patient

A02—Transfer a patient

A03—Discharge a patient

A04—Register an outpatient

A05—Preadmit a patient

A06—Transfer an outpatient to an inpatient

A07—Transfer an inpatient to an outpatient

A08—Update patient information

A11—Cancel admit

A13—Cancel discharge

A17—Swap patients (create two A02 events)

A18—Merge patient information

A31—Update person information

A36—Merge patient information, patient ID and account number

Appendix B: Patient Agent Data Interface Classes HL7 Messages Handled Public Class HL7 Private Const sConnectionString Private sHL7Record As String Private objMSH As MSH Private objEVN As EVN Private objPID As PID Private objPVI As PV1 Private objPV2 As PV2 Private objZPI As ZP1 Private objZVI As ZV1 Private objAL 1 As AL1 Private objINl As INI Private objIN2 As IN2 Private objMRG As MRG Private objNKI As NK1 Private objNPU As NPU Private objDGI As DG1 Private bMSHExists As Boolean Private bEVNExists As Boolean Private bPIDExists As Boolean Private bPVlExists As Boolean Private bPV2Exists As Boolean Private bZPlExists As Boolean Private bZVlExists As Boolean Private bALlExists As Boolean Private bINlExists As Boolean Private bIN2Exists As Boolean Private bMRGExists As Boolean Private bNKlExists As Boolean Private bNPUExists As Boolean Private bDGlExists As Boolean Public Sub Newo Public Sub New(ByVal sHL7Message As String) Public Sub WriteRecordObject(ByVal sFileStream As System.IO. StreamWriter) Public Sub WriteRecordString(ByVal sFileStream As System.IO. StreamWriter) 46 Lewis & Roca LLP Docket No. 44095.21U2 Public Sub ProcessRecordo Public Function MakeAcko As String Public ReadOnly Property HL7RecordStringo As String Public Property MSHO As MSH Public Property EVNO As EVN Public Property PIDO As PID Public Property PV1IO As PV1 Public Property PV20 As PV2 Public Property ZP1Io As ZP1 Public Property ZV1IO As ZV1 Public Property ALI o As ALI Public Property INIO As INI Public Property IN20 As IN2 Public Property MRGO As MRG Public Property NKIO As NKI Public Property NPUO As NPU Public Property DG Io As DGI Public ReadOnly Property MSHExistso As Boolean Public ReadOnly Property EVNExists( ) As Boolean Public ReadOnly Property PIDExistso As Boolean Public ReadOnly Property PVlExistso As Boolean Public ReadOnly Property PV2Existso As Boolean Public ReadOnly Property ZPlExistso As Boolean Public ReadOnly Property ZVlExistso As Boolean Public ReadOnly Property ALlExistso As Boolean Public ReadOnly Property INlExistso As Boolean Public ReadOnly Property IN2Existso As Boolean Public ReadOnly Property MRGExistso As Boolean Public ReadOnly Property NKlExistso As Boolean Public ReadOnly Property NPUExistso As Boolean Public ReadOnly Property DGlExistso As Boolean End Class Public Class MSH Private field seperator As String Private encoding_characters As String Private sending_application As String Private sending_facility As String Private receiving_application As String Private receiving_facility As String Private message_timestamp As String Private security As String 47 Lewis & Roca LLP Docket No. 44095.21U2 Private message_jype As String Private message_control_id As String Private processing_id As String Private version-id As String Private sequence-number As String Private continuation pointer As String Private accept acknowledgement_type As String Private application-acknowledgment_type As String Private country_code As String Private character set As String Private principal-language_of message As String Public Sub Newo Public Sub New(ByVal sMSHRecord As String) Public Function sMSHO As String Public Sub WriteRecord(ByVal sFileStream As System.IO.StreamWriter) Public Property SendingApplicationo As String Public Property MessageTypeo As String Public ReadOnly Property MessageTimestampo As String Public Property EncodingCharacterso As String Public Property SendingFacilityo As String Public Property ReceivingApplicationo As String Public Property ProcessingIDO As String Public Property VersionIDO As String Public Property MessageControlIDO As String End Class Public Class EVN Private event_type_code As String Private recorded datetime As String Private planned event-datetime As String Private event reason code As String Private operator id As XCN Private event occurred-datetime As String Public Sub Newo Public Sub New(ByVal sEVNRecord As String) Public Sub WriteRecord(ByVal swFile As System.IO.StreamWriter) Public Property EventTypeCodeo As String Public Property RecordedDateTimeo As String Public Property PlannedEventDateTimeo As String Public Property EventReasonCodeo As String Public Property OperatorlDO As XCN Public Property EventOccuredDateTimeo As String 48 Lewis & Roca LLP Docket No. 44095.21U2 End Class Public Class PID Private set-id patient id As String Private patient id-external_id As String Private patient id-internal_id As String Private alternate patient id As String Private patient name As XPN Private mothers maiden name As XPN Private date-time_of birth As String Private ssex As String Private patient alias As XPN Private srace As String Private patient-address As XAD Private country_code As String Private phone number home As String Private phone number business As String Private primary-language As String Private marital_status As String Private sreligion As String Private patient account-number As String Private ssn-number patient As String Private drivers_license-number patient As String Private mothers_identifier As String Private ethnic-group As String Private birth place As String Private multiple birth indicator As String Private birth order As String Private scitizenship As String Private veterans military_status As String Private snationality As String Private patient death-date_and-time As String Private patient death-indicator As String Public Sub Newo Public Sub New(ByVal sPIDRecord As String) Public Sub WriteRecord(ByVal swOutfile As System.IO.StreamWriter) Public Property MRNO As String Public Property PatientNameo As XPN Public Property FirstNameo As String Public Property LastNameo As String Public Property MiddleNameo As String Public ReadOnly Property MothersMaidenNameo As String 49 Lewis & Roca LLP Docket No. 44095.21U2 Public Property BirthDateTime( ) As String Public Property Sexo As String Public Property PatientAliasFirstName( ) As String Public Property PatientAliasLastNameo As String Public Property PatientAliasMiddleName( ) As String Public Property Raceo As String Public Property PatientAddresso As XAD Public Property PatientAddressStreetlo As String Public Property PatientAddressStreet2o As String Public Property PatientAddressCity( ) As String Public Property PatientAddressStateo As String Public Property PatientAddressZip( ) As String Public Property PatientAddressCountry( ) As String Public Property PatientAddressCountryCode( ) As String Public Property CountryCode( ) As String Public Property HomePhoneo As String Public ReadOnly Property HomePhoneAreaCodeo As String Public Property BusinessPhoneo As String Public Property PrimaryLanguage( ) As String Public Property MaritalStatuso As String Public Property Religion( ) As String Public Property PatientAccountNumbero As String Public Property PatientSSNO As String Public Property PatientDriversLicenseNumber( ) As String Public Property MothersMRN( ) As String Public Property EthnicGroup( ) As String Public Property BirthPlaceo As String Public Property MultipleBirthlndicator( ) As String Public Property BirthOrdero As String Public Property Citizenship( ) As String Public Property VeteransMilitaryStatus( ) As String Public Property Nationality( ) As String Public Property PatientDeathDateTimeo As String Public Property PatientDeathlndicatoro As String Public ReadOnly Property HasMinimumDatao As Boolean End Class Public Class PV1 Private set-id pvl As String Private patient-class As String Private assigned patient location As PL Private admissiontype As String 50 Lewis & Roca LLP Docket No. 44095.21U2 Private preadmit number As String Private prior patient location As PL Private attending_doctor As XCN Private referring_doctor As XCN Private consulting_doctor As XCN Private hospital_service As String Private temporary_location As PL Private preadmit_test-indicator As String Private readmission indicator As String Private admit source As String Private ambulatory_status As String Private vip-indicator As String Private admitting_doctor As XCN Private patient_type As String Private visit-number As String Private financial_class As String Private charge price_indicator As String Private courtesy_code As String Private credit rating As String Private contract code As String Private contract effective_date As String Private contract amount As String Private contract period As String Private interest code As String Private transfer to-bad-debt-code As String Private transfer to-bad-debt-date As String Private bad-debt agency_code As String Private bad-debt-transfer-amount As String Private bad-debt-recovery_amount As String Private delete_account-indicator As String Private delete_account-date As String Private discharge_disposition As String Private discharged to_location As String Private diet_type As String Private servicing_facility As String Private bed-status As String Private account status As String Private pending_location As PL Private prior temporary_location As PL Private admit date-time As String Private discharge_date-time As String 51 Lewis & Roca LLP Docket No. 44095.21U2 Private current patient balance As String Private total_charges As String Private total_adjustments As String Private total payments As String Private alternate visit id As String Private visit-indicator As String Private other-healthcare-provider As XCN Public Sub Newo Public Sub New(ByVal sPVlRecord As String) Public Sub WriteRecord(ByVal swOut As System.IO.StreamWriter) Public Property SetIDPV1IO As String Public Property PatientClasso As String Public Property AssignedPatientLocation( ) As PL Public Property AdmissionTypeo As String Public Property PreadmitNumbero As String Public Property PriorPatientLocationo As PL Public Property AttendingDoctoro As XCN Public Property ReferringDoctoro As XCN Public Property ConsultingDoctoro As XCN Public Property HospitalService( ) As String Public Property TemporaryLocationo As PL Public Property PreadmitTestlndicator( ) As String Public Property Readmissionlndicatoro As String Public Property AdmitSourceo As String Public Property AmbulatoryStatuso As String Public Property VIPIndicatoro As String Public Property AdmittingDoctoro As XCN Public Property PatientTypeo As String Public Property VisitNumbero As String Public Property FinancialClasso As String Public Property ChargePricelndicatoro As String Public Property CourtesyCodeo As String Public Property CreditRatingo As String Public Property ContractCodeo As String Public Property ContractEffectiveDateo As String Public Property ContractAmounto As String Public Property ContractPeriodo As String Public Property InterestCodeo As String Public Property TransferToBadDebtCodeo As String Public Property TransferToBadDebtDateo As String Public Property BadDebtAgencyCodeo As String 52 Lewis & Roca LLP Docket No. 44095.21U2 Public Property BadDebtTransferAmount( ) As String Public Property BadDebtRecoveryAmount( ) As String Public Property DeleteAccountlndicator( ) As String Public Property DeleteAccountDateo As String Public Property DischargeDispositiono As String Public Property DischargedToLocationo As String Public Property DietTypeo As String Public Property ServicingFacility( ) As String Public Property BedStatuso As String Public Property AccountStatuso As String Public Property PendingLocationo As PL Public Property PriorTemporaryLocation( ) As PL Public Property AdmitDateTimeo As String Public Property DischargeDateTimeo As String Public Property CurrentPatientBalance( ) As String Public Property TotalChargeso As String Public Property TotalAdjustmentso As String Public Property TotalPaymentso As String Public Property AlternateVisitIDo As String Public Property Visitlndicatoro As String Public Property OtherHealthcareProvider( ) As XCN End Class Public Class PV2 Private prior pending_location As PL Private accommodation code As String Private admit reason As String Private transfer reason As String Private patient valuables As String Private patient valuables_location As String Private visit-user-code As String Private expected admit date As String Private expected discharge date As String Private estimated length of inpatient stay As String Private actual_length of inpatient stay As String Private visit-description As String Private referral_source_code As String Private previous_service_date As String Private employment-illness-related-indicator As String Private purge_status_code As String Private purge_status_date As String Private special program-code As String 53 Lewis & Roca LLP Docket No. 44095.21U2 Private retention indicator As String Private expected-number-of insurance plans As String Private visit privateity_code As String Private visit-protection-indicator As String Private clinic_organization name As String Private patient status_code As String Private visit priority_code As String Private previous treatment-date As String Private expected discharge_disposition As String Private signature_of file_date As String Private first_similar-illness-date As String Private patient charge_adjustment code As String Private recurring_service_code As String Private billing media code As String Private expected surgery_date_and time As String Private military partnership_code As String Private military non availability_code As String Private newbom baby_indicator As String Private baby_detained indicator As String Public Sub Newo Public Sub New(ByVal sPV2Record As String) Public Sub WriteRecord(ByVal swOut As System.IO.StreamWriter) Public Property PriorPendingLocationo As PL Public Property AccommodationCodeo As String Public Property AdmitReasono As String Public Property TransferReasono As String Public Property PatientValuableso As String Public Property PatientValuablesLocation( ) As String Public Property VisitUserCodeo As String Public Property ExpectedAdmitDateo As String Public Property ExpectedDischargeDateo As String Public Property EstimatedLengthoflnpatientStay( ) As String Public Property ActualLengthOflnpatientStay( ) As String Public Property VisitDescriptiono As String Public Property ReferralSourceCode( ) As String Public Property PreviousServiceDate( ) As String Public Property EmploymentlllnessRelatedlndicator( ) As String Public Property PurgeStatusCodeo As String Public Property PurgeStatusDateo As String Public Property SpecialProgramCodeo As String Public Property Retentionlndicatoro As String 54 Lewis & Roca LLP Docket No. 44095.21U2 Public Property ExpectedNumberOflnsurancePlans( ) As String Public Property VisitPrivateityCodeo As String Public Property VisitProtectionlndicator( ) As String Public Property ClinicOrganizationName( ) As String Public Property PatientStatusCodeo As String Public Property VisitPriorityCode( ) As String Public Property PreviousTreatmentDate( ) As String Public Property ExpectedDischargeDisposition( ) As String Public Property SignatureOfEileDate( ) As String Public Property FirstSimilarlllnessDate( ) As String Public Property PatientChargeAdjustmentCode( ) As String Public Property RecurringServiceCode( ) As String Public Property BillingMediaCodeo As String Public Property ExpectedSurgeryDateAndTime( ) As String Public Property MilitaryPartnershipCode( ) As String Public Property MilitaryNonAvailabilityCode( ) As String Public Property NewbomBabylndicatoro As String Public Property BabyDetainedlndicatoro As String End Class Public Class ZP1 Private set-ID As String Private primary_care_physician As XCN Private advanced directives As String Private advanced directives_date_signed As String Private advanced directives_on-file-indicator As String Private organ-donor As String Private living-will As String Private date_of_death As String Private pcp-az_license-number As String Public Sub Newo Public Sub New(ByVal sZPlRecord As String) Public Sub writerecord(ByVal swOut As System.IO.StreamWriter) Public Property PrimaryCarePhysiciano As XCN Public Property AdvancedDirectiveso As String Public Property AdvancedDirectivesDateSigned( ) As String Public Property AdvancedDirectivesOnFilelndicator( ) As String Public Property OrganDonoro As String Public Property LivingWillo As String Public Property DateOfDeath( ) As String Public Property PCPAzLicenseNumbero As String End Class 55 Lewis & Roca LLP Docket No. 44095.21U2 Public Class ZV1 Private set-id As String Private transfer date-time As String Private attending phys_az_license-number As String Private baby_id As String Private sconfidentiality As String Private registration confirmation As String Private discharge physician As String Private admit thru_er As String Public Sub Newo Public Sub New(ByVal sZVlRecord As String) End Sub Public Sub WriteRecord(ByVal swOut As System.IO.StreamWriter) Public Property AttendingPhysAzLicenseNumber( ) As String Public Property BabyIDO As String Public Property Confidentialityo As String Public Property RegistrationConfirmation( ) As String Public Property DischargePhysiciano As String Public Property AdmitThruER( ) As String End Class Public Class INI Private set-idminl As String Private insurance plan id As String Private insurance-comp_id As String Private insurance_comp name As XON Private insurance_comp_address As XAD Private insurance_comp_contact4person As XCN Private insurance_comp4phone number As String Private group number As String Private group name As XON Private insureds_group_emp_id As String Private insureds_group_emp name As XON Private plan-effective_date As String Private plan expiration date As String Private authorization information As String Private plan_type As String Private name_of insured As XCN Private insureds relationship to patient As String Private insureds_date_of birth As String 56 Lewis & Roca LLP Docket No. 44095.21U2 Private insureds_address As XAD Private assignment of benefits As String Private coordination of benefits As String Private coordination of benefits priority As String Private notice_of admission code As String Private notice_of admission-date As String Private rpt of eligibility_code As String Private rpt of eligibility_date As String Private release_information-code As String Private pre-admit-cert As String Private verification date-time As String Private verification by As XCN Private type_of agreement code As String Private billing_status As String Private lifetime reserve-days As String Private delayjbefore_LR day As String Private company4plan code As String Private policy number As String Private policy_deductable As String Private policy_limit amount As String Private policy_limit days As String Private room rate_semi private As String Private room rate4private As String Private insureds_employement status As String Private insureds_sex As String Private insureds employer address As XAD Private verification-status As String Private prior insurance planjid As String Public Sub Newo Public Sub New(ByVal sINIRecord As String) Public Sub WriteRecord(ByVal swOut As System.IO.StreamWriter) Public Property SetIDIN IO As String Public Property InsurancePlanIDO As String Public Property InsuranceCompIDO As String Public Property InsuranceCompNameo As XON Public Property InsuranceCompAddresso As XAD Public Property InsuranceCompContactPerson( ) As XCN Public Property InsuranceCompPhoneNumber( ) As String Public Property GroupNumbero As String Public Property GroupNameo As XON Public Property InsuredsGroupEmpIDO As String 57 Lewis & Roca LLP Docket No. 44095.21U2 Public Property InsuredsGroupEmpName( ) As XON Public Property PlanEffectiveDateo As String Public Property PlanExpirationDateo As String Public Property Authorizationlnformation( ) As String Public Property PlanTypeo As String Public Property NameOflnsured( ) As XCN Public Property InsuredsRelationshipToPatient( ) As String Public Property InsuredsDateOfBirth( ) As String Public Property InsuredsAddresso As XAD Public Property AssignmentOfBenefits( ) As String Public Property CoordinationOfBenefits( ) As String Public Property CoordinationOfBenefitsPriority( ) As String Public Property NoticeOfAdmissionCode( ) As String Public Property NoticeOfAdmissionDate( ) As String Public Property RptOfEligibilityCode( ) As String Public Property RptOfEligibilityDate( ) As String Public Property ReleaselnformationCode( ) As String Public Property PreAdmitCerto As String Public Property VerificationDateTime( ) As String Public Property VerificationByo As XCN Public Property TypeOfAgreementCodeo As String Public Property BillingStatuso As String Public Property LifetimeReserveDayso As String Public Property DelayBeforeLRDayo As String Public Property CompanyPlanCodeo As String Public Property PolicyNumbero As String Public Property PolicyDeductableo As String Public Property PolicyLimitAmounto As String Public Property PolicyLimitDayso As String Public Property RoomRateSemiPrivateo As String Public Property RoomRatePrivateo As String Public Property InsuredsEmployementStatus( ) As String Public Property InsuredsSexo As String Public Property InsuredsEmployerAddress( ) As XAD Public Property VerificationStatuso As String Public Property PriorlnsurancePlanIDO As String End Class Public Class IN2 Private insureds_employee_id As String Private insureds_social-security number As String Private insureds employer-name As XCN 58 Lewis & Roca LLP Docket No. 44095.21U2 Private employer information data As String Private mail_claim party As String Private medicare_health ins_card-number As String Private medicaid_case name As XPN Private medicaid case-number As String Private champus-sponsor-name As XPN Private champus_id number As String Private dependent of champus recipient As String Private champus_organization As String Private champus_station As String Private champus_service As String Private champus rank grade As String Private champus_status As String Private champus retire_date As String Private champus no_avail_cert on-file As String Private baby_coverage As String Private combine baby_bill As String Private blood deductible As String Private special_coverage_approval name As XPN Private special_coverage_approval title As String Private non-covered-insurance_code As String Private payor id As String Private payor subscriber id As String Private eligibility_source As String Private room coverage_jype_amount As String Private policy_jype_amount As String Private daily_deductible As String Public Sub Newo Public Sub New(ByVal sIN2Record As String) Public Sub WriteRecord(ByVal swOut As System.IO.StreamWriter) Public Property InsuredsEmployeelDO As String Public Property InsuredsSocialSecurityNumber( ) As String Public Property InsuredsEmployerName( As XCN Public Property EmployerlnformationData( ) As String Public Property MailClaimParty( ) As String Public Property MedicareHealthlnsCardNumber( ) As String Public Property MedicaidCaseNameo As XPN Public Property MedicaidCaseNumbero As String Public Property ChampusSponsorNameo As XPN Public Property ChampusIDNumbero As String Public Property DependentOfChampusRecipient( ) As String 59 Lewis & Roca LLP Docket No. 44095.21U2 Public Property ChampusOrganizationo As String Public Property ChampusStationo As String Public Property ChampusService( ) As String Public Property ChampusRankGrade( ) As String Public Property ChampusStatuso As String Public Property ChampusRetireDateo As String Public Property ChampusNoAvailCertOnFile( ) As String Public Property BabyCoverageo As String Public Property CombineBabyBillo As String Public Property BloodDeductibleo As String Public Property SpecialCoverageApprovalName( ) As XPN Public Property SpecialCoverageApprovalTitle( ) As String Public Property NonCoveredlnsuranceCode( ) As String Public Property PayorlDO As String Public Property PayorSubscriberlDO As String Public Property EligibilitySourceo As String Public Property RoomCoverageTypeAmount( ) As String Public Property PolicyTypeAmounto As String Public Property DailyDeductibleo As String End Class Public Class MRG Private prior patient id-internal As CX Private prior alternate patient id As CX Private prior patient account number As CX Private prior patient id-external As CX Private prior_visit-number As CX Private prior alternate visit-id As CX Private prior patient-name As XPN Public Sub Newo Public Sub New(ByVal sMRGRecord As String) Public Sub WriteRecord(ByVal swOut As System.IO.StreamWriter) Public Property PriorPatientIDInternal( ) As CX Public Property PriorAlternatePatientID( ) As CX Public Property PriorPatientAccountNumber( ) As CX Public Property PriorPatientIDExternal( ) As CX Public Property PriorVisitNumbero As CX Public Property PriorAlternateVisitIDO As CX Public Property PriorPatientNameo As XPN End Class Public Class NK1 Private set-id_nkl As String 60 Lewis & Roca LLP Docket No. 44095.21U2 Private sname As XPN Private srelationship As String Private saddress As XAD Private phone number As String Private business phone number As String Private contact role As String Private start-date As String Private end-date As String Private next-of kinjob-title As String Private next-of kinjob_code As String Private next-of_kin employee number As String Private organization name As String Private marital_status As String Private ssex As String Private date-time_of birth As String Private living_dependency As String Private ambulatory_status As String Private scitizenship As String Private primary_language As String Private living_arrangement As String Private privateity_indicator As String Private protection indicator As String Private student indicator As String Private sreligion As String Private mothers maiden-name As XPN Private snationality As String Private ethnic_group As String Private contact reason As String Private contact persons name As String Private contact persons telephone number As String Private contact persons_address As XAD Private next-of_kin-identifiers As String Private job-status As String Private srace As String Private shandicap As String Private contact person social_security number As String Public Sub Newo Public Sub New(ByVal sNKI Record As String) Public Sub WriteRecord(ByVal swOut As System.IO.StreamWriter) Public Property NextOfKinName( ) As XPN Public Property Relationshipo As String 61 Lewis & Roca LLP Docket No. 44095.21U2 Public Property NextOflinAddress( ) As XAD Public Property PhoneNumbero As String Public Property BusinessPhoneNumbero As String Public Property ContactRoleo As String Public Property StartDate( ) As String Public Property EndDateo As String Public Property NextOflinJobTitle( ) As String Public Property NextOflinJobCode( ) As String Public Property NextOfKinEmployeeNumber( ) As String Public Property OrganizationNameo As String Public Property MaritalStatuso As String Public Property Sexo As String Public Property DateTimeOfBirth( ) As String Public Property LivingDependencyo As String Public Property AmbulatoryStatuso As String Public Property Citizenshipo As String Public Property PrimaryLanguage( ) As String Public Property LivingArrangemento As String Public Property Privateitylndicatoro As String Public Property Protectionlndicatoro As String Public Property Studentlndicatoro As String Public Property Religiono As String Public Property MothersMaidenNameo As XPN Public Property Nationalityo As String Public Property EthnicGroupo As String Public Property ContactReasono As String Public Property ContactPersonsNameo As String Public Property ContactPersonsTelephoneNumber( ) As String Public Property ContactPersonsAddresso As XAD Public Property NextOflinldentifiers( ) As String Public Property JobStatuso As String Public Property Raceo As String Public Property Handicapo As String Public Property ContactPersonSocialSecurityNumber( ) As String End Class Public Class NPU Private Bed-Location As String Private Bed-Status As String Public Sub Newo Public Sub New(ByVal sNPURecord As String) Public Sub WriteRecord(ByVal swOut As System.IO.StreamWriter) 62 Lewis & Roca LLP Docket No. 44095.21U2 Public Property BedLocationo As String Public Property BedStatuso As String End Class Public Class DG1 Private Set-ID As String Private Dx_Coding_Method As String Private Dx_Code As CE Private Dx_Description As String Private Dx_Dttm As String Private Dx_Type As String Public Sub Newo Public Sub New(ByVal sDGlRecord As String) Public Sub WriteRecord(ByVal swOut As System.IO.StreamWriter) Public Property SetIDO As String Public Property DxCodingMethodo As String Public Property DxCodeo As CE Public Property DxDescriptiono As String Public Property DxDateTimeo As String Public Property DxTypeo As String End Class Public Class PRI-To be included in the future Public Class ErrorControl Private Const sErrorFilePath Private hl7Error As HL7 Private sSQLCmd As System.Data.SqlClient.SqlCommand Public Sub Newo Public Sub New(ByVal hl7Record As HL7) Public Sub New(ByVal sqlCmd As System.Data.SqlClient.SqlCommand) Public Sub New(ByVal hl7Record As HL7, ByVal sqlCmd As Public Sub LogError( ) Public Sub LogError(ByVal sErrorString As String) End Class Public Class XPN Extended Person Name Private First-Name As String Private Last-Name As String Private Middle Name As String Private sSuffix As String Private sPrefix As String Private sDegree As String Private Name_Type_Code As String 63 Lewis & Roca LLP Docket No. 44095.21U2 Public Sub Newo Public Sub New(ByVal sXPNRecord As String) Public Sub WriteRecord(ByVal swOut As System.IO.StreamWriter) Public ReadOnly Property FullNameo As String Public Property FirstNameo As String Public Property LastNameo As String Public Property MiddleNameo As String Public Property Suffix( ) As String Public Property Prefixo As String Public Property Degreeo As String Public Property NameTypeCodeo As String End Class Public Class XAD Private Street Address As String Private other designation As String Private scity As String Private sstate As String Private szip As String Private scountry As String Private address_jype As String Private other geographic_location As String Private country_code As String Private census-tract As String Public Sub Newo Public Sub New(ByVal sXADRecord As String) Public Sub WriteRecord(ByVal swOut As System.IO.StreamWriter) Public Property StreetAddress l1 As String Public Property StreetAddress2o As String Public Property City( ) As String Public Property Stateo As String Public Property Zip( ) As String Public Property Country( ) As String Public Property AddressType( ) As String Public Property OtherGeographicLocation( ) As String Public Property CountryCode( ) As String Public Property CensusTracto As String End Class Public Class XCN Private sIDNumber As String Private sLastName As String Private sFirstName As String 64 Lewis & Roca LLP Docket No. 44095.21U2 Private sMiddleName As String Private sSuffix As String Private sPrefix As String Private sDegree As String Private sSourceTable As String Private sAssigningAuthority As String Private sNameTypeCode As String Private sldentifierCheckDigit As String Private sldentifierCheckDigitCode As String Private sldentifierTypeCode As String Private sAssigningFacility As String Public Sub Newo Public Sub New(ByVal sXCNRecord As String) Public Sub WriteRecord(ByVal swFile As System.IO.StreamWriter) Public Property IDNumbero As String Public Property LastNameo As String Public Property FirstNameo As String Public Property MiddleNameo As String Public ReadOnly Property FullNameo As String Public Property Suffixo As String Public Property Prefixo As String Public Property Degreeo As String Public Property SourceTableo As String Public Property AssigningAuthorityo As String Public Property NameTypeCodeo As String Public Property IdentifierCheckDigito As String Public Property IdentifierCheckDigitCode( ) As String Public Property IdentifierTypeCodeo As String Public Property AssigningFacilityo As String End Class Public Class XON Private sOrganization Name As String Private sOrganization Name_Type_Code As String Private sIDNumber As String Private sCheck Digit As String Private sCheck Digit Code As String Private sAssigning Authority As String Private sldentifier Type_Code As String Private sAssigning_Facility_ID As String Public Sub Newo Public Sub New(ByVal sXONRecord As String) 65 Lewis & Roca LLP Docket No. 44095.21U2 Public Sub WriteRecord(ByVal swOut As System.IO.StreamWriter) Public Property OrganizationNameo As String Public Property OrganizationNameTypeCode( ) As String Public Property IDNumbero As String Public Property CheckDigito As String Public Property CheckDigitCodeo As String Public Property AssigningAuthorityo As String Public Property IdentifierTypeCodeo As String Public Property AssigningFacilityIDO As String End Class Public Class PL Private sPointOfCare As String Private sRoom As String Private sBed As String Private sFacility As String Private sLocationStatus As String Private sPersonLocationType As String Private sBuilding As String Private sFloor As String Private sLocationDescription As String Public Sub Newo Public Sub New(ByVal sPLRecord As String) Public Sub WriteRecord(ByVal swOut As System.IO.StreamWriter) Public Property PointOfCareo As String Public Property Roomo As String Public Property Bedo As String Public Property Facilityo As String Public Property LocationStatuso As String Public Property PersonLocationTypeo As String Public Property Buildingo As String Public Property Flooro As String Public Property LocationDescriptiono As String End Class Public Class CE Private sldentifier As String Private sText As String Private sNameOfCodingSystem As String Private sAltemateldentifier As String Private sAltemateText As String Private sNameOfAlternateCodingSystem As String Public Sub Newo 66 Lewis & Roca LLP Docket No. 44095.21U2 Public Sub New(ByVal sCERecord As String) Public Sub WriteRecord(ByVal swOut As System.IO.StreamWriter) End Class Public Class HD Private sNamespace As String Private sUniversallD As String Private sUniversalIDType As String Public Sub Newo Public Sub New(ByVal sHDRecord As String) Public Sub WriteRecord(ByVal swOut As System.IO.StreamWriter) Public Property HDNamespaceo As String Public Property UniversaIlDO As String Public Property UniversalIDTypeo As String End Class Public Class CX Private sID As String Private sCheckDigit As String Private sCheckDigitScheme As String Private sAssigningAuthority As HD Private sldentifierTypeCode As String Private sAssigningFacility As HD Public Sub Newo Public Sub New(ByVal sCXRecord As String) Public Sub WriteRecord(ByVal swOut As System.IO.StreamWriter) Public Property IDO As String Public Property CheckDigito As String Public Property CheckDigitSchemeo As String Public Property AssigningAuthorityo As HD Public Property IndentifierTypeCodeo As String Public Property AssigningFacility( As HD End Class 67 Lewis & Roca LLP

Appendix C: SOL Stored Procedure Declarations for Patient Agent Data Store:

CREATE PROC dbo.usp_padiCancelDischargePatientLocation
@EntranceDateTime datetime
,@Nursing_Station_Code char(6)
,@Room_Number char(10)
,@Bed_Number char(2)
,@Patient_Account_Number char(12)
CREATE PROC dbo.usp_padiCancelEncounter
@Patient_Account_Number char(12)
CREATE PROC dbo.usp_padiCancelPatientLocation
@Patient_Account_Number char(12)
CREATE PROC dbo.usp_padiEnterUpdateDiagnosis
@Patient_Account_Number char(12)
,@Dx_Description varchar(50)
,@Dx_Type varchar(1)
CREATE PROC dbo.usp_padiEnterUpdateEncounterRecord
@Patient_Account_Number varchar(12)
,@Patient_MRN varchar(12)
,@Admit_Timestamp datetime
,@Admitting_Diagnosis varchar(40)
,@Attending_Phys_Code varchar(11)
,@Visit_Type_Code varchar(2)
,@Service_Area_ID int
,@Admit_Phys_Code varchar(11) = NULL
,@Ref_Phys_Code varchar(11) = NULL
,@PCP_Phys_Code varchar(11) = NULL
,@Discharge_Timestamp datetime
,@Discharge_STatus_Code varchar(4) = ″
,@Confidentiality varchar(20)
,@Mother_Reg_Num int
,@Address1 varchar(21) = ″
,@City varchar(16) = ″
,@Address2 varchar(21) = ″
,@State varchar(2) = ″
,@Zip varchar(10) = ″
,@Area_Code varchar(3) = ″
,@Phone Varchar(10) = ″
,@LastUpdate datetime
CREATE PROC dbo.usp_padiEnterUpdateInsurance
@Patient_Account_Number char(12)
,@Insurance_Seq tinyint
,@Policy_Number varchar(20)
,@Group_Number varchar(20)
,@Insured_Name varchar(20)
,@Insured_Relation varchar(20)
,@Carrier_Name varchar(20)
,@Plan_Name varchar(20)
CREATE PROC dbo.usp_padiEnterUpdateNextOfKin
@Patient_MRN char(12)
,@nok_last_name varchar(20) = ″
,@nok_first_name varchar(20) = ″
,@nok_Middle_name varchar(10) = ″
,@nok_name_suffix varchar(5) = ″
,@nok_relationship varchar(15) = ″
,@nok_address1 varchar(21) = ″
,@nok_address2 varchar(21) = ″
,@nok_city varchar(16) = ″
,@nok_state varchar(2) = ″
,@nok_zip varchar(10) = ″
,@nok_home_phone varchar(20) = ″
,@nok_work_phone varchar(20) = ″
,@nok_gender char(1) = ″
,@nok_dob datetime = ″
,@nok_primary_language int = ″
,@nok_mothers_maiden varchar(18) = ″
CREATE PROC dbo.usp_padiEnterUpdatePatientAddress
@Patient_MRN varchar(12)
,@Address1 varchar(21) = ″
,@City varchar(16) = ″
,@Address2 varchar(21) = ″
,@State varchar(2) = ″
,@Zip varchar(10) = ″
,@Area_Code varchar(3) = ″
,@Phone Varchar(10) = ″
,@LastUpdate datetime
CREATE PROC dbo.usp_padiEnterUpdatePatientLocation
@Patient_Account_Number char(12)
,@EntranceDateTime datetime
,@Nursing_Station_Code char(6)
,@Room_Number char(10)
,@Bed_Number char(2)
CREATE PROC usp_padiEnterUpdatePatientRecord
@MRN varchar(12)
,@First_Name varchar(20)
,@Last_Name varchar(20)
,@Middle_Name varchar(20) = ″
,@DOB datetime
,@Gender varchar(1)
,@Suffix varchar(5) = ″
,@Expired datetime
,@SSN varchar(9)
,@Language_ID varchar(6) = ″
,@Mother_MRN varchar(12)
,@Mother_Maiden_Name varchar(18)
,@Marital_STatus_Code char(4)
,@Ethnicity_ID int
,@Birth_Place varchar(18)
,@Birth_Order varchar(1)
,@Citizenship varchar(5)
,@Veterans_Military_Status varchar(5)
CREATE PROC dbo.usp_padiMergeAccounts
@Patient_Account_Number char(12)
,@Patient_MRN varchar(50)
CREATE PROC dbo.usp_padiMovePatientLocationToHistoryTable
@Patient_Account_Number char(12)
,@EntranceDateTime datetime
,@Nursing_Station_Code char(6)
,@Room_Number char(10)
,@Bed_Number char(2)
CREATE PROC dbo.usp_padiRemoveInsurance
@Patient_Account_Number char(12)
CREATE PROC dbo.usp_padiRemoveNextOfKin
@Patient_MRN char(12)
CREATE PROC dbo.usp_padiRemovePatientAddress
@Patient_MRN char(12)
CREATE PROC dbo.usp_padiRemovePatientLocation
@Patient_Account_Number char(12)
,@ExitDateTime datetime
CREATE PROC dbo.usp_padiRemovePatientRecord
@Patient_MRN char(12)

TABLE 3.1

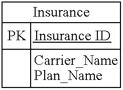

3.1 Insurance

| | |
|---|---|
| 1. InsuranceID | |
| Physical data type: | LONG |
| Allow NULLs: | Not allowed |
| 2. CarrierName | |
| Physical data type: | TEXT(50) |
| Allow NULLs: | Not allowed |
| 3. PlanName | |
| Physical data type: TEXT(50) | |
| Allow NULLs: | Not allowed |

TABLE 3.2

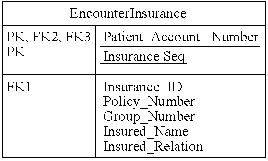

3.2 EncounterInsurance

| | |
|---|---|
| 1. PatientAccountNumber (FK) | |
| Physical data type: | TEXT(15) |
| Allow NULLs: | Not allowed |
| 2. InsuranceSeq | |
| Physical data type: | LONG |
| Allow NULLs: | Not allowed |
| 3. InsuranceID (FK) | |
| Physical data type: | LONG |
| Allow NULLs: | Not allowed |
| 4. PolicyNumber | |
| Physical data type: | TEXT(25) |
| Allow NULLs: | Allowed |
| 5. GroupNumber | |
| Physical data type: | TEXT(25) |
| Allow NULLs: | Allowed |
| 6. InsuredName | |
| Physical data type: | TEXT(50) |
| Allow NULLs: | Allowed |
| 7. InsuredRelation | |
| Physical data type: | CHAR(15) |
| Allow NULLs: | Allowed |

TABLE 3.3

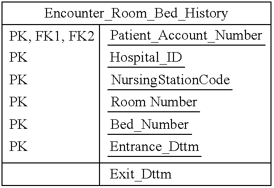

3.3 EncounterRoomBedHistory

| | |
|---|---|
| 1. PatientAccountNumber (FK) | |
| Physical data type: | TEXT(15) |
| Allow NULLs: | Not allowed |
| 2. NursingStationCode | |
| Physical data type: | TEXT(15) |
| Allow NULLs: | Not allowed |
| 3. RoomNumber | |
| Physical data type: | TEXT(4) |
| Allow NULLs: | Not allowed |
| 4. BedNumber | |
| Physical data type: | TEXT(2) |
| Allow NULLs: | Not allowed |
| 5. EntranceDttm | |
| Physical data type: | DATETIME |
| Allow NULLs: | Not allowed |
| 6. ExitDttm | |
| Physical data type: | DATETIME |
| Allow NULLs: | Not allowed |

TABLE 3.4

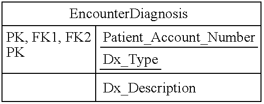

3.4 EncounterDiagnosis

| | |
|---|---|
| 1. PatientAccountNumber (FK) | |
| Physical data type: | TEXT(15) |
| Allow NULLs: | Not allowed |
| 2. DxType | |
| Physical data type: | TEXT(2) |
| Allow NULLs: | Not allowed |
| 3. DxDescription | |
| Physical data type: | TEXT(50) |
| Allow NULLs: | Not allowed |

TABLE 3.5

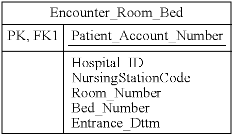

3.5 EncounterRoomBed

| | |
|---|---|
| 1. PatientAccountNumber (FK) | |
| Physical data type: | TEXT(15) |
| Allow NULLs: | Not allowed |
| 2. NursingStationCode | |
| Physical data type: | TEXT(15) |
| Allow NULLs: | Not allowed |
| 3. RoomNumber | |
| Physical data type: | TEXT(4) |
| Allow NULLs: | Not allowed |
| 4. BedNumber | |
| Physical data type: | TEXT(2) |
| Allow NULLs: | Not allowed |
| 5. EntranceDttm | |
| Physical data type: | DATETIME |
| Allow NULLs: | Not allowed |

TABLE 3.6

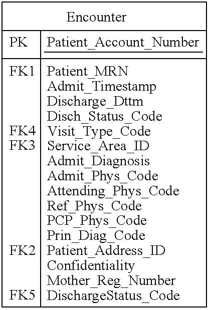

3.6 Encounter

| | |
|---|---|
| 1. PatientAccountNumber | |
| Physical data type: | TEXT(15) |
| Allow NULLs: | Not allowed |
| 2. PatientMRN (FK) | |
| Physical data type: | TEXT(15) |
| Allow NULLs: | Not allowed |
| 3. AdmitTimestamp | |
| Physical data type: | DATETIME |
| Allow NULLs: | Allowed |
| 4. DischargeDttm | |
| Physical data type: | DATETIME |
| Allow NULLs: | Allowed |
| 5. DischStatusCode | |
| Physical data type: | TEXT(10) |
| Allow NULLs: | Allowed |
| 6. VisitTypeCode (FK) | |
| Physical data type: | TEXT(5) |
| Allow NULLs: | Allowed |
| 7. ServiceAreaID (FK) | |
| Physical data type: | LONG |
| Allow NULLs: | Allowed |
| 8. AdmitDiagnosis | |
| Physical data type: | TEXT(30) |
| Allow NULLs: | Allowed |
| 9. AdmitPhysCode | |
| Physical data type: | CHAR(10) |
| Allow NULLs: | Allowed |
| 10. AttendingPhysCode | |
| Physical data type: | TEXT(10) |
| Allow NULLs: | Allowed |
| 11. RefPhysCode | |
| Physical data type: | TEXT(10) |
| Allow NULLs: | Allowed |
| 12. PCPPhysCode | |
| Physical data type: | TEXT(10) |
| Allow NULLs: | Allowed |
| 13. PrinDiagCode | |
| Physical data type: | TEXT(10) |
| Allow NULLs: | Allowed |
| 14. PatientAddressID (FK) | |
| Physical data type: | LONG |
| Allow NULLs: | Allowed |
| 15. Confidentiality | |
| Physical data type: | TEXT(1) |
| Allow NULLs: | Allowed |
| 16. MotherRegNumber | |
| Physical data type: | TEXT(15) |
| Allow NULLs: | Allowed |
| 17. DischargeStatusCode (FK) | |
| Physical data type: | TEXT(5) |
| Allow NULLs: | Allowed |

TABLE 3.7

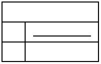

3.7 ServiceArea

| | |
|---|---|
| 1. ServiceAreaID | |
| Physical data type: | LONG |
| Allow NULLs: | Not allowed |
| 2. ServiceAreaDesc | |
| Physical data type: | TEXT(25) |
| Allow NULLs: | Not allowed |

TABLE 3.8

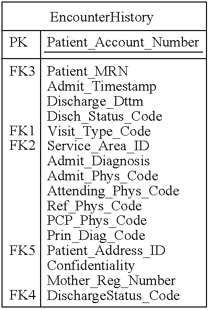

3.8 EncounterHistory

| | |
|---|---|
| 1. PatientAccountNumber | |
| Physical data type: | TEXT(15) |
| Allow NULLs: | Not allowed |
| 2. PatientMRN (FK) | |
| Physical data type: | TEXT(15) |
| Allow NULLs: | Not allowed |
| 3. AdmitTimestamp | |
| Physical data type: | DATETIME |
| Allow NULLs: | Allowed |
| 4. DischargeDttm | |
| Physical data type: | DATETIME |
| Allow NULLs: | Allowed |
| 5. DischStatusCode | |
| Physical data type: | TEXT(10) |
| Allow NULLs: | Allowed |
| 6. VisitTypeCode (FK) | |
| Physical data type: | TEXT(5) |
| Allow NULLs: | Allowed |
| 7. ServiceAreaID (FK) | |
| Physical data type: | LONG |
| Allow NULLs: | Allowed |
| 8. AdmitDiagnosis | |
| Physical data type: | TEXT(30) |
| Allow NULLs: | Allowed |
| 9. AdmitPhysCode | |
| Physical data type: | CHAR(10) |
| Allow NULLs: | Allowed |
| 10. AttendingPhysCode | |
| Physical data type: | TEXT(10) |
| Allow NULLs: | Allowed |
| 11. RefPhysCode | |
| Physical data type: | TEXT(10) |
| Allow NULLs: | Allowed |
| 12. PCPPhysCode | |
| Physical data type: | TEXT(10) |
| Allow NULLs: | Allowed |
| 13. PrinDiagCode | |
| Physical data type: | TEXT(10) |
| Allow NULLs: | Allowed |
| 14. PatientAddressID (FK) | |
| Physical data type: | LONG |
| Allow NULLs: | Allowed |
| 15. Confidentiality | |
| Physical data type: | TEXT(1) |
| Allow NULLs: | Allowed |
| 16. MotherRegNumber | |
| Physical data type: | TEXT(15) |
| Allow NULLs: | Allowed |
| 17. DischargeStatusCode (FK) | |
| Physical data type: | TEXT(5) |
| Allow NULLs: | Allowed |

TABLE 3.9

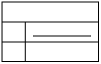

3.9 VisitType

| | |
|---|---|
| 1. VisitTypeCode | |
| Physical data type: | TEXT(5) |
| Allow NULLs: | Not allowed |
| 2. VisitTypeDesc | |
| Physical data type: | TEXT(25) |
| Allow NULLs: | Not allowed |

TABLE 3.10

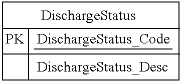

3.10 DischargeStatus

| | |
|---|---|
| 1. DischargeStatusCode | |
| Physical data type: | TEXT(5) |
| Allow NULLs: | Not allowed |
| 2. DischargeStatusDesc | |
| Physical data type: | TEXT(25) |
| Allow NULLs: | Not allowed |

TABLE 3.11

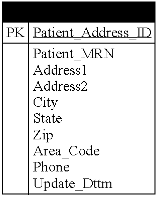

3.11 PatientAddress

| | |
|---|---|
| 1. Patient_Address_ID | |
| Physical data type: | LONG |
| Allow NULLs: | Not Allowed |
| 2. Patient_MRN | |
| Physical data type: | TEXT(15) |
| Allow NULLs: | Allowed |
| 3. Address1 | |
| Physical data type: | TEXT(50) |
| Allow NULLs: | Allowed |
| 4. Address2 | |
| Physical data type: | TEXT(50) |
| Allow NULLs: | Allowed |
| 5. City | |
| Physical data type: | TEXT(30) |
| Allow NULLs: | Allowed |
| 6. State | |
| Physical data type: | TEXT(2) |
| Allow NULLs: | Allowed |
| 7. Zip | |
| Physical data type: | TEXT(10) |
| Allow NULLs: | Allowed |
| 8. Area_Code | |
| Physical data type: | TEXT(5) |
| Allow NULLs: | Allowed |
| 9. Phone | |
| Physical data type: | TEXT(13) |
| Allow NULLs: | Allowed |
| 10. Update_Dttm | |
| Physical data type: | DATETIME |
| Allow NULLs: | Allowed |

TABLE 3.12

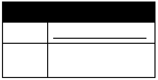

3.12 EncounterClinical

| | |
|---|---|
| 1. Patient_Account_Number (FK) | |
| Physical data type: | TEXT(15) |
| Allow NULLs: | Not allowed |
| 2. Isolation | |
| Physical data type: | TEXT(20) |
| Allow NULLs: | Allowed |
| 3. Isolation_Hx | |
| Physical data type: | TEXT(20) |
| Allow NULLs: | Allowed |

TABLE 3.13

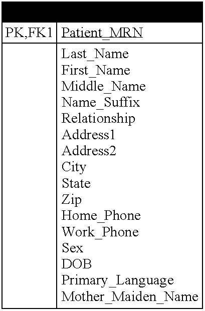

3.13 NextOfKin

| | |
|---|---|
| 1. Patient_MRN (FK) | |
| Physical data type: | TEXT(15) |
| Allow NULLs: | Not allowed |
| 2. Last_Name | |
| Physical data type: | TEXT(25) |
| Allow NULLs: | Allowed |
| 3. First_Name | |
| Physical data type: | TEXT(25) |
| Allow NULLs: | Allowed |
| 4. Middle_Name | |
| Physical data type: | TEXT(25) |
| Allow NULLs: | Allowed |
| 5. Name_Suffix | |
| Physical data type: | TEXT(10) |
| Allow NULLs: | Allowed |
| 6. Relationship | |
| Physical data type: | TEXT(15) |
| Allow NULLs: | Allowed |
| 7. Address1 | |
| Physical data type: | TEXT(50) |
| Allow NULLs: | Allowed |
| 8. Address2 | |
| Physical data type: | TEXT(50) |
| Allow NULLs: | Allowed |
| 9. City | |
| Physical data type: | TEXT(30) |
| Allow NULLs: | Allowed |
| 10. State | |
| Physical data type: | TEXT(2) |
| Allow NULLs: | Allowed |
| 11. Zip | |
| Physical data type: | TEXT(10) |
| Allow NULLs: | Allowed |
| 12. Home_Phone | |
| Physical data type: | TEXT(13) |
| Allow NULLs: | Allowed |
| 13. Work_Phone | |
| Physical data type: | TEXT(13) |
| Allow NULLs: | Allowed |
| 14. Sex | |
| Physical data type: | TEXT(1) |
| Allow NULLs: | Allowed |
| 15. DOB | |
| Physical data type: | DATETIME |
| Allow NULLs: | Allowed |
| 16. Primary_Language | |
| Physical data type: LONG | |
| Allow NULLs: | Allowed |
| 17. Mother_Maiden_Name | |
| Physical data type: TEXT(25) | |
| Allow NULLs: | Allowed |

TABLE 3.14

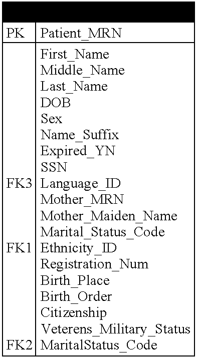

3.14 Patient

| | |
|---|---|
| 1. Patient_MRN | |
| Physical data type: | TEXT(15) |
| Allow NULLs: | Not allowed |
| 2. First_Name | |
| Physical data type: | TEXT(25) |
| Allow NULLs: | Allowed |
| 3. Middle_Name | |
| Physical data type: | TEXT(25) |
| Allow NULLs: | Allowed |
| 4. Last_Name | |
| Physical data type: | TEXT(25) |
| Allow NULLs: | Allowed |
| 5. DOB | |
| Physical data type: | DATETIME |
| Allow NULLs: | Allowed |
| 6. Sex | |
| Physical data type: | TEXT(1) |
| Allow NULLs: | Allowed |
| 7. Name_Suffix | |
| Physical data type: | TEXT(10) |
| Allow NULLs: | Allowed |
| 8. Expired_YN | |
| Physical data type: | TEXT(1) |
| Allow NULLs: | Allowed |
| 9. SSN | |
| Physical data type: | TEXT(11) |
| Allow NULLs: | Allowed |
| 10. Language_ID (FK) | |
| Physical data type: | LONG |
| Allow NULLs: | Allowed |
| 11. Mother_MRN | |
| Physical data type: | TEXT(15) |
| Allow NULLs: | Allowed |
| 12. Mother_Maiden_Name | |
| Physical data type: | TEXT(25) |
| Allow NULLs: | Allowed |
| 13. Marital_Status_Code | |
| Physical data type: | LONG |
| Allow NULLs: | Allowed |
| 14. Ethnicity_ID (FK) | |
| Physical data type: | TEXT(5) |
| Allow NULLs: | Allowed |
| 15. Registration_Num | |
| Physical data type: | TEXT(15) |
| Allow NULLs: | Allowed |
| 16. Birth_Place | |
| Physical data type: | TEXT(30) |
| Allow NULLs: | Allowed |
| 17. Birth_Order | |
| Physical data type: | TEXT(2) |
| Allow NULLs: | Allowed |
| 18. Citizenship | |
| Physical data type: | TEXT(20) |
| Allow NULLs: | Allowed |
| 19. Veterens_Military_Status | |
| Physical data type: | TEXT(20) |
| Allow NULLs: | Allowed |
| 20. MaritalStatus_Code (FK) | |
| Physical data type: | TEXT(5) |
| Allow NULLs: | Allowed |

TABLE 3.15

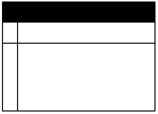

3.15 EncounterClinicalTemp

| | |
|---|---|
| 1. Patient_Account_Number | |
| Physical data type: | TEXT(15) |
| Allow NULLs: | Allowed |
| 2. Isolation | |
| Physical data type: | TEXT(20) |
| Allow NULLs: | Allowed |
| 3. Isolation_Hx | |
| Physical data type: | TEXT(20) |
| Allow NULLs: | Allowed |

TABLE 3.16

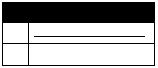

3.16 MaritalStatus

| | |
|---|---|
| 1. MaritalStatus_Code | |
| Physical data type: | TEXT(5) |
| Allow NULLs: | Not allowed |
| 2. MaritalStatus_Desc | |
| Physical data type: | TEXT(25) |
| Allow NULLs: | Not allowed |

TABLE 3.17

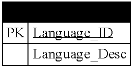

3.17 Language

| | |
|---|---|
| 1. Language_ID | |
| Physical data type: | LONG |
| Allow NULLs: | Not allowed |
| 2. Language_Desc | |
| Physical data type: | TEXT(30) |
| Allow NULLs: | Not allowed |

TABLE 3.18

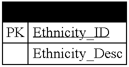

3.18 Ethnicity

| | |
|---|---|
| 1. Ethnicity_ID | |
| Physical data type: | TEXT(5) |
| Allow NULLs: | Not allowed |
| 2. Ethnicity_Desc | |
| Physical data type: | TEXT(25) |
| Allow NULLs: | Not allowed |

Appendix E: Tables 4.1-4.70—Patient Throughput Database Table Report

4.1 AdditionalAdmitTransferSource

| | |
|---|---|
| 1. Code | |
| Physical data type: | TEXT(6) |
| Allow NULLs: | Not allowed |
| 2. Desc | |
| Physical data type: | TEXT(25) |
| Allow NULLs: | Not allowed |
| 3. Active_YN | |
| Physical data type: | CHAR(1) |
| Allow NULLs: | Not allowed |

4.2 AMorPMIndicators

| 1. AMorPMIndicator_ID | |
|---|---|
| Physical data type: | LONG |
| Allow NULLs: | Not allowed |
| 2. AMorPMIndicator_Desc | |
| Physical data type: | TEXT(25) |
| Allow NULLs: | Allowed |

4.3 DayIndicators

| | |
|---|---|
| 1. DayIndicator_ID | |
| Physical data type: | LONG |
| Allow NULLs: | Not allowed |
| 2. DayIndicator_Desc | |
| Physical data type: | TEXT(25) |
| Allow NULLs: | Not allowed |

4.4 TADischarge

| 1. TADischarge_ID | |
|---|---|
| Physical data type: | LONG |
| Allow NULLs: | Not allowed |
| 2. Hospital_ID | |
| Physical data type: | LONG |
| Allow NULLs: | Not allowed |
| 3. NursingStationCode | |
| Physical data type: | TEXT(15) |
| Allow NULLs: | Not allowed |
| 4. Room_Number | |
| Physical data type: | TEXT(4) |
| Allow NULLs: | Not allowed |
| 5. Bed_Number | |
| Physical data type: | TEXT(2) |
| Allow NULLs: | Not allowed |
| 6. DayIndicator_ID (FK) | |
| Physical data type: | LONG |
| Allow NULLs: | Not allowed |
| 7. AMorPMIndicator_ID (FK) | |
| Physical data type: | LONG |
| Allow NULLs: | Not allowed |
| 8. DischargeCertaintyIndicator_ID (FK) | |
| Physical data type: | LONG |
| Allow NULLs: | Not allowed |
| 9. DischargeDetailIndicator_ID (FK) | |
| Physical data type: | LONG |
| Allow NULLs: | Not allowed |
| 10. Update_Dttm | |
| Physical data type: | DATETIME |
| Allow NULLs: | Allowed |

4.5 DischargeCertaintyIndicators

| 1. DischargeCertaintyIndicator_ID | |
|---|---|
| Physical data type: | LONG |
| Allow NULLs: | Not allowed |
| 2. DischargeCertaintyIndicator_Desc | |
| Physical data type: | TEXT(50) |
| Allow NULLs: | Allowed |

4.6 DischargeDetailIndicators

| 1. DischargeDetailIndicator_ID | |
|---|---|
| Physical data type: | LONG |
| Allow NULLs: | Not allowed |
| 2. DischargeDetailIndicator_Desc | |
| Physical data type: | TEXT(100) |
| Allow NULLs: | Allowed |

4.7 ThroughputCreateSource

| 1. ThroughputCreateSource_ID | |
|---|---|
| Physical data type: | LONG |
| Allow NULLs: | Not allowed |
| 2. ThroughputCreateSource_Desc | |
| Physical data type: | TEXT(25) |
| Allow NULLs: | Allowed |

4.8 ThroughputTargets

| 1. ThroughputTarget_ID | |
|---|---|
| Physical data type: | LONG |
| Allow NULLs: | Not allowed |
| 2. TABedRequest_ID (FK) | |
| Physical data type: | LONG |
| Allow NULLs: | Allowed |
| 3. TargetCreated_Dttm | |
| Physical data type: | DATETIME |
| Allow NULLs: | Allowed |
| 4. TargetCancelled_Dttm | |
| Physical data type: | DATETIME |
| Allow NULLs: | Allowed |
| 5. TargetHospital_ID | |
| Physical data type: | LONG |
| Allow NULLs: | Not allowed |
| 6. TargetUnit_ID | |
| Physical data type: | TEXT(15) |
| Allow NULLs: | Allowed |
| 7. TargetRoomBed | |
| Physical data type: | TEXT(6) |
| Allow NULLs: | Allowed |
| 8. ViewedByTargetUnit_YN | |
| Physical data type: | TEXT(1) |
| Allow NULLs: | Allowed |
| 9. ViewedByTargetUnit_Dttm | |
| Physical data type: | DATETIME |
| Allow NULLs: | Allowed |
| 10. BedReady_YN | |
| Physical data type: | TEXT(1) |
| Allow NULLs: | Allowed |
| 11. BedReady_Dttm | |
| Physical data type: | DATETIME |
| Allow NULLs: | Allowed |
| 12. CancelViewedByTarget_YN | |
| Physical data type: | TEXT(1) |
| Allow NULLs: | Allowed |
| 13. CancelViewedByTarget_Dttm | |
| Physical data type: | DATETIME |
| Allow NULLs: | Allowed |

4.9 SpecialNeeds

| 1. SpecialNeeds_ID | |
|---|---|
| Physical data type: | LONG |
| Allow NULLs: | Not allowed |
| 2. TABedRequest_ID (FK) | |
| Physical data type: | LONG |
| Allow NULLs: | Allowed |
| 3. SpecialNeeds_Txt | |
| Physical data type: | TEXT(250) |
| Allow NULLs: | Allowed |
| 4. UserID | |
| Physical data type: | TEXT(25) |
| Allow NULLs: | Allowed |
| 5. Create_Dttm | |
| Physical data type: | DATETIME |
| Allow NULLs: | Allowed |

4.10 BedShoppingDetails

| 1. BedShoppingDetail_ID | |
|---|---|
| Physical data type: | LONG |
| Allow NULLs: | Not allowed |
| 2. TABedRequest_ID (FK) | |
| Physical data type: | LONG |
| Allow NULLs: | Not allowed |
| 3. LikeUnit_ID (FK) | |
| Physical data type: | LONG |
| Allow NULLs: | Allowed |
| 4. Accept_YN | |
| Physical data type: | TEXT(1) |
| Allow NULLs: | Allowed |
| 5. Action_Dttm | |
| Physical data type: | DATETIME |
| Allow NULLs: | Allowed |

4.11 BedTypes

| | |
|---|---|
| 1. BedType_ID | |
| Physical data type: | LONG |
| Allow NULLs: | Not allowed |
| 2. BedType_Desc | |
| Physical data type: | TEXT(25) |
| Allow NULLs: | Not allowed |
| 3. Active_YN | |
| Physical data type: | CHAR(10) |
| Allow NULLs: | Allowed |

4.12 CancellationReasons

| | |
|---|---|
| 1. Reason_ID | |
| Physical data type: | LONG |
| Allow NULLs: | Not allowed |
| 2. Reason_Desc | |
| Physical data type: | TEXT(100) |
| Allow NULLs: | Not allowed |
| 3. Active_YN | |
| Physical data type: | TEXT(1) |
| Allow NULLs: | Not allowed |

4.13 DirectAdmitMarkets

| | |
|---|---|
| 1. ZipCode | |
| Physical data type: | TEXT(10) |
| Allow NULLs: | Not allowed |
| 2. Market | |
| Physical data type: | TEXT(25) |
| Allow NULLs: | Allowed |
| 3. State | |
| Physical data type: | TEXT(2) |
| Allow NULLs: | Allowed |
| 4. Major | |
| Physical data type: | TEXT(30) |
| Allow NULLs: | Allowed |

4.14 LikeUnits

| 1. LikeUnit_ID | |
|---|---|
| Physical data type: | LONG |
| Allow NULLs: | Not allowed |
| 2. BedType_ID (FK) | |
| Physical data type: | LONG |
| Allow NULLs: | Not allowed |
| 3. NursingStationCode | |
| Physical data type: | TEXT(25) |
| Allow NULLs: | Not allowed |
| 4. Hospital_ID | |
| Physical data type: | LONG |
| Allow NULLs: | Not allowed |

4.15 TABedRequest

| 1. TABedRequest_ID | |
|---|---|
| Physical data type: | LONG |
| Allow NULLs: | Not allowed |
| 2. ThroughputTarget_ID | |
| Physical data type: | LONG |
| Allow NULLs: | Allowed |
| 3. SourceHospital_ID | |
| Physical data type: | LONG |
| Allow NULLs: | Allowed |
| 4. SourceUnit_ID | |
| Physical data type: | TEXT(15) |
| Allow NULLs: | Allowed |
| 5. CurrentRoom | |
| Physical data type: | TEXT(4) |
| Allow NULLs: | Allowed |
| 6. ViewedBySourceUnit_YN | |
| Physical data type: | TEXT(1) |
| Allow NULLs: | Allowed |
| 7. ViewedBySourceUnit_Dttm | |
| Physical data type: | DATETIME |
| Allow NULLs: | Allowed |
| 8. PatientReady_YN | |
| Physical data type: | TEXT(1) |
| Allow NULLs: | Allowed |
| 9. PatientReady_Dttm | |
| Physical data type: | DATETIME |
| Allow NULLs: | Allowed |
| 10. PatientInBed_YN | |
| Physical data type: | TEXT(1) |
| Allow NULLs: | Allowed |
| 11. PatientInBed_Dttm | |
| Physical data type: | DATETIME |
| Allow NULLs: | Allowed |
| 12. NeedsAttention_YN | |
| Physical data type: | TEXT(1) |
| Allow NULLs: | Allowed |
| 13. NeedsAttention_Dttm | |
| Physical data type: | DATETIME |
| Allow NULLs: | Allowed |
| 14. NeedsAttentionAck_YN | |
| Physical data type: | TEXT(1) |
| Allow NULLs: | Allowed |
| 15. NeedsAttentionAck_Dttm | |
| Physical data type: | DATETIME |
| Allow NULLs: | Allowed |
| 16. Cancelled_YN | |
| Physical data type: | TEXT(1) |
| Allow NULLs: | Allowed |
| 17. Cancelled_Dttm | |
| Physical data type: | DATETIME |
| Allow NULLs: | Allowed |
| 18. CancelViewedBySourceUnit_YN | |
| Physical data type: | TEXT(1) |
| Allow NULLs: | Allowed |
| 19. CancelViewedBySourceUnit_Dttm | |
| Physical data type: | DATETIME |
| Allow NULLs: | Allowed |
| 20. CancelReason_ID (FK) | |
| Physical data type: | LONG |
| Allow NULLs: | Allowed |
| 21. CancelNotes | |
| Physical data type: | LONG |
| Allow NULLs: | Allowed |
| 22. Finished_YN | |
| Physical data type: | TEXT(1) |
| Allow NULLs: | Allowed |
| 23. Finished_Dttm | |
| Physical data type: | DATETIME |
| Allow NULLs: | Allowed |

4.16 TADemographics

| 1. TADemographic_ID | |
|---|---|
| Physical data type: | LONG |
| Allow NULLs: | Not allowed |
| 2. Account_Number | |
| Physical data type: | TEXT(20) |
| Allow NULLs: | Allowed |
| 3. MRN | |
| Physical data type: | TEXT(20) |
| Allow NULLs: | Allowed |
| 4. Last_Name | |
| Physical data type: | TEXT(25) |
| Allow NULLs: | Not allowed |
| 5. First_Name | |
| Physical data type: | TEXT(25) |
| Allow NULLs: | Allowed |
| 6. Middle_Name | |
| Physical data type: | TEXT(25) |
| Allow NULLs: | Allowed |
| 7. DOB | |
| Physical data type: | TEXT(11) |
| Allow NULLs: | Allowed |
| 8. Sex | |
| Physical data type: | TEXT(1) |
| Allow NULLs: | Allowed |
| 9. AdmitPhys | |
| Physical data type: | TEXT(50) |
| Allow NULLs: | Allowed |
| 10. RefPhys | |
| Physical data type: | TEXT(50) |
| Allow NULLs: | Allowed |
| 11. AdmitDx | |
| Physical data type: | TEXT(50) |
| Allow NULLs: | Allowed |

4.17 TATypes

| | |
|---|---|
| 1. TAType_ID | |
| Physical data type: | LONG |
| Allow NULLs: | Not allowed |
| 2. TAType_Desc | |
| Physical data type: | TEXT(50) |
| Allow NULLs: | Not allowed |
| 3. Active_YN | |
| Physical data type: | TEXT(1) |
| Allow NULLs: | Not allowed |

4.18 Throughput Activity

| 1. ThroughputActivity_ID | |
|---|---|
| Physical data type: | LONG |
| Allow NULLs: | Not allowed |
| 2. TAType_ID (FK) | |
| Physical data type: | LONG |
| Allow NULLs: | Not allowed |
| 3. TADemographic_ID (FK) | |
| Physical data type: | LONG |
| Allow NULLs: | Not allowed |
| 4. ThroughputCreateSource_ID (FK) | |
| Physical data type: | LONG |
| Allow NULLs: | Not allowed |
| 5. TABedRequest_ID (FK) | |
| Physical data type: | LONG |
| Allow NULLs: | Allowed |
| 6. TADischarge_ID (FK) | |
| Physical data type: | LONG |
| Allow NULLs: | Allowed |
| 7. Create_Dttm | |
| Physical data type: | DATETIME |
| Allow NULLs: | Allowed |

4.19 AlertsSent

| 1. AlertType_ID (FK) | |
|---|---|
| Physical data type: | LONG |
| Allow NULLs: | Not allowed |
| 2. Recipient_ID (FK) | |
| Physical data type: | LONG |
| Allow NULLs: | Not allowed |
| 3. Sent_Dttm | |
| Physical data type: | DATETIME |
| Allow NULLs: | Not allowed |

4.20 AlertType

| | |
|---|---|
| 1. AlertType_ID | |
| Physical data type: | LONG |
| Allow NULLs: | Not allowed |
| 2. AlertType_Desc | |
| Physical data type: | TEXT(50) |
| Allow NULLs: | Not allowed |
| 3. UnitSpecific_YN | |
| Physical data type: | TEXT(1) |
| Allow NULLs: | Not allowed |
| 4. Active_YN | |
| Physical data type: | TEXT(1) |
| Allow NULLs: | Not allowed |

4.21 Contacts

| 1. Contact_ID | |
|---|---|
| Physical data type: | LONG |
| Allow NULLs: | Not allowed |
| 2. EmpOrUnit_ID | |
| Physical data type: | TEXT(20) |
| Allow NULLs: | Not allowed |
| 3. Contact_Desc | |
| Physical data type: | TEXT(50) |
| Allow NULLs: | Not allowed |
| 4. Address | |
| Physical data type: | TEXT(50) |
| Allow NULLs: | Not allowed |
| 5. AddressActive_YN | |
| Physical data type: | TEXT(1) |
| Allow NULLs: | Not allowed |
| 6. CurrentEmployee_YN | |
| Physical data type: | TEXT(1) |
| Allow NULLs: | Not allowed |

4.22 Recipients

| | |
|---|---|
| 1. Recipient_ID | |
| Physical data type: | LONG |
| Allow NULLs: | Not allowed |
| 2. AlertType_ID (FK) | |
| Physical data type: | LONG |
| Allow NULLs: | Not allowed |
| 3. Contact_ID (FK) | |
| Physical data type: | LONG |
| Allow NULLs: | Not allowed |
| 4. Unit_ID | |
| Physical data type: | TEXT(20) |
| Allow NULLs: | Allowed |
| 5. Hospital_ID | |
| Physical data type: | LONG |
| Allow NULLs: | Allowed |

4.23 Auctions

| 1. Auction_ID | |
|---|---|
| Physical data type: | LONG |
| Allow NULLs: | Not allowed |
| 2. AuctionStart_Dttm | |
| Physical data type: | DATETIME |
| Allow NULLs: | Not allowed |
| 3. AuctionEnd_Dttm | |
| Physical data type: | DATETIME |
| Allow NULLs: | Not allowed |
| 4. AuctionType_ID (FK) | |
| Physical data type: | LONG |
| Allow NULLs: | Not allowed |
| 5. Wage | |
| Physical data type: | LONG |
| Allow NULLs: | Allowed |
| 6. DblLotteryMax | |
| Physical data type: | LONG |
| Allow NULLs: | Allowed |
| 7. Notes | |
| Physical data type: | TEXT(500) |
| Allow NULLs: | Allowed |
| 8. AvailableShiftID (FK) | |
| Physical data type: | LONG |
| Allow NULLs: | Allowed |
| 9. Cancelled_Dttm | |
| Physical data type: | DATETIME |
| Allow NULLs: | Allowed |
| 10. Cancelled_YN | |
| Physical data type: | TEXT(1) |
| Allow NULLs: | Allowed |

4.24 AuctionTypes

| | |
|---|---|
| 1. AuctionType_ID | |
| Physical data type: | LONG |
| Allow NULLs: | Not allowed |
| 2. AuctionType_Desc | |
| Physical data type: | TEXT(50) |
| Allow NULLs: | Not allowed |
| 3. Active_YN | |
| Physical data type: | TEXT(1) |
| Allow NULLs: | Not allowed |

4.25 AuthorizedUnits

| | |
|---|---|
| 1. UserID (FK) | |
| Physical data type: | TEXT(25) |
| Allow NULLs: | Not allowed |
| 2. NursingStationCode | |
| Physical data type: | TEXT(15) |
| Allow NULLs: | Not allowed |

4.26 BidHistory

| 1. Bid_ID | |
|---|---|
| Physical data type: | LONG |
| Allow NULLs: | Not allowed |
| 2. Auction_ID (FK) | |
| Physical data type: | LONG |
| Allow NULLs: | Not allowed |
| 3. UserID | |
| Physical data type: | TEXT(25) |
| Allow NULLs: | Not allowed |
| 4. BidAmt | |
| Physical data type: | LONG |
| Allow NULLs: | Not allowed |
| 5. BidPlaced_Dttm | |
| Physical data type: | DATETIME |
| Allow NULLs: | Not allowed |
| 6. BidEnd_Dttm | |
| Physical data type: | DATETIME |
| Allow NULLs: | Not allowed |
| 7. WinningBid_YN | |
| Physical data type: | TEXT(1) |
| Allow NULLs: | Not allowed |
| 8. MgrApproves_YN | |
| Physical data type: | TEXT(1) |
| Allow NULLs: | Allowed |
| 9. MgrApproves_Dttm | |
| Physical data type: | DATETIME |
| Allow NULLs: | Allowed |
| 10. MgrUserID | |
| Physical data type: | TEXT(15) |
| Allow NULLs: | Allowed |
| 11. DenialReason_ID (FK) | |
| Physical data type: | LONG |
| Allow NULLs: | Allowed |

4.27 Competencies

| | |
|---|---|
| 1. Compentency_ID | |
| Physical data type: | LONG |
| Allow NULLs: | Not allowed |
| 2. Competency_Desc | |
| Physical data type: | TEXT(50) |
| Allow NULLs: | Not allowed |
| 3. Active_YN | |
| Physical data type: | TEXT(1) |
| Allow NULLs: | Not allowed |

4.28 ContactMethods

| | |
|---|---|
| 1. UserID (FK) | |
| Physical data type: | TEXT(25) |
| Allow NULLs: | Not allowed |
| 2. Address | |
| Physical data type: | TEXT(50) |
| Allow NULLs: | Not allowed |

4.29 CurrentBids

| | |
|---|---|
| 1. Bid_ID | |
| Physical data type: | LONG |
| Allow NULLs: | Not allowed |
| 2. Auction_ID (FK) | |
| Physical data type: | LONG |
| Allow NULLs: | Not allowed |
| 3. UserID | |
| Physical data type: | TEXT(12) |
| Allow NULLs: | Not allowed |
| 4. BidAmt | |
| Physical data type: | LONG |
| Allow NULLs: | Not allowed |
| 5. BidPlaced_Dttm | |
| Physical data type: | DATETIME |
| Allow NULLs: | Not allowed |

4.30 DenialReasons

| | |
|---|---|
| 1. DenialReason_ID | |
| Physical data type: | LONG |
| Allow NULLs: | Not allowed |
| 2. Reason_Desc | |
| Physical data type: | TEXT(50) |
| Allow NULLs: | Not allowed |
| 3. Active_YN | |
| Physical data type: | TEXT(1) |
| Allow NULLs: | Not allowed |
| 4. StopsShiftFill_YN | |
| Physical data type: | TEXT(1) |
| Allow NULLs: | Not allowed |

4.31 DLWageOptions

| | |
|---|---|
| 1. WageOption_ID | |
| Physical data type: | LONG |
| Allow NULLs: | Not allowed |
| 2. Option_Desc | |
| Physical data type: | TEXT(50) |
| Allow NULLs: | Not allowed |
| 3. Active_YN | |
| Physical data type: | TEXT(1) |
| Allow NULLs: | Not allowed |

4.32 RegistrationHistory

| 1. Registration_ID | |
|---|---|
| Physical data type: | LONG |
| Allow NULLs: | Not allowed |
| 2. Auction_ID (FK) | |
| Physical data type: | LONG |
| Allow NULLs: | Not allowed |
| 3. UserID | |
| Physical data type: | TEXT(25) |
| Allow NULLs: | Not allowed |
| 4. Registered_Dttm | |
| Physical data type: | DATETIME |
| Allow NULLs: | Not allowed |
| 5. Unregistered_Dttm | |
| Physical data type: | DATETIME |
| Allow NULLs: | Allowed |
| 6. Winner_YN | |
| Physical data type: | TEXT(1) |
| Allow NULLs: | Not allowed |
| 7. WageOption_ID (FK) | |
| Physical data type: | LONG |
| Allow NULLs: | Allowed |
| 8. MgrApproves_YN | |
| Physical data type: | TEXT(1) |
| Allow NULLs: | Allowed |
| 9. MgrApproves_Dttm | |
| Physical data type: | DATETIME |
| Allow NULLs: | Allowed |
| 10. MgrUserID | |
| Physical data type: | TEXT(15) |
| Allow NULLs: | Allowed |
| 11. DenialReason_ID (FK) | |
| Physical data type: | LONG |
| Allow NULLs: | Allowed |

4.33 Registrations

| | |
|---|---|
| 1. Registration_ID | |
| Physical data type: | LONG |
| Allow NULLs: | Not allowed |
| 2. Auction_ID (FK) | |
| Physical data type: | LONG |
| Allow NULLs: | Not allowed |
| 3. UserID | |
| Physical data type: | TEXT(25) |
| Allow NULLs: | Not allowed |
| 4. Registered_Dttm | |
| Physical data type: | DATETIME |
| Allow NULLs: | Not allowed |

4.34 Shifts

| 1. AvailableShiftID | |
|---|---|
| Physical data type: | LONG |
| Allow NULLs: | Not allowed |
| 2. HospitalID | |
| Physical data type: | LONG |
| Allow NULLs: | Not allowed |
| 3. nursingstationcode | |
| Physical data type: | TEXT(15) |
| Allow NULLs: | Not allowed |
| 4. ShiftDate | |
| Physical data type: | DATETIME |
| Allow NULLs: | Not allowed |
| 5. ShiftStartTime | |
| Physical data type: | DATETIME |
| Allow NULLs: | Not allowed |
| 6. ShiftEndTime | |
| Physical data type: | DATETIME |
| Allow NULLs: | Not allowed |
| 7. StaffType | |
| Physical data type: | LONG |
| Allow NULLs: | Not allowed |
| 8. ManagerID (FK) | |
| Physical data type: | TEXT(25) |
| Allow NULLs: | Not allowed |
| 9. AlertStaffingOffice_YN | |
| Physical data type: | TEXT(1) |
| Allow NULLs: | Allowed |

4.35 UserCompentencies

| 1. UserID (FK) | |
|---|---|
| Physical data type: | TEXT(25) |
| Allow NULLs: | Not allowed |
| 2. Compentency_ID (FK) | |
| Physical data type: | LONG |
| Allow NULLs: | Not allowed |

4.36 Users

| | |
|---|---|
| 1. UserID | |
| Physical data type: | TEXT(25) |
| Allow NULLs: | Not allowed |
| 2. EmpID | |
| Physical data type: | TEXT(12) |
| Allow NULLs: | Not allowed |
| 3. Registered_YN | |
| Physical data type: | DATETIME |
| Allow NULLs: | Allowed |
| 4. Date_Registered | |
| Physical data type: | DATETIME |
| Allow NULLs: | Allowed |
| 5. Manager_EmpID | |
| Physical data type: | TEXT(12) |
| Allow NULLs: | Allowed |
| 6. Approved_YN | |
| Physical data type: | TEXT(1) |
| Allow NULLs: | Allowed |
| 7. ManagerAuth_Dttm | |
| Physical data type: | DATETIME |
| Allow NULLs: | Allowed |

4.37 Bed Status

| | |
|---|---|
| 1. Hospital_ID | |
| Physical data type: | LONG |
| Allow NULLs: | Not allowed |
| 2. NursingStationCode | |
| Physical data type: | TEXT(15) |
| Allow NULLs: | Not allowed |
| 3. Room_Number | |
| Physical data type: | TEXT(4) |
| Allow NULLs: | Not allowed |
| 4. Bed_Number | |
| Physical data type: | TEXT(2) |
| Allow NULLs: | Not allowed |
| 5. Status_Time | |
| Physical data type: | DATETIME |
| Allow NULLs: | Allowed |
| 6. Status | |
| Physical data type: | TEXT(15) |
| Allow NULLs: | Allowed |

4.38 Bed_Staffing_Indicator

| 1. Hospital_ID | |
|---|---|
| Physical data type: | LONG |
| Allow NULLs: | Not allowed |
| 2. NursingStationCode | |
| Physical data type: | TEXT(15) |
| Allow NULLs: | Not allowed |
| 3. Room_Number | |
| Physical data type: | TEXT(4) |
| Allow NULLs: | Not allowed |
| 4. Bed_Number | |
| Physical data type: | TEXT(2) |
| Allow NULLs: | Not allowed |
| 5. Room_Bed_Number | |
| Physical data type: | TEXT(6) |
| Allow NULLs: | Allowed |
| 6. Room_Bed_Number_2 | |
| Physical data type: | TEXT(7) |
| Allow NULLs: | Allowed |
| 7. Staffing_Indicator | |
| Physical data type: | TEXT(1) |
| Allow NULLs: | Allowed |
| 8. IOBed_YN | |
| Physical data type: | TEXT(1) |
| Allow NULLs: | Not allowed |
| 9. MasterNursingStationCode | |
| Physical data type: | TEXT(15) |
| Allow NULLs: | Allowed |

4.39 HourlyOccupancy

| | |
|---|---|
| 1. Hospital_ID | |
| Physical data type: | LONG |
| Allow NULLs: | Not allowed |
| 2. NursingStationCode | |
| Physical data type: | TEXT(15) |
| Allow NULLs: | Not allowed |
| 3. Extract_Dttm | |
| Physical data type: | DATETIME |
| Allow NULLs: | Not allowed |
| 4. IO_YN | |
| Physical data type: | TEXT(1) |
| Allow NULLs: | Not allowed |
| 5. Census | |
| Physical data type: | LONG |
| Allow NULLs: | Not allowed |

4.40 NursingStationNames

| | |
|---|---|
| 1. NursingStationCode | |
| Physical data type: | TEXT(15) |
| Allow NULLs: | Not allowed |
| 2. NursingStationDesc | |
| Physical data type: | TEXT(50) |
| Allow NULLs: | Allowed |
| 3. LastUpdate_Dttm | |
| Physical data type: | DATETIME |
| Allow NULLs: | Allowed |

4.41 NursingStations

| 1. Hospital_ID | |
|---|---|
| Physical data type: | LONG |
| Allow NULLs: | Not allowed |
| 2. NursingStationCode (FK) | |
| Physical data type: | TEXT(15) |
| Allow NULLs: | Not allowed |
| 3. ActiveForBedStaffing_YN | |
| Physical data type: | TEXT(1) |
| Allow NULLs: | Allowed |
| 4. SourceCensusAvailable_YN | |
| Physical data type: | TEXT(1) |
| Allow NULLs: | Allowed |
| 5. MasterNursingStationCode | |
| Physical data type: | TEXT(15) |
| Allow NULLs: | Allowed |
| 6. TrackedStatus_YN | |
| Physical data type: | TEXT(1) |
| Allow NULLs: | Allowed |
| 7. ActiveForThroughputBooster | |
| Physical data type: | TEXT(1) |
| Allow NULLs: | Allowed |
| 8. ICUUnit_YN | |
| Physical data type: | TEXT(1) |
| Allow NULLs: | Allowed |
| 9. DisplayOnSummitView_YN | |
| Physical data type: | TEXT(1) |
| Allow NULLs: | Allowed |

4.42 PatientStats

| 1. Extract_Dttm | |
|---|---|
| Physical data type: | DATETIME |
| Allow NULLs: | Not allowed |
| 2. Count_Type | |
| Physical data type: | TEXT(25) |
| Allow NULLs: | Not allowed |
| 3. Hospital_ID | |
| Physical data type: | LONG |
| Allow NULLs: | Not allowed |
| 4. NusrsingStationDesc (FK) | |
| Physical data type: | TEXT(50) |
| Allow NULLs: | Not allowed |
| 5. Extract_Count | |
| Physical data type: | LONG |
| Allow NULLs: | Allowed |

4.43 PatientStats_Temp

| 1. Extract_Dttm | |
|---|---|
| Physical data type: | DATETIME |
| Allow NULLs: | Allowed |
| 2. Count_Type | |
| Physical data type: | TEXT(25) |
| Allow NULLs: | Allowed |
| 3. NursingStationDesc (FK) | |
| Physical data type: | TEXT(50) |
| Allow NULLs: | Allowed |
| 4. Hospital_ID | |
| Physical data type: | LONG |
| Allow NULLs: | Allowed |
| 5. Extract_Count | |
| Physical data type: | LONG |
| Allow NULLs: | Allowed |

4.44 SummitViewPreLoad

| 1. Hospital_ID | |
|---|---|
| Physical data type: | LONG |
| Allow NULLs: | Not allowed |
| 2. NursingStationCode | |
| Physical data type: | TEXT(15) |
| Allow NULLs: | Not allowed |
| 3. NursingStationDesc | |
| Physical data type: | TEXT(50) |
| Allow NULLs: | Allowed |
| 4. CleanBeds | |
| Physical data type: | TEXT(5) |
| Allow NULLs: | Allowed |
| 5. DirtyBeds | |
| Physical data type: | TEXT(5) |
| Allow NULLs: | Allowed |
| 6. EmptyBeds | |
| Physical data type: | TEXT(5) |
| Allow NULLs: | Allowed |
| 7. StaffedBeds | |
| Physical data type: | TEXT(5) |
| Allow NULLs: | Allowed |
| 8. TotalRNsOnCall | |
| Physical data type: | TEXT(5) |
| Allow NULLs: | Allowed |
| 9. InpatientOccupiedBeds | |
| Physical data type: | TEXT(5) |
| Allow NULLs: | Allowed |
| 10. NonInpatientOccupiedBeds | |
| Physical data type: | TEXT(5) |
| Allow NULLs: | Allowed |
| 11. MidnightCensus | |
| Physical data type: | TEXT(5) |
| Allow NULLs: | Allowed |
| 12. PercentOccupied | |
| Physical data type: | TEXT(5) |
| Allow NULLs: | Allowed |
| 13. PendingAdmitsToUnit | |
| Physical data type: | TEXT(5) |
| Allow NULLs: | Allowed |
| 14. PendingAdmitsFromUnit | |
| Physical data type: | TEXT(5) |
| Allow NULLs: | Allowed |
| 15. PendingDischargesTodayFromUnit | |
| Physical data type: | TEXT(5) |
| Allow NULLs: | Allowed |
| 16. PendingDischargesTomorrowFromUnit | |
| Physical data type: | TEXT(5) |
| Allow NULLs: | Allowed |
| 17. SourceCensusAvailable_YN | |
| Physical data type: | TEXT(1) |
| Allow NULLs: | Allowed |
| 18. TrackedStatus_YN | |
| Physical data type: | TEXT(1) |
| Allow NULLs: | Allowed |

4.45 SummitViewPreLoad_HourlySnapshot

| 1. Hospital_ID | |
|---|---|
| Physical data type: | LONG |
| Allow NULLs: | Not allowed |
| 2. NursingStationCode | |
| Physical data type: | TEXT(15) |
| Allow NULLs: | Not allowed |
| 3. NusringStationDesc | |
| Physical data type: | TEXT(50) |
| Allow NULLs: | Allowed |
| 4. CleanBeds | |
| Physical data type: | TEXT(5) |
| Allow NULLs: | Allowed |
| 5. DirtyBeds | |
| Physical data type: | TEXT(5) |
| Allow NULLs: | Allowed |
| 6. EmptyBeds | |
| Physical data type: | TEXT(5) |
| Allow NULLs: | Allowed |
| 7. StaffedBeds | |
| Physical data type: | TEXT(5) |
| Allow NULLs: | Allowed |
| 8. TotalRNsOnCall | |
| Physical data type: | TEXT(5) |
| Allow NULLs: | Allowed |
| 9. InpatientOccupiedBeds | |
| Physical data type: | TEXT(5) |
| Allow NULLs: | Allowed |
| 10. NonInpatientOccupiedBeds | |
| Physical data type: | TEXT(5) |
| Allow NULLs: | Allowed |
| 11. MidnightCensus | |
| Physical data type: | TEXT(5) |
| Allow NULLs: | Allowed |
| 12. PercentOccupied | |
| Physical data type: | TEXT(5) |
| Allow NULLs: | Allowed |
| 13. PendingAdmitsToUnit | |
| Physical data type: | TEXT(5) |
| Allow NULLs: | Allowed |
| 14. PendingAdmitsFromUnit | |
| Physical data type: | TEXT(5) |
| Allow NULLs: | Allowed |
| 15. PendingDischargesTodayFromUnit | |
| Physical data type: | TEXT(5) |
| Allow NULLs: | Allowed |
| 16. PendingDischargesTomorrowFromUnit | |
| Physical data type: | TEXT(5) |
| Allow NULLs: | Allowed |
| 17. SourceCensusAvailable_YN | |
| Physical data type: | TEXT(1) |
| Allow NULLs: | Allowed |
| 18. TrackedStatus_YN | |
| Physical data type: | TEXT(1) |
| Allow NULLs: | Allowed |
| 19. Extract_Dttm | |
| Physical data type: | DATETIME |
| Allow NULLs: | Not allowed |

4.46 SummitViewPreLoad_UnitTotals

| 1. Hospital_ID | |
|---|---|
| Physical data type: | LONG |
| Allow NULLs: | Not allowed |
| 2. Extract_Dttm | |
| Physical data type: | DATETIME |
| Allow NULLs: | Not allowed |
| 3. IncludesNursery_YN | |
| Physical data type: | TEXT(1) |
| Allow NULLs: | Allowed |
| 4. CleanBeds | |
| Physical data type: | TEXT(5) |
| Allow NULLs: | Allowed |
| 5. DirtyBeds | |
| Physical data type: | TEXT(5) |
| Allow NULLs: | Allowed |
| 6. EmptyBeds | |
| Physical data type: | TEXT(5) |
| Allow NULLs: | Allowed |
| 7. StaffedBeds | |
| Physical data type: | TEXT(5) |
| Allow NULLs: | Allowed |
| 8. InpatientOccupiedBeds | |
| Physical data type: | TEXT(5) |
| Allow NULLs: | Allowed |
| 9. NonInpatientOccupiedBeds | |
| Physical data type: | TEXT(5) |
| Allow NULLs: | Allowed |
| 10. MidnightCensus | |
| Physical data type: | TEXT(5) |
| Allow NULLs: | Allowed |
| 11. PercentOccupied | |
| Physical data type: | TEXT(5) |
| Allow NULLs: | Allowed |
| 12. PendingAdmitsToUnit | |
| Physical data type: | TEXT(5) |
| Allow NULLs: | Allowed |
| 13. PendingAdmitsFromUnit | |
| Physical data type: | TEXT(5) |
| Allow NULLs: | Allowed |
| 14. PendingDischargesTodayFromUnit | |
| Physical data type: | TEXT(5) |
| Allow NULLs: | Allowed |
| 15. PendingDischargesTomorrowFromUnit | |
| Physical data type: | TEXT(5) |
| Allow NULLs: | Allowed |

4.47 Communications

| 1. Communication_ID | |
|---|---|
| Physical data type: | LONG |
| Allow NULLs: | Not allowed |
| 2. CommunicationType_ID (FK) | |
| Physical data type: | LONG |
| Allow NULLs: | Not allowed |
| 3. Communication_Dttm | |
| Physical data type: | DATETIME |
| Allow NULLs: | Not allowed |
| 4. Communication_Txt | |
| Physical data type: | TEXT(500) |
| Allow NULLs: | Not allowed |
| 5. UserID | |
| Physical data type: | TEXT(25) |
| Allow NULLs: | Not allowed |
| 6. SourceHospital_ID | |
| Physical data type: | LONG |
| Allow NULLs: | Not allowed |
| 7. Source_ID | |
| Physical data type: | TEXT(25) |
| Allow NULLs: | Not allowed |
| 8. TargetHospital_ID | |
| Physical data type: | LONG |
| Allow NULLs: | Not allowed |
| 9. Target_ID | |
| Physical data type: | TEXT(25) |
| Allow NULLs: | Not allowed |
| 10. ReadBySource_YN | |
| Physical data type: | TEXT(1) |
| Allow NULLs: | Not allowed |
| 11. ReadBySource_Dttm | |
| Physical data type: | DATETIME |
| Allow NULLs: | Allowed |
| 12. ReadByTarget_YN | |
| Physical data type: | TEXT(1) |
| Allow NULLs: | Allowed |
| 13. ReadByTarget_Dttm | |
| Physical data type: | DATETIME |
| Allow NULLs: | Allowed |
| 14. Expiration_Dttm | |
| Physical data type: | DATETIME |
| Allow NULLs: | Allowed |
| 15. ThroughputActivity_ID (FK) | |
| Physical data type: | LONG |
| Allow NULLs: | Allowed |

4.48 CommunicationTypes

| 1. CommunicationType_ID | |
|---|---|
| Physical data type: | LONG |
| Allow NULLs: | Not allowed |
| 2. CommunicationType_Desc | |
| Physical data type: | TEXT(50) |
| Allow NULLs: | Not allowed |
| 3. Active_YN | |
| Physical data type: | TEXT(1) |
| Allow NULLs: | Not allowed |

4.49 CurrentStaffedBeds

| | |
|---|---|
| 1. StaffCount_ID | |
| Physical data type: | LONG |
| Allow NULLs: | Not allowed |
| 2. NursingStationCode | |
| Physical data type: | TEXT(15) |
| Allow NULLs: | Not allowed |
| 3. Hospital_ID | |
| Physical data type: | LONG |
| Allow NULLs: | Not allowed |
| 4. TargetRatioRN | |
| Physical data type: | TEXT(3) |
| Allow NULLs: | Not allowed |
| 5. TargetRatioPatient | |
| Physical data type: | TEXT(3) |
| Allow NULLs: | Not allowed |
| 6. ActualStaffedBeds | |
| Physical data type: | TEXT(3) |
| Allow NULLs: | Not allowed |
| 7. RNsOnCall | |
| Physical data type: | TEXT(3) |
| Allow NULLs: | Not allowed |
| 8. CurrentHaves | |
| Physical data type: | TEXT(3) |
| Allow NULLs | Not Allowed |
| 9. EnteredBy | |
| Physical data type: | TEXT(15) |
| Allow NULLs: | Not allowed |
| 10. Entered_Dttm | |
| Physical data type: | DATETIME |
| Allow NULLs: | Not allowed |

4.50 NursingStationStaffTypes

| 1. NursingStationCode | |
|---|---|
| Physical data type: | TEXT(15) |
| Allow NULLs: | Not allowed |
| 2. Hospital_ID | |
| Physical data type: | LONG |
| Allow NULLs: | Not allowed |
| 3. StaffType_ID (FK) | |
| Physical data type: | LONG |
| Allow NULLs: | Not allowed |
| 4. Active_YN | |
| Physical data type: | TEXT(1) |
| Allow NULLs: | Not allowed |

4.51 RatioDiscrepencyReasons

| 1. RatioDiscrepencyReason_ID | |
|---|---|
| Physical data type: | LONG |
| Allow NULLs: | Not allowed |
| 2. Reason_Desc | |
| Physical data type: | TEXT(50) |
| Allow NULLs: | Not allowed |

4.52 SBDiscrepencyReasons

| 1. Hospital_ID | |
|---|---|
| Physical data type: | LONG |
| Allow NULLs: | Not allowed |
| 2. NursingStationCode | |
| Physical data type: | TEXT(15) |
| Allow NULLs: | Not allowed |
| 3. RatioDiscrepencyReason_ID (FK) | |
| Physical data type: | LONG |
| Allow NULLs: | Not allowed |
| 4. EnteredBy | |
| Physical data type: | TEXT(15) |
| Allow NULLs: | Not allowed |
| 5. Entered_Dttm | |
| Physical data type: | DATETIME |
| Allow NULLs: | Not allowed |

4.53 SBDiscrepencyReasonsHistory

| 1. Hospital_ID | |
|---|---|
| Physical data type: | LONG |
| Allow NULLs: | Not allowed |
| 2. NursingStationCode | |
| Physical data type: | TEXT(15) |
| Allow NULLs: | Not allowed |
| 3. RatioDiscrepencyReason_ID (FK) | |
| Physical data type: | LONG |
| Allow NULLs: | Not allowed |
| 4. EnteredBy | |
| Physical data type: | TEXT(15) |
| Allow NULLs: | Not allowed |
| 5. EnteredBy_Dttm | |
| Physical data type: | DATETIME |
| Allow NULLs: | Not allowed |
| 6. End_Dttm | |
| Physical data type: | DATETIME |
| Allow NULLs: | Not allowed |

4.54 SBHaves

| 1. Hospital_ID | |
|---|---|
| Physical data type: | LONG |
| Allow NULLs: | Not allowed |
| 2. NursingStationCode | |
| Physical data type: | TEXT(15) |
| Allow NULLs: | Not allowed |
| 3. StaffType_ID (FK) | |
| Physical data type: | LONG |
| Allow NULLs: | Not allowed |
| 4. Haves | |
| Physical data type: | TEXT(3) |
| Allow NULLs: | Not allowed |
| 5. Entered_Dttm | |
| Physical data type: | DATETIME |
| Allow NULLs: | Not allowed |

4.55 SBHavesHistory

| 1. Hospital_ID | |
|---|---|
| Physical data type: | LONG |
| Allow NULLs: | Not allowed |
| 2. NursingStationCode | |
| Physical data type: | TEXT(15) |
| Allow NULLs: | Not allowed |
| 3. StaffType_ID (FK) | |
| Physical data type: | LONG |
| Allow NULLs: | Not allowed |
| 4. Haves | |
| Physical data type: | TEXT(3) |
| Allow NULLs: | Not allowed |
| 5. Entered_Dttm | |
| Physical data type: | DATETIME |
| Allow NULLs: | Not allowed |
| 6. End_Dttm | |
| Physical data type: | DATETIME |
| Allow NULLs: | Not allowed |

4.56 SBShortageSurplus

| 1. NursingStationCode | |
|---|---|
| Physical data type: | TEXT(15) |
| Allow NULLs: | Not allowed |
| 2. Hospital_ID | |
| Physical data type: | LONG |
| Allow NULLs: | Not allowed |
| 3. StaffType_ID (FK) | |
| Physical data type: | LONG |
| Allow NULLs: | Not allowed |
| 4. Shortage | |
| Physical data type: | TEXT(3) |
| Allow NULLs: | Not allowed |
| 5. Surplus | |
| Physical data type: | TEXT(3) |
| Allow NULLs: | Not allowed |
| 6. Entered_Dttm | |
| Physical data type: | DATETIME |
| Allow NULLs: | Not allowed |
| 7. Entered_By | |
| Physical data type: | TEXT(15) |
| Allow NULLs: | Not allowed |

4.57 SBShortageSurplusHistory

| 1. NursingStationCode | |
|---|---|
| Physical data type: | TEXT(15) |
| Allow NULLs: | Not allowed |
| 2. Hospital_ID | |
| Physical data type: | LONG |
| Allow NULLs: | Not allowed |
| 3. StaffType_ID (FK) | |
| Physical data type: | LONG |
| Allow NULLs: | Not allowed |
| 4. Shortage | |
| Physical data type: | TEXT(3) |
| Allow NULLs: | Not allowed |
| 5. Surplus | |
| Physical data type: | TEXT(3) |
| Allow NULLs: | Not allowed |
| 6. Entered_Dttm | |
| Physical data type: | DATETIME |
| Allow NULLs: | Not allowed |
| 7. Entered_By | |
| Physical data type: | TEXT(15) |
| Allow NULLs: | Not allowed |
| 8. End_Dttm | |
| Physical data type: | DATETIME |
| Allow NULLs: | Not allowed |

4.58 StaffedBedsHistory

| 1. StaffCount_ID | |
|---|---|
| Physical data type: | LONG |
| Allow NULLs: | Not allowed |
| 2. NursingStationCode | |
| Physical data type: | TEXT(15) |
| Allow NULLs: | Not allowed |
| 3. Hospital_ID | |
| Physical data type: | LONG |
| Allow NULLs: | Not allowed |
| 4. TargetRatioRN | |
| Physical data type: | TEXT(3) |
| Allow NULLs: | Not allowed |
| 5. TargetRatioPatient | |
| Physical data type: | TEXT(3) |
| Allow NULLs: | Not allowed |
| 6. ActualStaffedBeds | |
| Physical data type: | TEXT(3) |
| Allow NULLs: | Not allowed |
| 7. RNsOnCall | |
| Physical data type: | TEXT(3) |
| Allow NULLs: | Not allowed |
| 8. CurrentHaves | |
| Physical data type: | TEXT(3) |
| Allow NULLs: | Not Allowed |
| 9. EnteredBy | |
| Physical data type: | TEXT(15) |
| Allow NULLs: | Not allowed |
| 10. Entered_Dttm | |
| Physical data type: | DATETIME |
| Allow NULLs: | Not allowed |
| 11. EndedBy | |
| Physical data type: | TEXT(15) |
| Allow NULLs: | Not allowed |
| 12. Ending_Dttm | |
| Physical data type: | DATETIME |
| Allow NULLs: | Not allowed |

4.59 StaffTypeJobCodeXRef

| 1. StaffType_ID (FK) | |
|---|---|
| Physical data type: | LONG |
| Allow NULLs: | Not allowed |
| 2. JobCode | |
| Physical data type: | TEXT(25) |
| Allow NULLs: | Not allowed |

4.60 StaffTypes

| | |
|---|---|
| 1. StaffType_ID | |
| Physical data type: | LONG |
| Allow NULLs: | Not allowed |
| 2. StaffType_Desc | |
| Physical data type: | TEXT(25) |
| Allow NULLs: | Not allowed |
| 3. Active_YN | |
| Physical data type: | TEXT(1) |
| Allow NULLs: | Not allowed |
| 4. DisplayOrder | |
| Physical data type: | SHORT |
| Allow NULLs: | Not allowed |

4.61 Departments

| | |
|---|---|
| 1. Department_ID | |
| Physical data type: | TEXT(15) |
| Allow NULLs: | Not allowed |
| 2. Department_Desc | |
| Physical data type: | TEXT(50) |
| Allow NULLs: | Not allowed |

4.62 Employees

| 1. Emp_ID | |
|---|---|
| Physical data type: | TEXT(12) |
| Allow NULLs: | Not allowed |
| 2. Last_Name | |
| Physical data type: | TEXT(20) |
| Allow NULLs: | Not allowed |
| 3. First_Name | |
| Physical data type: | TEXT(20) |
| Allow NULLs: | Not allowed |
| 4. Middle_Name | |
| Physical data type: | TEXT(20) |
| Allow NULLs: | Allowed |
| 5. Hosptal_ID | |
| Physical data type: | LONG |
| Allow NULLs: | Not allowed |
| 6. Department_ID (FK) | |
| Physical data type: | TEXT(15) |
| Allow NULLs: | Not allowed |
| 7. JobCode (FK) | |
| Physical data type: | TEXT(15) |
| Allow NULLs: | Not allowed |
| 8. UserID | |
| Physical data type: | TEXT(25) |
| Allow NULLs: | Not allowed |
| 9. PayRate | |
| Physical data type: | LONG |
| Allow NULLs: | Not allowed |
| 10. Active_YN | |
| Physical data type: | TEXT(1) |
| Allow NULLs: | Not allowed |
| 11. Termed_Dttm | |
| Physical data type: | DATETIME |
| Allow NULLs: | Allowed |
| 12. Manager_EmpID | |
| Physical data type: | TEXT(12) |
| Allow NULLs: | Allowed |

4.63 JobCodes

| | |
|---|---|
| 1. JobCode | |
| Physical data type: | TEXT(15) |
| Allow NULLs: | Not allowed |
| 2. JobDescription | |
| Physical data type: | TEXT(50) |
| Allow NULLs: | Not allowed |

4.64 HOPPlaces

| | |
|---|---|
| 1. Place_ID | |
| Physical data type: | LONG |
| Allow NULLs: | Not allowed |
| 2. Place_Desc | |
| Physical data type: | TEXT(50) |
| Allow NULLs: | Not allowed |
| 3. Place_Active_YN | |
| Physical data type: | TEXT(1) |
| Allow NULLs: | Not allowed |

4.65 HOPsInPlace

| 1. ThroughputBooster_ID (FK) | |
|---|---|
| Physical data type: | LONG |
| Allow NULLs: | Not allowed |
| 2. Place_ID (FK) | |
| Physical data type: | LONG |
| Allow NULLs: | Not allowed |

4.66 ThroughputBoosterCriteria

| | |
|---|---|
| 1. Criteria_ID | |
| Physical data type: | LONG |
| Allow NULLs: | Not allowed |
| 2. Criteria_Desc | |
| Physical data type: | TEXT(100) |
| Allow NULLs: | Not allowed |
| 3. Criteria_Active | |
| Physical data type: | TEXT(1) |
| Allow NULLs: | Not allowed |

4.67 ThroughputBoosterCriteriaMet

| 1. ThroughputBooster_ID (FK) | |
|---|---|
| Physical data type: | LONG |
| Allow NULLs: | Not allowed |
| 2. Criteria_ID (FK) | |
| Physical data type: | LONG |
| Allow NULLs: | Not allowed |

4.68 ThroughputBoosterForm

| 1. NursingStationCode | |
|---|---|
| Physical data type: | TEXT(15) |
| Allow NULLs: | Not allowed |
| 2. NursingStationDesc | |
| Physical data type: | TEXT(50) |
| Allow NULLs: | Allowed |
| 3. CleanBeds | |
| Physical data type: | TEXT(5) |
| Allow NULLs: | Allowed |
| 4. DirtyBeds | |
| Physical data type: | TEXT(5) |
| Allow NULLs: | Allowed |
| 5. StaffedBeds | |
| Physical data type: | TEXT(5) |
| Allow NULLs: | Allowed |
| 6. OccupiedBeds | |
| Physical data type: | TEXT(5) |
| Allow NULLs: | Allowed |
| 7. TransfersToUnit | |
| Physical data type: | TEXT(5) |
| Allow NULLs: | Allowed |
| 8. TransfersFromUnit | |
| Physical data type: | TEXT(5) |
| Allow NULLs: | Allowed |
| 9. PendingDischargesToday | |
| Physical data type: | TEXT(5) |
| Allow NULLs: | Allowed |
| 10. PendingDischargesTomorrow | |
| Physical data type: | TEXT(5) |
| Allow NULLs: | Allowed |
| 11. RNNeeds | |
| Physical data type: | TEXT(5) |
| Allow NULLs: | Allowed |
| 12. PCTNeeds | |
| Physical data type: | TEXT(5) |
| Allow NULLs: | Allowed |
| 13. ThroughputBooster_ID (FK) | |
| Physical data type: | LONG |
| Allow NULLs: | Not allowed |

4.69 ThroughputBoosters

| 1. ThroughputBooster_ID | |
|---|---|
| Physical data type: | LONG |
| Allow NULLs: | Not allowed |
| 2. Start_Dttm | |
| Physical data type: | DATETIME |
| Allow NULLs: | Allowed |
| 3. Start_Time | |
| Physical data type: | TEXT(10) |
| Allow NULLs: | Allowed |
| 4. End_Dttm | |
| Physical data type: | DATETIME |
| Allow NULLs: | Allowed |
| 5. NursingSupervisor | |
| Physical data type: | TEXT(50) |
| Allow NULLs: | Allowed |
| 6. Synopsis | |
| Physical data type: | TEXT(500) |
| Allow NULLs: | Allowed |
| 7. Start_UserID | |
| Physical data type: | TEXT(25) |
| Allow NULLs: | Allowed |
| 8. End_UserID | |
| Physical data type: | TEXT(25) |
| Allow NULLs: | Allowed |

4.70 ThrougputBoosterScanCriteria

| | |
|---|---|
| 1. Criteria_ID (FK) | |
| Physical data type: | LONG |
| Allow NULLs: | Not allowed |
| 2. CriteriaFound_Dttm | |
| Physical data type: | DATETIME |
| Allow NULLs: | Not allowed |
| 3. ActionTaken_Dttm | |
| Physical data type: | DATETIME |
| Allow NULLs: | Allowed |

Appendix F: Population of Patient Agent Databases:

### Supporting System Data Feeds

Scheduling System Data

Shift Filler

Hospital ID

Unit ID

Shift Start Date

Shift Start Time

Shift End Date

Shift End Time

Job Code

Staffed Beds

Hospital ID

Unit ID

Employee ID

Job Code

Housekeeping System Data

Clean/Dirty Beds

Hospital ID

NursingStationCode

Room Number

Bed Number

Status

Status Date & Time

ADT System Data

Supporting Data Elements for all Modules

Hospital ID

Hospital Description

NursingStationCode

NursingStationDescription

Month to Date Admit Numbers

Date

Type of Count

Hospital ID

NursingStationCode

Count

Human Resource System Data

Shift Filler

Employee ID

Last Name

First Name

Middle Name

Hospital ID

Department ID

Job Code

Active Y/N

Termination Date

Pay Rate

Supporting Data Elements for all Modules

Hospital ID

Department ID

Department Description

Job Code

Job Description

Clinical Information System Data

Throughput Activity

Patient Account Number

Isolation

Isolation History

Telemetry

Physician Information System Data

Supporting Data Elements for all Modules

Provider ID

Provider Specialty

Appendix G: Access defined in Microsoft Active Directory Services

| | | Active Directory Roles (Examples |
|---|---|---|
| Active Directory Group | Patient Agent ™ Capability | Displayed) |
| PTAgent_ThroughputBoosterAdmin | Configure and manage all aspects of the | Org_Nursing_Director of Nursing |
| | Throughput Booster, call and end Throughput | Org_Operations_Director of |
| | Booster alerts | Operations |
| PTAgent_ThroughputTransfers | View detail information in the Pending | Org_ThroughputOffice_ThroughputCoordinator |
| | Admits/Transfers TO Unit 32 and the Pending | |
| | Admits/Transfers FROM Unit 33 of the Summit | |
| | View 6 | |
| PTAgent_ThroughputBoosterMgr | View and update alert numbers as related to the | Org_Unit_UnitManager |
| | Throughput Booster Module 12 | Org_Operations_Director, Operations |
| PTAgent_ThroughputOffice | View, manage and administer the throughput | Org_ThroughputOffice_ThroughputCoordinator |
| | office view of the Throughput Activity Module 8 | |
| PTAgent_ThroughputDirectAdmit | View the Direct Admit Trending reports | Org_ThroughputOffice_Throughput |
| | | Coordinator |
| PTAgent_PatientAgentReports | View general reports that do not display any | Org_Unit_Clinical Nurse Lead |
| | patient health information (PHI) | Org_Unit_Unit Manager |
| PTAgent_ThroughputReport | Generate reports related to throughput activity | Org_Nursing_Director, Nursing |
| | including the Target Staffed Bed Discrepancies, | Org_Operations_Director, Operations |
| | Throughput Activity Detail, and Throughput | |
| | Activity Trending reports | |
| PTAgent_ThroughputPendingDischgAdmin | Update, edit and remove pending discharges | Org_Unit_Unit Manager |
| | information from the Pending Discharges | Org_Unit_Clinical Nurse Lead |
| | Today/Tomorrow column 34 of the Summit View | |
| | 6 | |
| PTAgent_PatientAgentAdmin | Create and remove beds, create and remove | Org_Nursing_Director, Nursing |
| | units, assign beds to a unit, create/assign job | Org_Operations_Director, Operations |
| | types | |
| PTAgent_Alerts | Manage alert information for self | Org_Nursing_Director, Nursing |
| | | Org_Operations_Director, Operations |
| | | Org_Unit_Unit Manager |
| PTAgent_AlertsAdmin | Manage alert information for all | Org_Operations_Director, Operations |

What is claimed is:

1. A healthcare network for a plurality of units in a healthcare facility, the network comprising comprising:
a server computer;
a system interface for coupling said server computer to:
an administration/discharge/transfer (ADT) system;
a clinical information management system;
a system interface for coupling said server computer to:
a scheduling system;
a housekeeping/bed tracking system;
a human resource system;
a physician information system;
a database coupled to said server computer and storing data for the healthcare work, including patient data, clinical data, scheduling data, housekeeping data, human resource data, and physician data;
a web server coupled to said server computer;
a Lightweight Directory Access Protocol (LDAP) server connected to said server computer; and
a messaging server connected to said server.

2. The healthcare network as defined in claim 1, further comprising means for coupling said server computer to a data backup and recovery system.

3. The healthcare network as defined in claim 1, further comprising means for receiving data from other information systems and for storing said data from other information systems in said database.

4. The healthcare network as defined in claim 3, further comprising means for:
adding, removing, or changing said data from other information systems; and
storing said data from other information systems.

5. The healthcare network as defined in claim 3, further comprising means for transmitting said data from other information systems.

6. The healthcare network as defined in claim 1, further comprising a Staffed Bed Module coupled to said server computer to provide one or more said units in the healthcare facility with the capability to electronically monitor, manage, communicate and record the unit's staffed bed conditions, needs, and overages to a Staffing Office.

7. The healthcare network as defined in claim 1, further comprising means for providing a Staffing Office with the capability to monitor, manage, communicate and record staff requirements across a plurality of said units in the healthcare facility.

8. The healthcare network as defined in claim 1, further comprising means for electronically displaying each said unit's staffed bed status to other said units in the healthcare facility.

9. The healthcare network as defined in claim 1 further comprising a Throughput Activity module coupled to said server computer to provide each said unit the ability to record, monitor, manage, and communicate patient movement activity and decisions that directly involve the unit.

10. The healthcare network as defined in claim 1, further comprising means for providing the facility's Throughput Office within the ability to monitor, manage, communicate and record patient movement between all units of the healthcare facility as well as admission activity generated from external sources.

11. The healthcare network as defined in claim 1, further comprising means for electronically displaying all patient movement status and activity to all said units in the healthcare facility.

12. The healthcare network as defined in claim 1, further comprising a Shift Filler Module coupled to said server computer to provide a unit management entity with the ability to view future unfilled shifts from the facility's scheduling system and have the opportunity to make use of a shift lottery, shift and salary lottery or salary auction to attract appropriately skilled clinical staff who are in good standing.

13. The healthcare network as defined in claim 12, further comprising means for providing said unit management entity with the ability to define and identify competencies required for units and shifts.

14. The healthcare network as defined in claim 12, further comprising means for providing said unit management entity with the ability to review and edit clinical staff profiles as well as approve or disapprove individual participation in lotteries or auctions.

15. The healthcare network as defined in claim 12, further comprising means for providing said unit management entity with the ability to define denial reasons for denying shift awards to winning participants.

16. The healthcare network as defined in claim 12, further comprising means for providing said unit management entity with the ability to provide the clinical staff of the healthcare facility with the opportunity to participate in shift lotteries, shift and salary lotteries and salary auctions to fill shifts for which they hold the required competencies, wherein clinical staff participation in these lotteries and auctions provides the clinical staff with the opportunity to work a shift at a higher pay than they would normally receive as well as stimulate honest and entertaining competition for shifts.

17. The healthcare network as defined in claim 1, further comprising an Alert Module coupled to said server computer to provide a utility for viewing predefined facility alerts, viewing and managing alert recipients and recipient addresses.

18. The healthcare network as defined in claim 17, further comprising means for providing each authorized user the ability to enter multiple electronic device addresses and receive alerts to their choice of one or many of those electronic devices.

19. The healthcare network as defined in claim 1, further comprising a Reporting module coupled to said server computer to provide users the ability to view and analyze said stored data.

20. The healthcare network as defined in claim 1, further comprising a Throughput Booster Module coupled to said server computer to provide a system generated alert when predefined conditions are met that may lead to a situation resulting in either financial or patient care risk.

21. The healthcare network as defined in claim 20, further comprising means for providing management of the healthcare facility with the ability to quickly and easily enable an electronic alert by which all critical players in maximizing throughput are set into a joint effort motion to address and remedy the situation.

22. The healthcare network as defined in claim 20, further comprising means for providing a history of occasions when predefined conditions were met as well as occasions when a Throughput Booster collaborative effort was put into motion, wherein a snapshot of the following data is taken for each Throughput Booster event (displayed by unit): census, staffed beds, clean/dirty beds, pending transfers in and out of the unit and pending discharges.

23. The healthcare network as defined in claim 1, further comprising means for providing the management of the healthcare facility with the ability to administer how and what facility and unit information is displayed to facility personnel, wherein enabling this option for facility management ensures that the most valuable information is presented to key throughput players in such a way as to prevent the need for screen toggling, phone calls, and dependence on inference.

24. A healthcare network comprising a server computer coupled to:
a web server;
a directory services server;
a messaging server;
an ADT System;
a clinical information management System; and
a database coupled storing data from each of the ADT System, the clinical information management System and one of more modules and systems selected from the group consisting of:
a human resource System;
a scheduling System;
a Staffed Bed Module;
a Reporting module;
a Throughput Activity Module;
a physician information System;
a Shift Filler Module;
an Alert Module; and
a Throughput Booster module.
